(19) United States
(12) Patent Application Publication
(10) Pub. No.: US 2024/0322748 A1
(43) Pub. Date: Sep. 26, 2024

(54) MULTI-PURPOSE SOLAR ENERGY SYSTEM AND CONSTRUCTION METHOD THEREOF

(71) Applicant: Eunil KIM, Daejeon (KR)

(72) Inventor: Eunil KIM, Daejeon (KR)

(21) Appl. No.: 18/272,442

(22) PCT Filed: Dec. 30, 2021
(86) PCT No.: PCT/KR2021/020264

§ 371 Date: Jul. 14, 2023

(30) Foreign Application Priority Data
Jan. 15, 2021 (KR) 10-2021-0006007

(51) Int. Cl. H02S 30/10; H02S 20/24

(52) U.S. Cl. CPC H02S 30/10; H02S 20/24

(57) ABSTRACT

A multipurpose solar energy system in which an object having a primary use is provided with a secondary use, namely the production of solar energy (power or heat), and a method of construction thereof. A roof beam of a solar rack is placed on a roof beam of a base frame assembled with a plurality of elevation frames formed by roof beams and columns to form a flat roof with a lattice structure in the form of #, wherein the solar energy panels are installed at a suitable orientation and inclination angle on the rack beam to form a solar workpiece for effective solar energy collection. The base frame is assembled to form various elevation frames, including a portal frame, and mix them to meet the primary use of the object.

### BACKGROUND

In general, construction structures are divided into building structures and civil structures, wherein the building structures are intended to facilitate comfortable and convenient living and are classified into residential, commercial, and public uses according to their purpose, and the civil structures are intended to fulfill safety and welfare needs in daily life and production activities, such as roads and rivers, The embodiments of the present invention are intended to realize a multipurpose solar energy system by forming a building structure with a flat-roofed solar workpiece or by adding it to an existing building structure or civil structure.

Embodiments of the invention are provided as a solar workpiece comprising solar panels mounted on a flat roof with a suitable tilt angle of true southward in the Northern Hemisphere or true northward in the Southern Hemisphere. The building structure includes buildings such as residential buildings, commercial buildings, schools, workshops, factories, warehouses, barns, sheds, plantations, farms, fish ponds, and (semi-shaded) horticultural facilities, and the civil structures include parking lots, parks, rivers, bridges, railroads, roads, intersections, sidewalks, sewage treatment plants, water treatment plants, docks, moorings, (train) platforms, and road soundproofing tunnels.

In addition to the above-mentioned construction structures, cultivated land for agriculture and forestry, etc. as well as non-cultivated land is also recognized as an object for the application of the embodiments of the invention and is intended to not only fulfill its intended use but also to improve it.

A solar energy system is a system that converts solar energy incident on solar panels installed on the earth's surface into electricity or heat. It is natural that the amount of solar energy incident on the earth's surface is represented by the horizontal surface insolation, and the subspace of the solar panel is reduced by the amount of insolation incident on it. Accordingly, a system capable of producing power or heat utilizing solar energy (abbreviated as “solar energy system”) can be added when the amount of solar insolation does not significantly affect the original use of the construction structure. The solar energy system includes a solar photovoltaic system and a solar thermal energy system, each of which includes a solar photovoltaic panel and a solar thermal collector as a corresponding solar energy panel (abbreviated as “solar panel”), through which solar energy can be obtained and utilized.

In the case of agro solar power systems, it is necessary to place solar panels in consideration of the decrease in crop yields due to the decrease in horizontal insolation, and solar power systems can be built to have optimal efficiency on sites such as sidewalks, bridges, building rooftops, parking lots, and rivers that do not require 100% of the insolation incident on the underside of the solar panels. Nevertheless, it is desirable to consider environmentally friendly landscaping that meets the original purpose of parking and drainage in addition to solar power generation.

A multipurpose solar energy system applied to agriculture can be constructed by installing solar panels on the roofs of buildings with primary uses such as workshops, barns, mushroom farms, insect houses, fish farms, fish ponds, and (semi-shaded) horticultural facilities, with a secondary use of generating electricity or heat. Residential buildings, commercial buildings, schools, factories, and warehouses for other purposes are no different. Solar panels can also be installed on the roofs or open spaces of existing buildings by erecting a base frame that does not interfere with or enhance the original primary use and installing solar panels on top of it to generate power or heat for a secondary use. Open spaces include parking lots, parks, streams, bridges, railroads, roads, intersections, sidewalks, sewage treatment plants, water treatment plants, docks, moorings, (railroad) platforms, and soundproof tunnels, which require a base frame of long span members and a small number of columns to minimize the impact on the original primary use.

For agro solar power systems on agricultural or forestry land, the distance between columns should be such that it does not interfere with the operation of agricultural machinery. In the case of installing a PV system on a riverbed, it is necessary to locate the columns on the river bank or elsewhere as much as possible so that the flow of water is not interrupted and the safety of the PV system facility is guaranteed.

In general, in order to utilize the subspace of the solar panel for various purposes, a portal frame or similar structure formed by supporting long beams with high columns is suitable. Since the portal frame is formed by applying the main member made of the long span member, it should be considered to be a load bearing structure.

The dissemination of solar energy is encouraged at the national level, and various R&D and support policies are in place to promote it. In order to secure sites for solar power generation, the use of existing facilities such as agricultural fields and buildings as multipurpose solar energy systems is being prioritized. Solar energy resources can be properly utilized because they are evenly distributed over the earth's surface where they are not shaded by surrounding terrain or structures. Solar panels can also be placed on dead space, such as rivers, dams, bridges, roads, parking lots, or parks, to harness the sun's energy with little or no disruption to the original use of the site. In parks, for example, installing them over walking paths can provide useful shading, increasing their use throughout the summer months.

Existing agro solar power systems are disclosed in the following patent references. They suffer from the problem that the installation is limited by the layout and orientation of the land by adjusting the solar panels to face or track the sun according to the orientation of the substructure to effectively obtain solar energy. To solve this problem, a solar power system that fixes the solar power panels on a single column is proposed, but this also causes other problems such as maintaining structural stability.

Since solar energy systems are manufactured with a design life of at least 20 years, it is necessary to ensure not only the efficiency of solar energy acquisition but also the resistance of the building structure to weather disasters such as large snowfalls and strong winds. The Korean Ministry of Agriculture, Food and Rural Affairs has published the standards for disaster-resistant horticultural and specialty facilities (Ministry of Agriculture, Food and Rural Affairs Notification No. 2014-78, Jul. 24, 2014), as well as the specifications, plans and specifications of disaster-resistant standard facilities for greenhouses, simple mushroom growers and ginseng facilities on the website of the Rural Development Administration (http://www.rda.go.kr). It is self-evident that the multipurpose solar energy system proposed in the embodiments of the invention should be designed and constructed in consideration of the above disaster-resistant standards.

### PRIOR ART REFERENCES

(KR Patent literature 0001) Registration No.: KR 1023225350000; Registration Date: 2021.11.01. “Architectural structure, solar energy building and construction method thereof”, Inventor: KIM, Eunil
(KR Patent literature 0002) Registration No.: 1023685770000; Registration Date: 2022.02.23. “Multipurpose (including farming in parallel) solar PV system and construction method thereof”, Inventor: KIM, Eunil
(KR Patent literature 0003) Registration No.: 1012126470000; Registration Date: 2012.12.10. “Solar cell power generating system provided with greenhouse for cultivation”, Inventor: KIM DONG HOI
(KR Patent literature 0004) Registration No.: 1012741990000; Registration Date: 2013.06.05. “Solar cell power generating system provided with greenhouse for cultivation”, Inventor: KIM DONG HOI
(KR Patent literature 0005) Registration No.: 1015478640000Registration Date: 2015.08.2. “Mushroom Cultivation Equipment having Solar Energy Collection Unit”, Inventor: SUK HO SHIN|JI, Seung-Ho|JEONG EUI YONG
(KR Patent literature 0006) Registration No.: 1020012420000; Registration Date: 2019.07.11. “Solar photovoltaic device installed in agriculture and livestock area”, Inventor: CHO CHEON HYUNG
(KR Patent literature 0007) Registration No.: 1018703740000Registration Date: 2018.06.21. “INSTALLATION MODULE OF PHOTOVOLTAIC POWER PLANT FOR AGRICULTURE”, Inventor: JEON, Hyun Ik|SONG, Ki O|BACK, Jin Su|YOO, Jae . . .
(KR Patent literature 0008) Registration No.: 1020385300000; Registration Date: 2019.10.24. “Agro photo voltaic system which includes agro photo voltaic structure”, Inventor: LIM, Jong Ho|DO, Gi Il|LEE, Kyoung Ho|CHAE, Jong . . .
(KR Patent literature 0009) Registration No.: 1009752120000; Registration Date: 2010.08.04. “Floating structure for installing solar cell array”, Inventor: JOO HYONG JOONG| NAM JEONG HOON|YOON SO . . .
(KR Patent literature 0010) Registration No.: 1010129540000; Registration Date: 2011.01.27. “Structure for Arraying Solar Cell Array”, Inventor: NAM JEONG HOON|JOO HYONG JOONG|LEE SeungSik|YOON SOON JONG . . .
(US Patent literature 0011) Document/Patent number: U.S. Pat. No. 10, 723, 422-B2, “Photovoltaic array system and method”, Inventor name: Jaramillo; Elliot, Publication date: 2020-07-28.

### SUMMARY OF THE INVENTION

The embodiments of the present invention seek to implement the technical ideas presented in the above background technology, wherein one of the problems to be solved is to effectively obtain solar energy by constructing a building structure with a solar workpiece proposed in the embodiments of the invention, either by itself or in addition to it.

Another challenge of the embodiments of the invention is to effectively implement a multipurpose solar energy system for the secondary use of generating power or heat by adding the solar workpiece above the space being utilized for the primary use of the civil structures. Another challenge of the embodiments of the invention is to minimize the impediment to the utilization of the primary use and maximize the efficiency of the secondary use of solar energy acquisition, without being constrained by the location of the object (with respect to orientation and flatness) on cultivated or non-cultivated land, such as agricultural or forestry land.

Another challenge of the embodiments of the invention is to ensure that the solar panel subspace has a wide spacing between the columns and a high height of the columns themselves so that there is sufficient workspace underneath to allow for unimpeded utilization of the primary use of the subspace.

Another challenge of the embodiments of the invention is to form a load bearing structure so that the solar workpiece, including the solar panels installed on top of an open natural space or facility, is resistant to weather disasters such as snowfall and strong winds for a long period of time (20 years or more).

Another challenge of the embodiments of the invention is to add additional tertiary uses to the solar workpiece, such as the installation of power and communication lines, lighting, and the attachment of irrigation, pesticide and liquid spraying equipment and harmful tide control nets, or landscaping using vines and other plants.

Another task of the embodiments of the invention is to contribute to the dissemination of solar energy by enabling the integration of solar energy systems into building structures and civil structures that do not require 100% sunlight.

Another challenge of the embodiments of the invention is to enable prefabrication of key components in a factory, so that pre-planned specifications and quality are maintained.

Another challenge of the embodiments of the invention is to facilitate the assembly and construction of a multipurpose solar energy system on site.

In order to solve the above problems, embodiments of the present invention implement a solar system comprising a roof (abbreviated as “flat roof”) with a polygonal horizontal surface of a solar workpiece. A solar energy system is implemented in which a solar energy panel (abbreviated as “solar panel”) is installed on the roof. Said solar panel is installed on said flat roof at a value (abbreviated as “suitable orientation and inclination angle”) in the vicinity of a suitable inclination angle of a northern latitude inclination angle facing south for a northern hemisphere region or a southern latitude inclination angle facing north for a southern hemisphere region.

The solar workpiece includes a base frame forming a solar rack on top and a space below it (i.e., a subspace for solar panels), wherein said solar rack includes a plurality of rack beams forming one or more pairs (abbreviated as ‘rack beam pair’) and one or more inclined support members and solar panels, wherein said rack beams are disposed in an east-west direction as horizontal members, said rack beam pair including a southern rack beam on the south side and a northern rack beam on the north side, wherein the southern rack beam and the northern rack beam are arranged in parallel at certain intervals, and a plurality of rack beam pairs are arranged in parallel at certain intervals, and wherein the inclined support member includes a horizontal support part and a slope part having a predetermined inclination angle, wherein said support part is fixed orthogonally across a plane above said southern rack beam and northern rack beam, and said solar panel is attached to said slope part.

Said base frame comprises a plurality of elevation frames and a footing part, said elevation frames comprising at least one horizontal member, a roof beam, and at least one vertical member, a column, wherein said roof beam is fixed to a top part of said column by column-beam connection means, and wherein said elevation frame crosses the inner space, disposed along the perimeter of said space, so that said roof beams are of a certain height, on which said rack beams are fixed, so that one or more polygonal horizontal flat roofs (horizontal flat roof: abbreviated as “flat roof”) are formed, said roof beams being disposed in different directions from said rack beams.

Said footing part is fixed to said object by including framing settlement means at the bottom part of said column. Said framing settlement means includes a weight support or a base plate fixture, said weight support and base plate fixture are placed or fixed on a concrete or pile foundation, and said footing part is settled by said framing settlement means in a predetermined direction and spacing within said object, so that said solar workpiece is erected.

Said rack beam is placed on said roof beam and fixed with beam-beam superposition connection means in the form of layered framing, so that the flat roof of the solar workpiece formed by said rack beam and roof beam together is formed as a lattice structure in the form of #. Furthermore, the flat roof is strengthened as a load-bearing structure by fixing the support part of the inclined support member on top of said rack beam pair.

Said column comprises a cylindrical column, a square tube pillar, a truss type column or a main member applied to said rack beam or roof beam, wherein said main member comprises a horizontal or vertical long span member having a rectangular section formed by a roll forming process, said main member having a length of a certain height to enable the use of said object to function.

The rack beam pair is arranged in an east-west direction, and the inclined support member is manufactured with an inclined part considering the latitude of the region in advance, so that the solar panel installed on it has a suitable orientation and inclination angle as a result.

Said solar rack and said base frame each optionally further comprising the following components, wherein said solar rack further comprises a rack beam facia as a horizontal member, wherein said rack beam facia is a main member similar to said rack beam and is secured to the ends of adjacent rack beams by rack beam-facia connection means.

The base frame further comprising a roof beam facia, a bracing beam or a purlin as a horizontal member, said roof beam facia being a main member similar to said roof beam, secured to the ends of adjacent roof beams by roof beam-facia connection means, said bracing beams and purlins being main members similar to said roof beams, wherein said columns are connected horizontally between sections of a certain height, said bracing beams being located flush with the roof beams and fixed between said elevation frames by column-beam connection means in the form of flush framing, wherein said purlins are located below said roof beams and are fixed between said elevation frames by column-purlin connection means in the form of layered framing.

The solar workpiece having a flat roof with a lattice structure in the form of #, wherein said rack beam ends are connected to said rack beam fascia and said roof beam ends to said roof beam fascia, and further strengthened into a load bearing structure by adding bracing beams and purlins.

The rack beam-facia connection means, roof beam-facia connection means, column-beam connection means and column-purlin connection means include direct connection by welding, self-drilling screw or bolt nut fastener, or indirect connection by adding a plate bracket.

The elevation frame optionally comprising one or more of a cantilever frame, a portal frame, a box frame, a pile frame, and a mixed frame, wherein said cantilever frame is formed by securing a top portion of one vertical member, a column, and an end portion of one horizontal member, a roof beam, with column-beam connection means, wherein the portal frame is formed by supporting the top of the two vertical members of the column and the end parts of the one horizontal member of the roof beam, respectively, and fixing them with the column-beam connection means, wherein the box frame is formed by fixing the two end parts of the roof beam and the floor beam, which are two horizontal members, to the top and bottom parts of the column, which are two vertical members, with column-beam connection means, whereas, the pile frame is formed by fixing the two end portions of the two upper and lower horizontal members, the roof beam and the floor beam, respectively, to the top and intermediate portions of the column, which are two vertical members, with column-beam connection means, wherein said pile frame is a structure in which a column protrudes downwardly from said box frame and extends therefrom, and wherein said mixed frame is an integrated structure in which said cantilever frame, portal frame, box frame and pile frame are optionally mixed and applied to the formation of said base frame.

The roof beam and the floor beam, each of said roof beams and floor beams having a certain length at their respective ends beyond said columns, comprising an eave width in the case of the roof beam and a balcony width in the case of the floor beam, so that the length of the roof beam and the floor beam is equal to or longer than the inner and outer spacing between the two columns.

The horizontal member and the vertical member include a cylindrical column, a square tube pillar, an I beam, or an H beam, in addition to a main member having a rectangular section.

The main member optionally comprising the following features with respect to material, process, and shape, wherein the material of the main member comprises one or more of a metal, a synthetic resin, or a composite material, The forming process of said main member includes one or more of a cold or hot roll forming process, an extrusion process, a pultrusion process, and a composite material manufacturing process, wherein the cross-sectional shape of said main member includes one or more of E-shape, C-shape (channels), -shape, H-shape, I-shape, L-shape (i.e., angles), and T-shape, and said main member is formed with a single said cross-sectional shape or, comprising a horizontal member and a vertical member having a mixed cross-sectional shape, and comprising a composite member formed by merging two or more of said main members by welding, self-drilling screw or bolt nut fastener.

Said main member is assembled by being fixed with main member joint connection means in a straight line or a ray at a certain position in the longitudinal direction, and said main member may have a corner of a certain angle (not more than 180 degrees) by forming a half-line with respect to said certain position.

Each of said column, rack beam, roof beam, rack beam facia, roof beam facia, bracing beam, and purlin further comprises a main member similar to the main member used, wherein the back surfaces of the two main members of the one ply are butted together to form a single two-ply long span member by direct connection by welding, self-drilling screws, or bolt-nut fasteners.

Comprising a cross strut for rack beam between said one or said pair of rack beams of said two-ply main member, said cross strut for rack beam being a plate fixture of =shape, wherein said pair or pairs are connected by fastening means, such as self-drilling screws, in an orthogonal form between said pair of rack beams, and wherein said pair or pairs of cross struts for rack beams are formed by fastening them face to face.

A compound member pair, wherein said one or two layers of main members (abbreviated as ‘single layer member’ and ‘double layer member’, respectively) are placed parallel to each other, and a pair of main members (abbreviated as ‘single layer pair’ and ‘double layer pair’, respectively) are formed as long span members of the compound structure.

Said elevation frame comprises a column and a roof beam of said compound member pair, and further comprises a cross strut for main member between said compound member pair, said cross strut for main member being a plate fixture of E shape, wherein one or a pair thereof is connected between said compound member pairs by fastening means, such as a self-drilling screw, in an orthogonal form, and wherein said pair of cross struts for main member are formed by fastening them face to face.

Accordingly, said rack beam pair including said cross strut for rack beam and said elevation frame including said cross strut for main member are formed into a Vierendeel truss, so that said solar workpiece becomes a load-bearing structure.

The rack beam-facia connection means, the roof beam-facia connection means, the column-purlin connection means, and the beam-beam superposition connection means, column-beam connection means, and main member joint connection means refer to the corresponding two main members, rack beam and rack beam facia, roof beam and roof beam facia, and column and purlin, respectively, rack beam and roof beam, column and roof beam or bracing beam, and main member and main member as connection means, including direct connection by welding, self-drilling screw or bolt nut fastener, wherein said connection means further comprises an indirect connection by welding, self-drilling screw or bolt nut fastener by adding a bracket to the connection part of the two main members.

The bracket is formed in such a way that it is attached to the connection part of the main member, and the formation means of the bracket is casting processing, press processing, sheet metal processing, and composite material processing, wherein the sheet metal processing comprises one or more of the following shaping means: shearing, bending, and welding.

The bracket includes a plate bracket formed from a single piece of plate, and said sheet metal processing includes the forms of a single bracket, a double bracket, and a combined bracket, wherein said single bracket is formed from one piece and applied to a point of said connection part, The form of said double bracket is formed in two pieces and applied together to a point of said connection part, and the form of said combined bracket is formed by merging the shapes of the corresponding brackets at a point where there are two or more adjacent connection parts or three or more main members passing through the connection part to form a single bracket or a double bracket, which is applied to the connection part as a whole.

The plate bracket is formed by cutting and bending a single metal plate sheet according to the shape of the connection part, and the plate bracket is called a rack beam-facia bracket, a roof beam-facia bracket, or a roof beam-facia bracket, column-purlin bracket, beam-beam superposition bracket, column-beam bracket, and main member joint bracket, and said rack beam-facia bracket applies to the rack beam-facia connection means, wherein the roof beam-facia bracket is applied to the roof beam-facia connection means, and the column-purlin bracket is applied to the column-purlin connection means, the beam-beam superposition bracket is applied to the beam-beam superposition connection means, the column-beam bracket is applied to the column-beam connection means, and the main member joint bracket is applied to the main member joint connection means.

Said rack beam-facia bracket, roof beam-facia bracket, column-purlin bracket, and beam-beam superposition bracket, column-beam bracket, and main member joint bracket, and when said plate brackets overlap due to their proximity, the overlapping planes are cut into a single plane and formed into a single bracket or a double bracket in the form of said combined connection bracket, which is applied to said connection part as a whole.

A planar combination type of an elevation frame for forming said base frame, optionally including one or more of a cross-sectional frame of a crosswise type, a side wall frame of a longitudinal type, and a mixed frame of a mixed type.

The cross-sectional frame, wherein said elevation frames are disposed in a plurality at certain intervals across the interior of said object and connect the ends of adjacent roof beams to roof beam fascias or the tops of adjacent columns to other bracing beams, wherein said side wall frames are arranged in two or more rows in a longitudinal direction along the interior or exterior perimeter of said object, said elevation frames, wherein a bracing beam is connected in a flush-framing manner between two opposite columns, one column and a roof beam, or two roof beams between said two rows, and wherein said mixed frame is a type in which said cross-sectional frame and side wall frame are optionally arranged in a mixture.

In the form arranged according to the above combination type, a column made of the same main member is optionally added to the connection part of a bracing beam or a roof beam, or a purlin is fixed to an adjacent column in a layered framing method.

The base frame, optionally comprising one or more of a single building type, a consecutive building type, a multistory building type, and a mixed building type, wherein said single building type comprises a column placed at the outer perimeter of said object, and said consecutive building type comprises a row or rows of columns inside said object, constructed by attaching one or more of said single building types immediately adjacent to each other, wherein said multistory building type is formed by building a plurality of base frames of the same or lesser floor area on top of said single building type or consecutive building type, and wherein said mixed building type is formed by selectively mixing said single building type, consecutive building type, or multistory building type to form a base frame according to the shape of a given object.

Also, a merged combination type of an elevation frame for forming said base frame, comprising one or more of a primary cubic frame and a secondary cubic frame, wherein said primary cubic frame is formed in a planar combination type of said elevation frame, and said secondary cubic frame is formed in a perpendicular combination type of said elevation frame such that said primary cubic frame is supported on said object.

The means for providing support to said object comprises a floating body, piles or a combination support, said floating body being installed in or under said primary cubic frame, wherein said piles are attached to columns within said primary or secondary cubic frame, and wherein said mixed support method is supported by said piles being attached to columns within said primary cubic frame containing said floating body.

Said primary or secondary cubic frame optionally further comprises a roof, floor and walls or railings which are subordinate frames, said roof being secured by a sheet type structure attached to said roof beams, said floor being secured by a sheet type structure attached to said bottom beams, and said walls being secured by a sheet type structure attached to the sides of said columns, The handrail is formed as an integral elevation structure with the columns at the corners of the floor, thereby forming a solar workpiece in which the roof becomes a non-covered structure, the floor and walls become a safety structure, and the interior space is divided according to the use, and the roof and floor share the horizontal load and the walls and handrail share the vertical load.

The object on which the solar workpiece is constructed, comprising an earth's surface, including cultivated and uncultivated land, and a building structure and civil structures, the building structure being formed and completed with a base frame in accordance with the original primary use of the building, further includes separate facilities (hereinafter referred to as “internal facilities”) or is attached to the exterior of the building structure (hereinafter referred to as “external installations”) to serve or improve said primary use, and said building structure includes residential buildings, shops, schools, workshops, factories, warehouses, barns, sheds, growers, breeders, fish farms, fish ponds, and (semi-shaded) horticultural facilities.

Said internal facilities include power, communication, lighting, irrigation, pesticide and liquid fertilizer spraying facilities and harmful tide control nets as separate utility facilities, and said external facilities are formed by erecting columns on or around the roof of all or part of the floor area of said building to form said base frame.

Said base frame is also constructed in addition to or integral with existing or new civil structures, wherein said civil structures include parking lots, parks, rivers, bridges, railroads, roads, intersections, and sidewalks, sewage treatment plants, water purification plants, marinas, moorings, (railway) platforms, and road soundproofing tunnels, and said base frame is formed in the form of a cloister by erecting columns inside, outside, or at the boundaries of said civil structures.

Said earth's surface on which said base frame is installed includes land, water, and swampy ground, and said base frame is installed by erecting columns on the boundary or inside of said object, and said floating body includes a floating body, and said floating mooring type of said base frame includes an anchor and a pile mooring, wherein said anchor is fixed to the water bottom in the form of floating structures by means of a line connected to said base frame, and said pile mooring is fixed to the water bottom in the form of semi-floating structures by means of inserting a cylinder movable up and down to a certain height with said pile as a fixed axis into said base frame.

Said base frame further comprises, in addition to the above separate utility facilities, a landscaping structure on the inside for landscaping by attracting vines to a certain position, and includes facilities for using the space between the roof and the floor of said cubic frame forming said base frame as a walkway, pathway, or camping deck, and, if said space is water, a swimming pool or fishpond in the lower part thereof.

A construction method for a multipurpose solar energy system, which is constructed as a solar workpiece including a solar energy panel (abbreviated as “solar panel”) according to a process achieved by including the following steps, for the purpose of being constructed on an object on an earth's surface and utilizing a subspace, is disclosed as follows.
(1) A construction planning step comprising the following steps in a process for preparing said solar workpiece for construction on a given object:
(a) a design stage comprising the following steps, in a process utilizing a digital map of the site and a global positioning system (GPS) to ensure that said solar panel has a suitable orientation and inclination angle:
1) surveying the outer extent of said subspace, and causing said roof beams to be of a certain height so that one or more polygonal horizontal flat roofs (abbreviated “flat roofs”) are formed by fixing said rack beams on top of said roof beams, and causing said rack beam pairs to be fixed in a layered framing manner on top of said roof beams forming said flat roofs, 2) said rack beam pair is arranged in an east-west direction such that the solar panels have an inclination angle of due south in the northern hemisphere or due north in the southern hemisphere, and 3) the inclination angle of the inclined support member installed on top of said rack beam pair is equal to the tilt of the earth's axis of rotation at the latitude of the location (obliquity≈23.5°, or is predetermined and molded with an inclination angle value that produces maximum energy production during a year or a specific period of time; 4) the spacing between said rack beam pair in the north-south direction or north-east direction is adjacent but sufficiently distant so that the shading effect of the solar panels in front and behind is minimized, 5) said elevation frame is arranged so that the flat roof of the solar workpiece formed by said rack beams and roof beams is formed as a lattice structure in the form of #, and 6) If the acute angle of intersection between said rack beam and said roof beam is 30 degrees or less, said bracing beam is added and fixed between said elevation frame in the form of flush framing at the same height as the roof beam so that said rack beam and said bracing beam are formed into a lattice structure in the form of #, 7) consequently, said design step determines the layout of the multi-use solar energy system so that the poles within said elevation frame are properly positioned on said object;
(b) performing a survey of candidate points on said object to anchor said footing portion of said column; (c) determining said framing settlement means from said survey; and (d) if the candidate points for anchoring said footing part are unsuitable for the application of said framing settlement means, to finalize the layout of said multipurpose solar energy system by relocating said poles in said design phase; and (e) to complete the detailed design of said solar workpiece in accordance with said layout to comply with the disaster resistance design standards and road transportation regulations;
(2) the factory fabrication stage, which is the process of factory fabricating the components of said solar rack and base frame, further comprising the following steps:
(a) investigating the transportation restrictions prescribed by the Road Traffic Act and the transportation conditions from the factory to the site, and accordingly, the main members of said solar rack and base frame are cut and assembled to an acceptable scale; and (b) assembling the main members on site and drilling the main members for fixing the connection means, (c) a plate bracket is fabricated which is applied to the connection means of said elevation frame and the horizontal member and vertical member attached thereto according to the shape of said base frame; and (d) said plate bracket is formed by cutting and bending a single metal plate sheet according to the shape of the connection part of said main member;
(3) a site transportation stage in which said component of the multipurpose solar energy system manufactured in said factory production stage is transported to the site as prescribed by the Road Traffic Act;
(4) an on-site assembly stage in which said components of said multipurpose solar energy system transported in said on-site transportation stage are assembled unit by unit in a process that includes the following steps:
(a) preparing the construction means required for ground excavation, framing settlement means, and aerial loading means; (b) preparing a concrete or pile foundation for settlement of the framing settlement means at a location determined in said design stage within the object with said ground excavation construction means; and (c) scaling the components of the solar workpiece to be assembled on the ground with said framing settlement means, taking into account the capacity of the aerial loading means to, 1) said solar rack is assembled by attaching inclined support members in rack beam pairs, with or without solar panels, depending on the permissible scale; and 2) said elevation frames forming said base frame are assembled individually, (d) said elevation frames are lifted by said elevated support member and settled by said erecting support member on said foundation; and (e) the assembly of said base frame is accomplished by attaching a roof beam facia, which is a main member, between said elevation frames, roof beams, and purlins, in accordance with the above design steps, 1) securing the ends of adjacent roof beams to said roof beam facia, 2) securing said bracing beams flush with said roof beams in a flush framing configuration, or 3) securing said purlins below said roof beams in a layered framing configuration, (f) Elevating said solar rack above said base frame by means of elevated loaded construction to secure said roof beams and rack beams, and assembling said solar workpiece by adding rack beam facia in accordance with the above design steps, (g) in the case of said solar rack excluding solar panels, completing the field assembly of said solar workpiece by raising the solar panels to the roof of said solar workpiece by means of aerial loading and attaching them to said inclined support member;
(5) a step of completing construction of a multipurpose solar energy system, wherein the process of said on-site assembly step further comprises the following steps:
(a) after completion of said solar workpiece, work on the remaining portion of the building to conform to the original primary use of the building and the addition of separate facilities therein to conform to or improve said primary use; (b) withdrawal of said construction means used in the site work from the site and clearing the site; and (c) connect the power lines required by the electricity transaction under the Electricity Business Act and other applicable laws and regulations, and install and commission the necessary electrical facilities; and (d) obtain safety and performance certifications from the authorities in accordance with said commissioning, thereby completing the construction of the said MULTIPURPOSE SOLAR ENERGY SYSTEM.

According to embodiments of the present invention, the following means of solving the above problems can be achieved.

Since the multipurpose solar energy system comprises a solar workpiece that can be applied to cultivated as well as non-cultivated land, to new or existing building structures and civil structures, it becomes easier to obtain space for the installation of the solar energy system. Thus, the dissemination of solar energy, which is encouraged and required at the national level, can be expanded.

The term “building structure” includes structures such as residential buildings, shops, schools, workshops, factories, warehouses, barns, sheds, growers, breeders, fish farms, fish ponds, and (semi-shaded) horticultural facilities, and the term “civil structures” includes parking lots, parks, rivers, bridges, railroads, roads, intersections, sidewalks, sewage treatment plants, water treatment plants, docks, moorings, (railway) platforms, roadways, intersections, sidewalks, sewage treatment plants, water purification plants, marinas, soundproof tunnels, and the like, wherein a flat roof solar workpiece according to the technical idea of the embodiments of the invention is added to the building structure or civil structure to effectively complete the solar energy system.

In a building structure, said base frame is formed by erecting pillars on or around the roof or rooftop of the whole or part of the planar area, and in a civil structure, said base frame is formed in the form of a cloister by erecting pillars inside, outside or on the perimeter, and a solar energy system is installed to fulfill the secondary use of utilizing solar energy in addition to the original primary use.

The internal facilities of the base frame include power, communication, lighting, irrigation, pesticide and liquid fertilizer spraying facilities and harmful tide control nets as separate useful facilities to improve the utilization of existing uses such as farming.

The space in which the base frame is installed includes land, water, and swamps, and the base frame is installed by erecting poles on the boundary or inside the space, thereby increasing the utility of land by expanding the space for installing solar energy systems as well as creating other uses such as residential or leisure.

The base frame, which is installed on the water, includes a floating body to form a floating type or semi-floating type structure, thereby facilitating the implementation of the floating solar energy system and simultaneously utilizing the interior space for residential or leisure purposes, thereby increasing the added value of the multipurpose solar energy system.

The base frame further comprises, in addition to the above separate useful facilities, a landscaping structure inside which vines are attracted to a certain position for landscaping, and the space between the roof and the floor of the cubic frame forming the base frame includes facilities for a walkway, a pathway or a camping deck, and if the space is water, a swimming pool or a fish farm is included in the lower part thereof, thereby maximizing the added value of the multipurpose solar energy system.

The main member applied to said solar workpiece comprises a horizontal or vertical long span member having a rectangular section formed by a roll forming process, wherein the flat roof of said solar workpiece is formed as a lattice structure in the form of #, so that said flat roof becomes a load-bearing structure and a disaster-resistant multipurpose solar energy system can be realized.

By overlapping the backs of said one or two layers of main members to form one or two layers of long span members, and by paralleling said one or two layers of main members, including one more, to form a pair of long span members of compound structures (abbreviated as “compound member pair”), further comprising a cross strut for the main member between said compound member pair to form a Vierendeel truss, thereby making said solar workpiece a load bearing structure that resists buckling under horizontal loading.

The connection means of said main member includes direct connection by welding, self-drilling screws or bolt-nut fasteners, or indirect connection with a plate bracket, whereas, the plate bracket is applied by cutting and bending a metal plate sheet according to the shape of the connection part and forming it without a welding process, so that the effect of a load-bearing structure that facilitates construction and strengthens the connection of the main member is exerted.

The type of elevation frame comprising one or more horizontal members and one or more vertical members of said main member forming said base frame, including one or more of a cantilever frame, a portal frame, a box frame, a pile frame, and a mixed frame, a cross-sectional frame of a crosswise type, which is a planar combination type of said elevation frame, a side wall frame of a longitudinal type, and a mixed frame of a mixed type, one or more of which can be optionally mixed and arranged to flexibly form various base frames, thereby facilitating the systematic implementation of a multipurpose solar energy system in a cost-effective manner.

The base frame with the above load-bearing structure can be formed with vertical members of high columns and horizontal members of long beams, so that sufficient workspace can be secured underneath, minimizing the problems caused by using the original land used for primary purposes such as farming, parking, sidewalks, and rivers.

Since the solar panels are fixed and installed on the flat roof of the solar workpiece with a suitable orientation and inclination angle, the solar energy system can be effectively implemented by minimizing the impact of the shape and orientation of the land for primary use. By installing the solar panel with a suitable orientation and inclination angle even in uneven terrain, it is possible to efficiently acquire solar energy while resolving location constraints.

The main member can be procured as a commercially available off-the-shelf product, which is structurally proven and therefore can maintain a high level of quality, and since it is widely used in the construction market, the price-performance ratio is optimized, and as a result, a multipurpose solar energy system can be constructed cost-effectively.

Since the main components according to the embodiments of the invention are manufactured and verified to meet the disaster-resistant design standards in a factory with quality control in advance, and then transported to the site for assembly and installation, it is possible to secure the disaster-resistant structural safety of the multipurpose solar energy system without requiring more systematic construction and highly skilled workers.

In addition, since the main components according to the embodiments of the invention are planned, designed, cut and manufactured in consideration of the construction conditions and road transportation regulations at the site, the components transported to the site can be easily assembled at the site with minimal construction equipment or manpower, enabling systematic and low-cost installation of the multipurpose solar energy system.

Embodiments of the present invention relate to a solar energy system, and more particularly to a multipurpose solar energy system for generating power or heat from solar energy by adding a solar workpiece to an object, such as an agricultural field or a construction structure, that has an intended use, or by itself.

### BRIEF DESCRIPTION OF DRAWINGS

FIG. 1 is a conceptual perspective view of a multipurpose solar energy system formed by a solar workpiece having a roof of a rectangular plane as Example 1 according to embodiments of the present invention.

FIG. 2 is a top and bottom exploded view of the solar workpiece illustrated in FIG. 1.

FIG. 3 is a partially enlarged detailed perspective view of the {I} solar workpiece illustrated in FIGS. 1 and 2 by the dashed oval.

FIG. 4 is a partially enlarged detail perspective view of {II} indicated by the dashed oval in FIGS. 1 and 2 above.

FIG. 5 is a partially enlarged detail perspective view of {III} indicated by the dashed oval in FIGS. 1 and 2 above.

FIG. 6 is a partially enlarged detail perspective view of {IV} indicated by the dashed oval in FIGS. 1 and 2 above.

FIG. 7 is a partially enlarged detail perspective view of {V} indicated by the dashed oval in FIGS. 1 and 2 above.

FIG. 8 is a partially enlarged detail perspective view of {VI} indicated by the dashed oval in FIGS. 1 and 2 above.

FIG. 9 is a partial perspective view showing the formation of an elevation frame by applying a main member made of long span members of compound structures in pairs (abbreviated as “compound member pair”) by adding a single layer of main member in accordance with the technical idea of the embodiments of the invention, with respect to the portion indicated by the double-dashed oval in FIG. 8 above.

FIG. 10 is a partial perspective view showing the formation of an elevation frame with two layers of a compound member pair in accordance with the technical idea of the embodiments of the invention, with reference to the same category as FIG. 9 above.

FIG. 11 is a conceptual perspective view illustrating typical types and combinations of elevation frames forming a base frame for utilizing a subspace in accordance with embodiments of the invention.

FIG. 12 is a conceptual perspective view illustrating typical types and combinations of elevation frames forming a base frame for utilizing a subspace in accordance with embodiments of the invention.

FIG. 13 is a partially enlarged detail perspective view of {VII} indicated by the dashed oval in FIG. 12 above.

FIG. 14 is a conceptual perspective view illustrating a combination of an elevation frame supporting a base frame for utilization of a subspace and an attachment structure for columns, in accordance with embodiments of the invention.

FIG. 15 is a conceptual perspective view of a multipurpose solar energy system formed by a solar workpiece having a roof of a circular arc plane comprising the outer curves of two arcs, as embodiment 2 according to embodiments of the invention.

FIG. 16 is a partially enlarged detail perspective view of {VIII}, indicated by the dashed oval in FIG. 15 above.

FIG. 17 is a partially enlarged detail perspective view of {IX} indicated by the dashed oval in FIG. 15 above.

FIG. 18 is a partially enlarged detail perspective view of {X} indicated by the dashed oval in FIG. 15 above.

FIG. 19 is a conceptual perspective view of a multipurpose solar energy system formed by a solar workpiece having a roof of any polygonal plane constructed on an inclined earth's surface as Example 3 according to embodiments of the invention.

FIG. 20 is a partially enlarged detail perspective view of {XI}, indicated by the dashed oval in FIG. 19 above.

FIG. 21 is a partially enlarged detail perspective view of {XII} indicated by the dashed oval in FIG. 19 above.

FIG. 22 is a partially enlarged detail perspective view of {XIII} indicated by the dashed oval in FIG. 19 above.

FIG. 23 is a conceptual perspective view of a multipurpose solar energy system formed by a hexahedral solar workpiece having a roof of a rectangular plane constructed in a floating type on water as Example 4 according to embodiments of the invention.

FIG. 24 is a partially enlarged detail perspective view of {XIV}, indicated by the dashed oval in FIG. 23 above.

FIG. 25 is a close-up view of the portion of {XV} indicated by the dashed oval in FIG. 23 above.

FIG. 26 is a conceptual perspective view of a multipurpose solar energy system formed by a hexahedral solar workpiece having a roof of a rectangular plane constructed in a semi-floating type on water as Example 5 according to embodiments of the invention.

FIG. 27 is a zoomed-in detail perspective view around the {XVI} portion indicated by the dashed oval in FIG. 26 above.

FIG. 28 is a conceptual perspective view of a multipurpose solar energy system formed by a solar workpiece having a roof of an arbitrary polygonal plane, constructed by erecting columns above the surface of the earth, as Example 6 according to embodiments of the invention.

FIG. 29 is a partially enlarged detail perspective view of {XVII}, indicated by the dashed oval in FIG. 28 above.

FIG. 30 is a detailed perspective view showing the engagement and disengagement of the columns within the range indicated by the double-dashed ellipses in FIG. 29 above.

FIG. 31 is a detailed perspective view of the plate brackets [i] to [vii] described above.

FIG. 32 is a perspective view specifically illustrating the plate brackets [viii] to [xiv] described above.

FIG. 33 is a perspective view of the above-described plate brackets [xv] to [xxi].

FIG. 34 is a perspective view showing the unfolded plane before bending of certain of the above-described plate brackets ([iv], [vi], [vii], [ix], [x]).

FIG. 35 is a perspective view showing the unfolded plane before bending of certain of the aforementioned plate brackets ([xiii], [xix], [xx], [xxi]).

FIG. 36 is a perspective view showing the application of a main member joint bracket for securing a roof beam and a roof beam facia, two main members that form the vertices of a base frame roof plane.

FIG. 37 is a perspective view showing the application of a rack beam-facia bracket for securing a rack beam pair and a rack beam facia that form the perimeter of a solar rack.

FIG. 38 is a perspective view showing the application of a beam-beam superposition bracket for securing a rack beam pair to a roof beam forming the flat roof of a solar workpiece and the reinforcement structure of the rack beam pair.

FIG. 39 is a perspective view showing a column-beam bracket for fastening a column and a roof beam of an elevation frame forming the apex or side of the roof face of a base frame, and a roof beam facia for finishing the ends of said roof beam. A perspective view showing the application of a combined connection bracket incorporating a roof beam-facia bracket and the connection of the main member to another column.

FIG. 40 is a perspective view illustrating the application of a column-beam bracket for anchoring between a column and a roof beam and the combination of said column and roof beam for conversion to a load bearing structure.

FIG. 41 is a perspective view showing the shape of a plate bracket formed by cutting and bending a beam-beam superposition bracket, a rack beam-facia bracket, a main member joint bracket, and a combined connection bracket incorporating a column-beam bracket into a single flat plate.

FIG. 42 is a perspective view showing the shape of a combined connection bracket for connecting multiple beams and columns.

FIG. 43 is a perspective view showing the application of a column-beam bracket for cross-connection of a column and a beam.

FIG. 44 is a perspective view showing a typical shape of a main member as applied to embodiments of the invention.

FIG. 45 is a top and bottom exploded view of a solar workpiece in which the rack beam pair of the solar rack and the roof beam of the elevation frame are nearly orthogonal.

FIG. 46 is a top and bottom exploded view of a conceptual solar workpiece in which the rack beam pairs of the solar rack and the roof beams of the elevation frame are nearly parallel.

FIG. 47 is a conceptual perspective view of a multipurpose solar energy system formed by a solar workpiece on a building rooftop and a building roof as Example 7 for a building structure according to embodiments of the invention.

FIG. 48 is a conceptual perspective view of a multipurpose solar energy system formed by solar workpieces on top of a crosswalk, bridge, and sidewalk as Example 8 applied to civil structures according to embodiments of the invention.

### EXPLANATION OF SYMBOLS

In the following explanation of symbols, the ‘=’ sign means that the left and right sides represent the components of an equality, and the ‘{, , , }’ sign means a set containing multiple components. indicates a set that contains multiple components. For example, the following ‘[roof beam]=[horizontal member]=[main member]’ indicates that the three components are equivalent and that roof beam 210 is a horizontal member and a main member, “[rack beam pair]={[southern rack beam)], [northern rack beam)] }” means that rack beam pair 120 comprises components of southern rack beam 122 and northern rack beam 124.

The embodiments of the present invention are applied to the surface of the earth and the top of a construction structure (abbreviated as “object”), wherein the construction structure is divided into a building structure and a civil structure, as described above. A solar workpiece, as applied to the above object, is understood to be a structure and facility for the construction of a solar energy system, or the solar energy system itself.
[object]={[building rooftop], [top of a construction structure], [above the earth's surface], . . . }
[solar energy system]⊇[solar workpiece]
[construction structure]={[building structure], [civil structures]}

The multipurpose solar energy system presented in the embodiments of the invention is a solar workpiece comprising a solar energy panel according to the technical idea of the embodiments of the invention for generating solar energy.
[multipurpose solar energy system]={[solar workpiece], [energy system remaining components]]}

The solar workpiece includes a solar rack and a base frame, and the solar rack includes a solar energy panel (abbreviated as ‘solar panel’), wherein said solar rack is fixed on said base frame to form a flat roof of said solar workpiece, and thereby an interior space beneath it (i.e., a subspace of the flat roof beneath the solar panel) is formed.
[solar workpiece]={[solar rack], [base frame]}
[solar rack]={[rack beam], [inclined support member], solar panel, +[rack beam facia]}

The solar rack, an element of the above solar workpiece, comprising a rack beam, an inclined support member, and a solar panel, and optionally including a cross strut for the rack beam facia and a cross strut for the rack beam as required (with a ‘+’ sign added). 100: solar rack
120: crossbeam (a pair of two rack beams, abbreviated as ‘rack beam pair’)
122: southern rack beam); 124: northern rack beam)

The rack beam pair 120 is formed by arranging the southern rack beam 122 on the south side and the northern rack beam 124 on the north side in a parallel east-west direction.
[rack beam pair]={[southern rack beam)], [northern rack beam)] }
130˜: cross strut for rack beam; L shaped plate fixture
131˜: series of cross struts for rack beam

The cross strut for rack beam 130 is attached to the southern rack beam 122 and northern rack beam 124 of the rack beam pair 120 in an orthogonal form at certain intervals, so that the rack beam pair becomes a structure of a Vierendeel truss. 140: rack beam facia
160: inclined support member={[support part], [slope part] }
162: support part; 164: slope part
170: solar panel

Said inclined support member 160 includes a horizontal support part 162 that is fixed above said rack beam pair 120 and a slope part 164 having a certain angle of inclination on which the solar panel 170 is installed.

Said base frame is constructed by appropriately positioning a plurality of elevation frames and interconnecting them with structural reinforcements to anchor said footing part to the earth's surface or to an existing structure.
[base frame]={[elevation frame], +[structural reinforcement members], [footing part]}
200: elevation frame={[roof beam], [column] }
[type of elevation frame].
201: cantilever frame; 202: portal frame; 203: box frame; 204: pile frame; 205: mixed frame
[Application form of elevation frame].
206: cross-sectional frame; 207: side wall frame
208: primary cubic frame; 209: secondary cubic frame

The cubic frame formed by the elevation frame 200 may form a composite structure in which the primary cubic frame is supported by a secondary cubic frame.

The type of elevation frame is determined by its components and shape, and as a type of elevation frame, cross-sectional frames 206 are spaced at certain intervals across the subspace, and side wall frames 207 are settled in a row on the outside or inside of the subspace, depending on the arrangement method. Accordingly, an elevation frame may be represented by multiple reference symbols. For example, if an elevation frame is a portal frame and is in the form of a cross-sectional frame, they may be represented together as 200|202, 206. To distinguish between multiple types or formats of the same elevation frame within a drawing, a lowercase letter of the English alphabet is added after the sign. For example, a plurality of cross-sectional frames is indicated as 206a, 206b, 206c, . . .
210: roof beam=[horizontal member]=[main member].
211˜: a series of roof beams

In the above base frame, a horizontal flat roof (abbreviated as ‘flat roof’) of the solar workpiece is formed by forming the roof beam 210 of the elevation frame at a certain height and fixing the rack beam above the roof beam in a lattice structure in the form of #.
[flat roof]={[roof beam], [rack beam]}: #shape lattice structure
220: Column: [left column] or [front column]=[vertical member]=[main member]
221˜: Series of columns
230: Cross strut for main member: E-shaped plate fixture={[cross strut for roof beam], [cross strut for column] }
232: cross strut for roof beam; 234: cross strut for column
240: column: right column or rear column=[vertical member]=[main member
241˜: Series of columns
250: Minor column=[Piston type].
270: Major column=[Cylinder type]

Since said elevation frame 200 includes said roof beam 210 and various columns 220, 240, the reference symbols for them are sometimes shown together, such as 200|210, 220, 240. The various reference numbers 220, 240, 250, 270 assigned to the columns are intended to distinguish them according to their location or type, such as 220 for columns located on the left or front, and 240 for columns located on the right or rear. In addition, columns made of roof beams and other main members are designated by the reference symbol 250, and other types of columns, such as 250, 260, are designated by the reference symbol, and multiple columns are indicated by a series of numbers in the drawing (e.g., 250|251, 252, 253, . . . ).

A structural reinforcement material, which is a horizontal member, is optionally added between the elevation frames applied to the base frame, so that a solar workpiece characterized by load-bearing capacity is completed.
[structural reinforcement members]={[bracing beam], [purlin], . . . }
310: bracing beam
320: purlin;
322: upper purlin; 324: middle purlin; 326: bottom purlin

An outskirt member is a structural horizontal member (abbreviated as “outskirt member”) that incorporates a rack beam facia over a roof beam, roof beam facia, or bracing beam that finishes the outside of a flat roof.
340: roof beam facia
350: middle beam; 360: bottom beam

The roof beam facia 340 is a horizontal member that finishes the ends of the roof beam 210 at the same height, and the purlin 320 is a main member that attaches the horizontal member below the roof beam 210, bracing beam 310 is a main member that connects the horizontal member to the existing column 220, 240 or roof beam 210 at the same height as roof beam 210, and when columns are added to both ends of said bracing beam 310, it is called a roof beam and functions as a roof beam.

Said middle beam 350 or bottom beam 360 is fixed as a horizontal member to the lower part of the pillar as one of the components of said elevation frame in the same manner as roof beam 210 in the formation of said elevation frame 200 in the form of box frame 203 or pile frame 204, and said bracing beam 310 or purlin 320 (which is subdivided into upper purlin, middle purlin, and lower purlin according to its location) is the main member connecting and fixing said elevation frame 200 plurality. Said bracing beams are connected and fixed between forming the roof surface of the base frame.

The main member may be a roof beam, column, roof beam facia, bracing beam, or purlin of an elevation frame that forms the base frame, or as a long span member applied to a rack beam pair and a rack beam facia forming a flat frame of a solar rack, horizontal elements are referred to as horizontal members and vertical elements are referred to as vertical members, depending on the direction in which they are laid, and members having a rectangular section by a roll forming process are preferred. Accordingly, one roof beam 210 is both a horizontal member and a main member.
400: footing part
440: waterbed settlement means
442: anchor support member; 444: anchor rope; 446: anchor

The footing part 400 is a framing settlement means and includes a waterbed settlement means 440.
490: floating body

A cross-sectional shape of the main member includes an oblong cross-section, and has an elemental appearance as shown below.

### [Cross-Sectional Shape of the Main Member].

512: long side; 514: short side
516: backside; 517: frontside; 518: upper side; 519: bottom side

The main member is divided into a horizontal member and a vertical member, and there is a single layer member made of a single layer main member and a double layer member made of two single layer members overlapping into one, Each of said single layer member or double layer member is further arranged in parallel at a certain interval and fixed orthogonally between them with a cross strut for main member to form a main member (abbreviated as ‘compound member pair’) as a long span member of a paired compound structure. In other words, the compound member pair includes a single layer pair comprising two single layer members and a double layer pair comprising two double layer members.
560: compound member pair

In the above main member, a member having a rectangular section by a roll forming process is preferred, but without limitation, various cross-sectional shapes other than the rectangular section and combinations thereof are also employed depending on the convenience of connection between the main members, the robustness of the structure, or the cost effectiveness.
600: handrail;
610: (handrail) long horizontal member; 620: short horizontal member; 650: (handrail) tall vertical member; 660: short vertical member

The above means rack beam-facia connection means, roof beam-facia connection means, column-purlin connection means, beam-beam superposition connection means, column-beam connection means, and main member joint connection means. rack beam-facia bracket, as each plate bracket applied to a column-beam connection means, roof beam-facia bracket, column-purlin bracket, beam-beam superposition bracket, column-beam bracket, and main member joint bracket use the same reference symbol. For example, a beam-beam superposition connection means and a beam-beam superposition bracket are denoted by 740, and a series of single or double brackets are denoted by 741, 742, 743, . . .

When a number of the same or different types of connection means are located adjacent to each other, the related connection means are merged into a combined connection means 790, and a plate bracket is applied to give the same reference symbol as the combined connection bracket 790.
[main member joint connection means for connection of main member]=[main member joint bracket]]
709: self-drilling screw
710: [rack beam-facia connection means]=[plate bracket for rack beam-facia connection] (abbreviated as ‘rack beam-facia bracket’)
711˜: a series of rack beam-facia brackets (rack beam-facia bracket)
720: roof beam-facia connection means=plate bracket for beam-facia connection (abbreviated as ‘roof beam-facia bracket’)
721˜: a series of roof beam-facia brackets (roof beam-facia bracket)
730: column-purlin connection means=plate bracket for column-purlin connection (abbreviated as ‘column-purlin bracket’)
731˜: a series of column-purlin brackets (column-purlin bracket)
740: beam-beam superposition connection means=plate bracket for beam-beam connection (abbreviated as ‘beam-beam superposition bracket’)
741˜: a series of beam-beam superposition bracket (beam-beam superposition bracket)
750: column-beam connection means=plate bracket for column-beam connection (abbreviated as ‘column-beam bracket’)
751˜: a series of column-beam brackets (column-beam bracket)
760: main member joint connection means=plate bracket for main member joint connection (abbreviated as ‘main member joint bracket’)
761˜: series of main member joint brackets (main member joint bracket)
790: combined connection means=plate bracket for combined connection (abbreviated as ‘combined connection bracket’)
791˜: a series of combined connection brackets (combined connection bracket)

Describe the features of the plate bracket shape by defining rounded corner, beveled edge, curved edge, overlapping surface, borrowing surface, contact line (reference line), contact angle, and contact surface.

### [Shape of a Plate Bracket].

811: rounded corner; 812: beveled edge; 813: curved edge/component outline; 814: overlapping surface; 815: borrowed surface
820: Contact line (baseline); 822: Horizontal contact line; 824: Perpendicular contact line
830: Contact angle
840: Contact surface; series of contact surfaces: 841, 842, 843, . . .
900: earth's surface (land, water); 910: surface water level; 920: surface slope
930: above water; 940: water bottom
950: building rooftop; 960: crosswalk; 970: building roof; 980: bridge; 990: sidewalk

### Explanation of Terms

With reference to the accompanying drawings, various embodiments of the invention will be described in detail so as to facilitate the practice of one having ordinary skill in the art to which the embodiments of the invention belong. However, the ideas of the embodiments of the invention can be implemented in many more forms and are not limited to the embodiments described herein. The terms used herein are defined in view of the function and operation of the embodiments of the invention and are intended to describe specific embodiments only, and are not intended to limit the ideas of the embodiments of the invention, but they may be understood differently by the reader or by convention, and definitions should be made in light of the embodiments of the invention as a whole.

The shapes shown in the drawings are only approximate in nature and include various components to express the technical idea of the embodiments of the invention, but they are not intended to show the exact shape of the technical idea, nor are they intended to narrow the scope of the embodiments of the invention. Rather, the drawings shown below and the following description relate to preferred embodiments of various methods for effectively illustrating the features of the embodiments of the invention. Nevertheless, the embodiments of the invention are not limited to the following drawings and description.

Consequently, the technical idea of the embodiments of the invention is determined by the claims, and the following embodiments are only one means of effectively explaining the technical idea of the advanced embodiments of the invention to one having ordinary knowledge in the technical field to which the embodiments of the invention belong.

In addition, the sizes and shapes of the components shown in the drawings are depicted as closely as possible to scale, but may be exaggerated to some extent for clarity and convenience. Terms specifically defined in view of the construction and operation of the embodiments of the invention may be understood differently according to the reader's intent or custom, but definitions of such terms should be based on the entirety of this specification.

In this specification, references to components of embodiments of the invention in the singular form include the plural form unless expressly defined as singular in the relevant context.

In addition, components predefined and recited in the description of the claims and elsewhere are sometimes indicated by using the word “said” in the same form as a preposition, substituting it for an indicative noun for the thing immediately preceding it, or by omitting “said member in said component” in favor of “member in said component” or simply “said member,” and “said component A and/or said component B” in favor of “said components A and/or B.

Also, in the description of the drawings, the prefixes ‘before’, ‘after’, ‘left’, ‘right’, and ‘center’ refer to relative positions in the drawings, and in the components of the embodiments of the invention, the prefixes ‘˜top’, ‘center’, and ‘bottom’ refer to relative upward and downward positions of an observer with respect to the hexahedral object or space shown in the drawings, and ‘˜top’, ‘˜bottom’, ‘˜left’, and ‘˜right’ suffixes refer to the top, bottom, left, and right ends or portions of the object depicted in the drawing, ‘horizontal’ and ‘vertical’ refer to the length of the left and right directions horizontally and the length of the front and back directions vertically in the depicted cuboidal space, and the prefixes ‘horizontal’ and ‘perpendicular’ also refer to the depicted cuboidal space.

In addition, the meanings of “comprising” and “having” are intended to specify certain characteristics, areas, integers, steps, actions, elements, and/or components, and not to exclude the existence or added value of other such things and/or groups.

Further, the meaning of “consisting of” is to make or form a component from a limited number of members.

Also, “forming” and “being resulted in” means to be made into a structure of a certain shape or to become something causally.

Also, “being positioned in” means to place on or next to a specific part of a component.

Also, “being fixed to” means to attach a member to another member or to a part of a component to form a permanent structure. The act of “fixing” includes the near-permanent joining of members in the factory or field, such as by welding or bolt nut fasteners. Almost interchangeably, “being attached to” means having another component firmly attached to a main component.

Also, “being directly connected to, being coupled with” means to be connected to a thing by means of a connection means and to be fixed to it.

Also, the meaning of “being settled in by settlement means” is that a component is firmly attached to a place or object by relevant means.

Further, the meaning of “being mounted on by mounting means” is to be semi-permanently united by attaching one component to another component by relevant means.

The words “to connect,” “to settle,” and “to adhere,” with associated means, are used interchangeably to refer to the site-specific use of components of the embodiments of the invention, and the act of assembling them in a factory or field to make them semi-permanently integral by means such as welding, rivets, or bolt-nut fasteners.

In addition, the meaning of “being installed to” is to place a component in place by fastening it to another finished product.

Also, the quantity of “one or more” is simply “one or more,” “pair” is two components functioning as one, and “plural” and “multiple” are used to indicate more than one component, with multiple indicating more components than plural.

In addition, “certain” is a value that is predetermined, designed, or planned, but is an arbitrary constant, and is used as a qualifier or preposition, such as “certain” spacing, “certain” height, “certain” length, “certain” distance, “certain” radius of curvature, “certain” position, and “certain” space, and “respectively” is used as an adverb to modify each of the aforementioned components in turn.

In addition, “parallel”, “perpendicular”, “vertical”, “horizontal”, and “plumb” as used in mathematical or engineering terms are understood to be accuracy or precision in the range allowed in actual civil and architectural design.

Furthermore, while an “architecture” is defined as a work of art that is constructed by humans and anchored to the ground, and a “building” is defined as a structure for continuous habitation as a form of architecture, no distinction is made herein between an architecture or a building, and the terms work of art and structure are utilized interchangeably depending on the context.

Also, in general, a “solar workpiece” is broadly divided into a “building structure,” which is a structure that forms a building such as a house, a shopping center, etc. and a “civil structure,” which is a structure related to infrastructure such as roads, rivers, etc. other than the above, but the technical idea of the embodiments of the invention is applied to define a workpiece that is newly constructed or added as a solar workpiece including solar panels as a multipurpose solar energy system.

A “rack” is a structure supported on a base to support something, a “solar rack” is a trestle on which solar panels are installed or to be installed, and a “base frame” is a structure or framework that forms a building, and the solar workpiece that functions as a multipurpose solar energy system is formed by a solar rack and a base frame. In other words, solar panels are installed on the solar workpiece to realize a multipurpose solar energy system according to the technical idea of the embodiments of the invention.

The base frame can be utilized in the construction of the building structure, as well as added to an existing building or civil structure to implement the multipurpose solar energy system.

Further, the method of forming a plane of a frame with a plurality of main members through connection means includes flush framing and layered framing, wherein said flush framing comprises securing the other main members while ensuring that the plane formed by the main members remains at the same height, and wherein said layered framing comprises securing the main members in one plane while allowing another plane to be formed by superimposing other main members.

It also includes platform framing and balloon framing in the form of forming the frame itself from a plurality of main members via said connection means, wherein said platform framing is formed by forming a frame of a certain height or length with a main member of a certain length and connecting another main member of a certain length above or next to it to form a frame, Whereas, the platform framing is mainly flush framing, and the balloon framing is mainly layered framing by applying one long span member, the main member, to form a horizontal or vertical frame, and whereas, the balloon framing is mainly layered framing.

Timber framing, wherein the base frame includes a heavy framing and a light framing, and the heavy framing has a small number of heavy vertical members, called columns, pole building framing, and heavy-steel framing, wherein the light structure includes balustrade framing, platform framing, and light-steel framing, wherein the heavy structure has a greater number of lightweight vertical members.

Referring now to the accompanying drawings, the features and operating principles of preferred embodiments of the invention will be described in detail.

However, when it is necessary to distinguish and describe components or parts having the same function, a different series of sub-reference symbols shall be given within the drawing. A ‘l’ shall be added between the original reference symbol and the subordinate reference symbols, and a comma ‘,’ shall be placed between them when multiple subordinate reference symbols of the same function are shown together. For example, a typical reference symbol for a column is 220, but if you need to distinguish between two columns within a drawing, you might refer to one column as 220|221 or simply 221 and the other as 220|222 or simply 222. Both columns can also be referred to as 220|221, 222. However, when it is difficult to assign a sub-reference number, a series of lowercase letters can be added to distinguish components or parts that have the same function. For example, the reference symbol for a portal frame in an elevation frame is (202), but to distinguish between multiple portal frames in a drawing, they are referred to as (202a), (202b), (202c), . . . to distinguish the multiple portal frames in the drawing. If any of the above sub-reference symbols have a special meaning within a drawing, it should be mentioned in the description of that drawing.

Also, when referring to multiple different components in one part of the drawing, or when referring to multiple of the same component in the description of the drawing, place a comma ‘,’ between the multiple symbols. For example, when one bracket 710 is adjacent to another bracket 750 to form another combined connection bracket 790, the reference symbol is given as 790|710, 750. This indicates that the combined connection bracket 790 is viewed as a parent component of the other brackets 710, 750. In some cases, when the number of brackets is large and it is difficult to show them as one in the drawing, they are given separately or omitted. Also, when multiple identical components are referred to in the description of the drawings, they are designated as combined connection brackets 791, 792, 793, 794.

In addition, when one component is separated from another component in the drawing and is intended to be shown together, it is separated by an ampersand ‘&’. For example, fixing two roof beams 210|211, 212 & 213, 214 and columns 220|221, 222 & 223, 224 means fixing roof beams 211, 212 and columns 221, 222 and another roof beam 213, 214 and another column 223, 224 respectively.

In addition, a dotted line in the drawings indicates the outline or extent of a component, and a single dashed line is utilized as a reference line for disassembling and deploying the component. The expanded component is highlighted with a darker hue than the component in its original position to distinguish it, and the unexpanded component is darkened to keep it in place.

Also, to distinguish one set of components in a drawing from another set of components, a different color tone is used to help distinguish them.

In addition, a dotted line through a reference symbol in a drawing is used when the component to be referenced is not visible in the drawing, but is explicitly present in the area indicated by the line and needs to be cited in the description.

### DETAILED DESCRIPTION OF THE INVENTION

### Embodiment 1

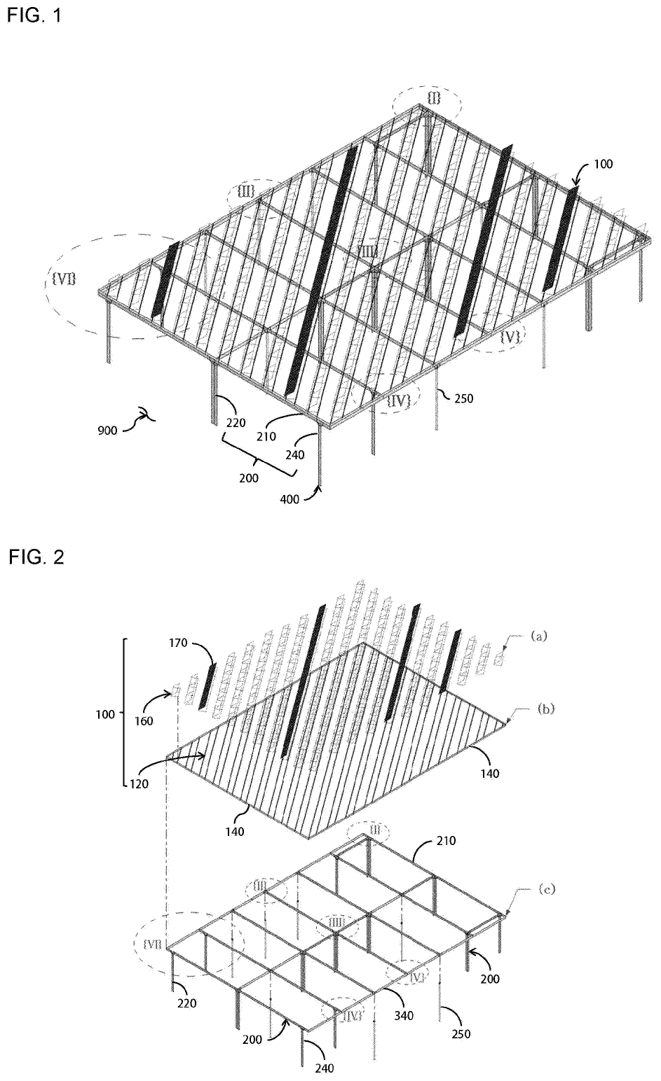

FIG. 1 is a conceptual illustration of a multipurpose solar energy system formed by a solar workpiece having a roof of a rectangular plane that is settled on an object, an earth's surface 900, as an embodiment of the present invention.

The interior space of the solar workpiece (i.e., the subspace of the solar panels) is utilized for various purposes such as straight roads, rivers, parking lots, and agricultural fields, and the solar workpiece includes a solar rack 100 on top and a base frame below it, wherein the base frame includes a plurality of elevation frames 200 and a footing part 400, wherein the elevation frames 200|210, 220, 240 include one horizontal member, a roof beam 210, and one or more vertical members, a column 220, 240. While said horizontal members and vertical members are generally formed as main members of a long span member having the same rectangular section, it is shown that instead of said main member, the columns are replaced by cylindrical columns 250 or the like of different shapes.

Said elevation frame 200 is disposed crossing the inner space of said subspace, or along the perimeter of said subspace, so that said roof beam is of a certain height, wherein said rack beams are fixed on said roof beams so that one or more polygonal horizontal flat roofs (abbreviated as ‘flat roofs’) are formed, said roof beams being oriented differently from said rack beams, whereby said flat roofs are formed in a plane including a plurality of roof beams and rack beams which are horizontal members.

Said footing part is anchored to said object by including framing settlement means at the bottom part of said columns. Said footing part is constructed in the same manner as the foundation of a conventional building structure, and is therefore not specified. Said framing settlement means includes weight supports or base plate fixtures, said weight supports and base plate fixtures may be placed or anchored on a concrete or pile foundation, and said footing part is settled in a predetermined direction and spacing within said subspace.

The types of foundations for the application of the framing settlement means include a continuous footing, a mat foundation, an independent footing and a pile foundation, wherein the continuous footing is the foundation to which the walls are connected, The mat foundation is a foundation that creates a floor slab over the entire building or an extensive part of it, the independent footing is a foundation that is created by individual columns, and the pile foundation is a foundation in which piles are driven into the soft ground and other foundations are applied on top of them, which is determined by the shape of the building, the load, the bearing capacity and the terrain.

In order to efficiently utilize and conserve agricultural land, the administrative authorities designate agricultural promotion areas (Article 28, paragraph 1 of the Agricultural Land Act), and cultivated land in agricultural promotion areas is generally laid out in a rectangular shape. (Korean Design Standard, KDS 67 50 10, ‘2018 Cultivation Plan’, enacted on Apr. 24, 2018, Ministry of Agriculture, Food and Rural Affairs) According to the ‘2018 Cultivation Plan’, in the case of flat land (1/200 or less), a parcel of cultivated land is a rectangular structure with an area of 30-90a, a short side of 30-60 m and a long side of 100-150 m.

As one embodiment according to embodiments of the invention, FIG. 1 illustrates a plurality of columns 220, 240, 250 arranged at certain intervals parallel to the longitudinal and transverse sides of said earth's surface (e.g., cropland 900) to settle into a matrix distribution, and joined between the columns, which are adjacent vertical members at a certain height above the earth's surface, in the transverse and longitudinal directions by long span members, which are horizontal members.

Said columns 220, 240 include a cylindrical column 250, a square tube pillar, a truss type column, or a main member applied to said rack beam or roof beam, includes a horizontal or vertical long span member having a rectangular section by a roll forming process, said main member having a length of a certain height capable of functioning for said spatial use.

The oval dotted lines in FIG. 1 and the Roman numerals {I}, {II}, {III}, {IV}, {V}, {VI}. The subscripted portions are intended to describe in detail the upper coupling state of the solar workpiece.

FIG. 2 is a disassembled view of said solar workpiece illustrated in FIG. 1 in an upward and downward direction.

Said solar rack 100 includes a plurality of rack beams 120, an inclined support member 160, a solar panel 170, and a rack beam facia 140, wherein reference symbol (a) in the drawing shows a form in which a solar panel 170 is attached to said inclined support member 160, and reference symbol (b) in the drawing shows a form in which said rack beam 120, which is a horizontal member, and its periphery is pasted with a rack beam facia 140 to form a single flat frame.

Said solar rack 100 includes at least one pair of two rack beams (abbreviated as “rack beam pair” 120), said rack beam pair 120 being disposed in an east-west direction, and said multiple rack beam pairs being disposed in parallel at certain intervals.

Reference symbol (c) in the drawing indicates a base frame forming said solar workpiece, and shows various applications of the formation and arrangement of said elevation frame 200 and the columns 220, 240, 250 by type. The base frame is a consecutive building type in a three-dimensional form, as will be described in more detail hereinafter.

The rack beam pair 120 of the solar rack is placed on the roof beam 210 of the base frame and fixed in the form of layered framing, so that the flat roof of the solar workpiece formed by the rack beam and the roof beam becomes a lattice structure in the form of #, Furthermore, by fixing said inclined support member 160 on said rack beam pair 120, it becomes a load bearing structure for the loads on said flat roof.

By adding rack beam facia 140 and roof beam facia 340 to the flat frame of said solar rack 100 and the elevation frame 200 of said base frame, respectively, said solar workpiece becomes a load bearing structure. Generally, the rack beam facia 140 and the roof beam facia 340 are arranged up and down on the same outline as the main member that finishes the roof of the solar workpiece.

The total amount of solar energy reaching the earth's surface is represented by horizontal insolation. The location for installing a solar energy system is not only limited to the availability of land or buildings, but can also be influenced by the surrounding objects. The biggest factor that affects the amount of insolation on the solar panel is shading by surrounding objects. Shading by the solar panels themselves or by the surrounding objects can be solved by considering the solar energy system from the design stage. Various impacts of the solar energy system on the outside of the site must also be considered. Owners of land or facilities located off-site also have the same sunlight rights. Embodiments of the invention first provide a facility for minimizing the impact of the solar energy system on and around the site. By enabling the subspace to be used for the original primary use and the solar panels to be arranged flatly on the upper part of the subspace to fulfill the secondary use of electricity generation, it is possible to contribute to the dissemination of solar energy, especially by enabling the installation of solar energy systems on idle areas (parking lots, small parks, rivers, sidewalks, roads, crossings) that do not require 100% solar energy for the primary use.

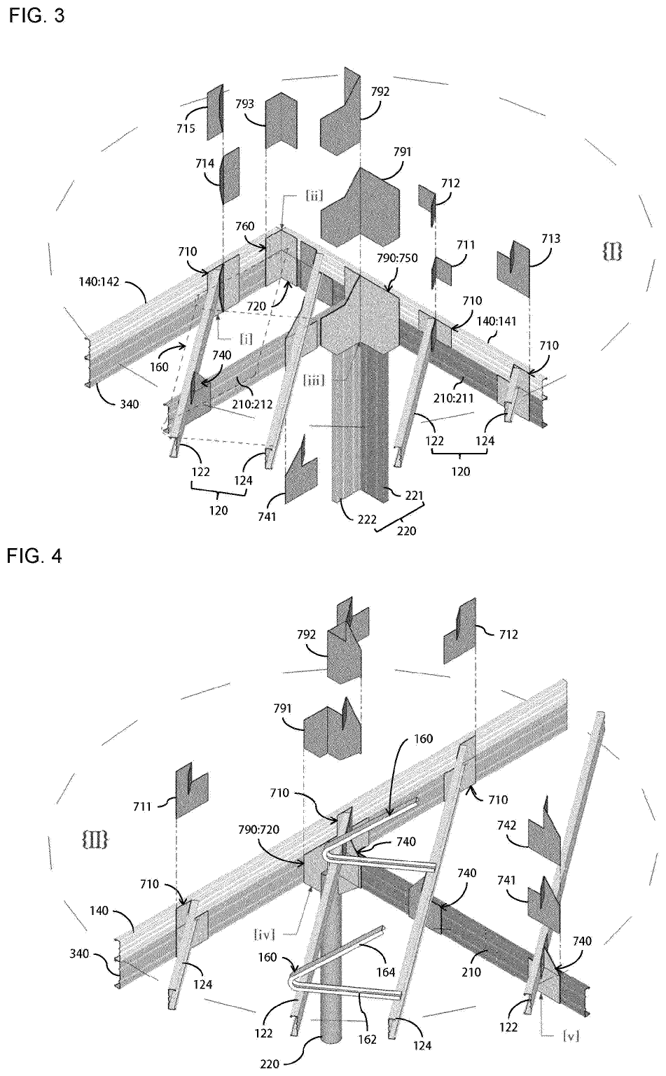

FIG. 3 is an enlarged and detailed view of the portion {I} indicated by the dashed oval in FIGS. 1 and 2 above.

The rack beam pair 120 includes a southern rack beam 122 on the south side and a northern rack beam 124 on the north side, said southern rack beam and northern rack beam being placed parallel at certain intervals, and an inclined support member 160 being installed and fixed thereon.

The base frame illustrated herein includes two elevation frames, one formed by a roof beam 211 and a column 221 on the right side, and the other formed by a roof beam 212 and a column 222 on the left side. Said base frame shows a composite structure in which the two roof beams 210|211, 212 form said portal frame, which is each an elevation frame, sharing the two columns 220|221, 222 as one.

The left end of roof beam 211 of said elevation frame, i.e., the outline of the roof face of said base frame, is finished with roof beam facia 340, and said rack beam pair 120 is supported on roof beams 211, 212 or roof beam facia 340 forming said base frame, and the outline of said flat frame formed by said rack beam pair 120 is finished with said rack beam facia 140.

Said rack beam pair 120 rests on top of roof beam 212, and its ends are attached and secured to rack beam facia 140, roof beam facia 340, and the other roof beam 211.

In one of the best forms for implementing the embodiments of the invention, the planar frame of said solar rack is adapted to conform to the roof surface of said base frame, thereby making the entire solar workpiece a load-bearing structure, and the connection of said column 221, 222, roof beam 211, 212, rack beam pair 120, rack beam facia 140, and main member forming roof beam facia 340 can be directly connected by welding, self-drilling screws, or bolt nut fasteners, but an indirect connection with a plate bracket is shown here. In this regard, the rack beam-facia connection means, roof beam-facia connection means, column-beam connection means and column-purlin connection means described above and below are all equivalent.

Said rack beam facia 140 is a main member similar to said rack beam, which consolidates said flat frame by fixing the ends of adjacent rack beams with rack beam-facia connection means 710, and said right rack beam facia 140|141 and left rack beam facia 140|142 are assembled by fixing them with main member joint connection means 760 at conner parts in a horizontal plane, wherein said roof beam facia 340 is a main member similar to said roof beam 211, 212, and is secured to the end of the adjacent roof beam 211 with roof beam-facia connection means 380, and said roof beam 211, 212 is secured to the top part of said column 221, 222 with column-beam connection means 750, and said rack beam pair 120 is resting on said roof beam 210 and is secured with beam-beam superposition connection means 740.

The rack beam-facia connection means 710, main member joint connection means 760, roof beam-facia connection means 380, column-beam connection means 750 and beam-beam superposition connection means 740 include a bracket attached to the connection part of the two main members for indirect connection by welding, self-drilling screw or bolt nut fastener.

Said bracket is formed to be attached to a connection part of said main member, said connection part comprising one side of a contact point between the main members, and said means of forming said bracket is casting processing, press processing, sheet metal processing, and composite material processing, wherein the sheet metal processing comprises one or more of the shaping means of shearing, bending, and welding.

The bracket includes a plate bracket formed from a single sheet of plate, wherein the sheet metal processing includes the form of a single bracket, a double bracket, and a combined bracket, wherein said single bracket is formed in one piece and applied to one point of said connection part, and said single bracket of one particular shape is not applied to the following double bracket, and said double bracket is formed in two pieces and applied together to one point of said connection part, Said double bracket formed in two pieces can be applied as said single bracket by selecting one of them, and the form of said merging bracket is applied to said connection part as a whole by merging the shapes of the corresponding brackets to form said single bracket or double bracket at a point where there are two or more adjacent connection parts or three or more main members passing through the connection part.

The merging bracket is called a rack beam-facia bracket, a roof beam-facia bracket, a beam-beam superposition bracket, and a column-beam bracket, column-purlin bracket, and main member joint bracket are adjacent and the said plate bracket overlaps, the overlapping plane shall be cut into a single plane and formed into a single bracket or double bracket type and applied to the said connection part as a combined connection bracket.

rack beam-facia bracket 710 for connection limited to rack beam facia 1401141 of rack beam 122 in rack beam pair 120 on the center right of said bracket is formed as said double bracket 711, 712, rack beam-facia bracket 710 for connection to rack beam facia 140|141 and roof beam 211 of rack beam 124 together is formed by said single bracket 713, and rack beam-facia bracket 710 for connection to rack beam facia 140|142 and roof beam facia 340 of rack beam 122 together in left rack beam pair 120 is formed by said double bracket 714, 715.

Further, a beam-beam superposition bracket 740 for connection of rack beam pair 120|122, 124 on top of said roof beam 212 among said brackets is formed by said single bracket 741, and the right roof beam 211 and left roof beam 212 forming said two elevation frames are each shared on one side by a column 220|221, column-beam bracket 750 for connection to the top of 222 is formed as a double bracket 791, 792 as a combined connection bracket 790, and main member joint bracket 760 for connection of right rack beam facia 1401141 and left rack beam facia 140|142 and roof beam-facia bracket 380 for connection of right roof beam 211 and left roof beam facia 340 are formed as a single bracket 793 as a combined bracket.

Directly above said right roof beam 211 and left roof beam facia 340, the two main members of each of the right rack beam facia 140|141 and left rack beam facia 140|142 are integrated, and the bracket applied to them is formed in the form of a merging bracket.

The column-beam bracket 750, which is applied to the connection between the top of one vertical member 220 and the contact area of the other horizontal member 210, is formed on the basis of a rectangular plane formed by extending the back surface of the horizontal member and the back surface of the vertical member in a straight line (abbreviated as “reference rectangular plane”), wherein the reference rectangle includes left and right (left & right) vertical corners and up and down (up & down) horizontal corners, and the left and right vertical corners of the reference rectangle protrude outwardly from the width of the vertical member to a certain distance in the left and right directions of the horizontal member when the horizontal member protrudes outwardly from the reference rectangle, Accordingly, when the vertical member is supported against the end of said horizontal member, only one of the left and right perpendicular corners of said reference square protrudes, and the lower horizontal corner of said reference square protrudes outwardly from the width of said horizontal member for a certain distance in the direction below said vertical member, wherein a single bracket is formed by connecting the two vertices of said horizontal corner and the lower two vertices of the left and right vertical members to form an inclined surface, and a double bracket is formed by overlapping said single bracket.

In the drawing, the rack beam-facia connection means 7101714, 715 of the left rack beam facia 140|142 and roof beam facia 340 of one part are designated by the reference symbol [I], and the combined connection bracket 7901793 of the main member joint connection means 760 & roof beam-facia connection means 380 of the part forming the corner of the said flat roof are designated by the reference symbol [II], and column-beam connection means 7901791, 792&750 in the area where a shared column 220|221, 222 supports two roof beams 210|211, 212, which will be re-described separately in another drawing as [iii].

FIG. 4 is an enlarged and detailed view of the portion {II} indicated by the dashed oval in FIGS. 1 and 2 above.

It shows a base frame formed by connecting roof beam 210 and roof beam facia 340 and supporting the connection point with a cylindrical column 220. The cylindrical column 220 is shown to illustrate one option for forming the base frame in the application of the technical ideas of the embodiments of the invention, and of course the column 220 may be replaced by other forms.

The rack beam pair includes a southern rack beam 122 on the south side and a northern rack beam 124 on the north side, said southern rack beam and northern rack beam being parallel to each other at certain intervals, on which an inclined support member 160 is installed and fixed. Said inclined support member 160 includes a horizontal support part 162 and a slope part 164 having a predetermined inclination angle, said support part 162 being fixed perpendicularly across said southern rack beam 122 and northern rack beam 124 in a plane, and said solar panel 170 being installed on said slope part 164.

As said inclined support member 160 is fixed in a suitable orientation, the solar panel is installed at a suitable inclination angle fixed on said inclined support member 160, which is a value determined in the vicinity of a southwardly directed northern latitude inclination angle for a northern hemisphere region or a northwardly directed southern latitude inclination angle for a southern hemisphere region.

The rack beam pair 120 rests on the roof beam 210 and is secured by a beam-beam superposition connection means 740, the ends of which are attached to an integral rack beam facia 140 and roof beam facia 340 and secured by a rack beam-facia connection means 710, and one end of the roof beam 210 is secured by a roof beam-facia connection means 380 that terminates in the roof beam facia 340.

The plate brackets corresponding to said beam-beam superposition connection means 740, rack beam-facia connection means 710 and roof beam-facia connection means 380 are beam-beam superposition bracket 740, rack beam-facia bracket 710 and roof beam-facia bracket 380.

In the upper part of the cylindrical column 220, the rack beam-facia bracket 710, the roof beam-facia bracket 380 and the beam-beam superposition bracket 740 are located closely to each other, so that they are formed in the form of double brackets 791, 792 of the combined connection bracket 790.

It is shown that the rack beam-facia bracket 710 is formed in the form of a single bracket 711, 712, and the beam-beam superposition bracket 740 is formed in the form of a double bracket 741, 742. The rack beam-facia bracket 710 for the above rack beam-facia connection means 710 is capable of forming two shapes of single bracket 711, 712.

The combined connection bracket 790 of the rack beam-facia connection means 710, beam-beam superposition connection means 740 & roof beam-facia connection means 380 above the column 220 in the drawing is denoted by the reference symbol [iv], and the beam-beam superposition connection means 740 above the roof beam 210 is denoted by the reference symbol [v], and will be described again in another drawing separately.

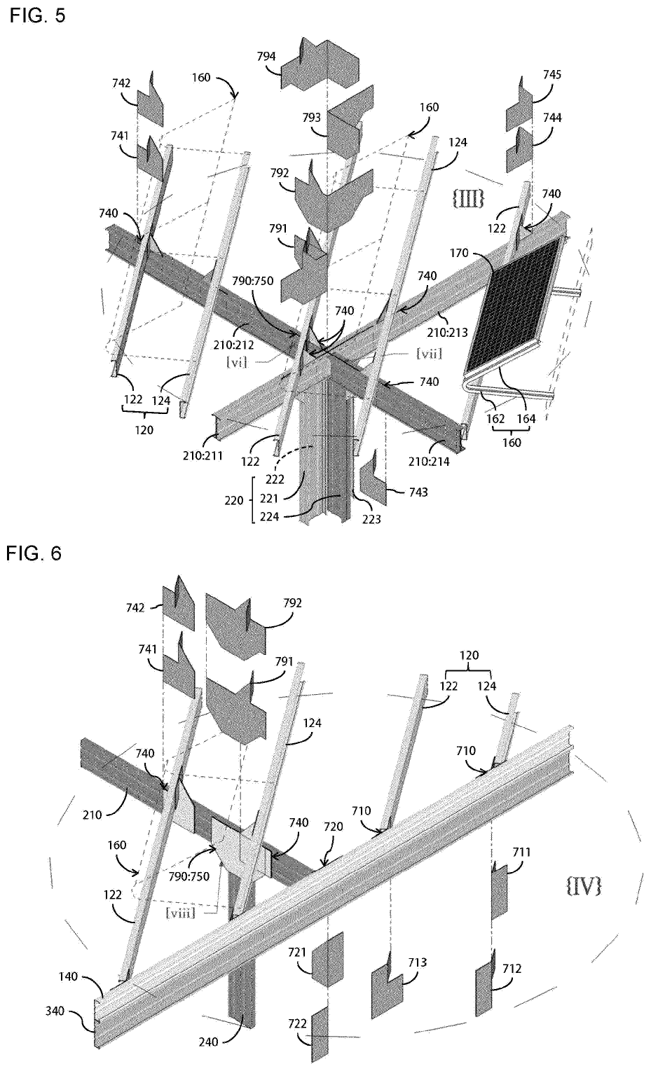

FIG. 5 is an enlarged and detailed view of the portion {III} indicated by the dashed oval in FIGS. 1 and 2 above.

The base frame shown here shows a composite structure in which four roof beams 210|211, 212, 213, 214 intersect at right angles to form a respective elevation frame (said portal frame), sharing a single column 220|221, 222, 223, 224, first on the front side (longitudinal) with roof beam 211 and column 221, The second is a roof beam 212 and a column 222 on the left side, the third is a roof beam 213 and a column 223 (this column is located opposite 221 and is not visible) on the rear side (longitudinally), and the fourth is an elevation frame with a roof beam 214 and a column 224 on the right side, forming the base frame.

Each of said roof beam 210 and column 220 is an example of applying two layers of main members by attaching two main members, and each of said column 220, rack beam 120, roof beam 210, rack beam facia, roof beam FACIA, bracing beam, and purlin includes one more main member identical to the main member used, wherein the back surfaces of the two main members of said one-ply are overlapped and secured together by welding, self-drilling screws, or bolt-nut fasteners to form a single two-ply long span member.

Again, the rack beam pair 120 includes a southern rack beam 122 on the south side and a northern rack beam 124 on the north side, wherein the southern rack beam and the northern rack beam are parallel to each other at certain intervals, and an inclined support member 160 is installed and fixed thereon. Said inclined support member 160 includes a horizontal support part 162 and a slope part 164 having a predetermined inclination angle, said support part 162 being fixed vertically (orthogonally) across said southern rack beam 122 and northern rack beam 124 in a plane, and said solar panel 170 being installed on said slope part 164.

Said roof beam 210|211, 212, 213, 214 is fixed with column-beam connection means 750 on top of said column 220|221, 222, 223, 224, and said rack beam pair 120 is resting on said roof beam 210 and fixed with beam-beam superposition connection means 740. The plate brackets corresponding to said column-beam connection means 750 and beam-beam superposition connection means 740 are column-beam bracket 750 and beam-beam superposition bracket 740.

At the top of the shared column 220, the four column-beam brackets 750 and the two beam-beam superposition bracket 740 are located in close proximity to each other so that they are formed in the form of quadruple brackets 791, 792, 793, 793 of the combined connection bracket 790.

The beam-beam superposition bracket 740 is shown formed in the form of a single bracket 743 or in the form of a double bracket 741, 742, 744, 745. Those in the form of double brackets can be adapted as single brackets by taking either of them. In this regard, both the aforementioned and the following double brackets are equivalent.

The combined connection bracket 790 and the beam-beam superposition bracket 740 are applied by sandwiching them between the back surfaces of the two layers of the main member, and are secured by fastening means such as welding, self-drilling screws, or bolt nut fasteners. The fastening means are not shown in order to improve the readability of the drawings. In this regard, both the aforementioned and the following fastening means are equivalent.

A quadruple bracket 791 of a combined connection bracket 790 formed by a plurality of column-beam connection means 750 and beam-beam superposition connection means 740 adjacent to a connection part of the shared column 220|221, 222, 223, 224 and the semi-straight roof beams 210|211, 212, 213, 214 projecting in four directions, 792, 793, 793) will be divided into two, and the left side 791, 792 will be labeled with reference symbol [VI] and the right side 793, 794 will be labeled with reference symbol [VII], and will be described again in another separate drawing.

FIG. 6 is an enlarged and detailed view of the portion {IV} indicated by the dashed oval in FIGS. 1 and 2 above.

The base frame illustrated herein is an elevation frame having an overhang or eave with a roof beam 210 extending past a column 240 (illustrating an application of said portal frame), wherein the ends of said roof beam 210 are finished with a roof beam facia 340 and are topped and secured with a rack beam pair 120|122, 124 finished with a rack beam facia 140 to form said base frame.

Here again, the rack beam pair 120 includes a southern rack beam 122 on the south side and a northern rack beam 124 on the north side, said southern rack beam and northern rack beam being placed parallel at certain intervals, and an inclined support member 160 being installed and fixed thereon.

A portion of said roof beam 210 is fixed with column-beam connection means 750 at the top of said column 240, and said rack beam pair 120 is resting on said roof beam 210 and fixed with beam-beam superposition connection means 740. The plate brackets corresponding to said column-beam connection means 750 and beam-beam superposition connection means 740 are column-beam bracket 750 and beam-beam superposition bracket 740.

It is shown that two column-beam bracket 750 and one beam-beam superposition bracket 740 are located closely to each other in the upper part of the column 240, so that they are formed in the form of double brackets 791, 792 of the combined connection bracket 790, and the other beam-beam superposition bracket 740 is formed in the form of double brackets 741, 742.

The ends of the roof beam 210 and the roof beam facia 340 are fixed by the roof beam-facia connection means 380, and the ends of the rack beam pair 120|122, 124 and the rack beam facia 140 are fixed by the rack beam-facia connection means 710, and the corresponding plate brackets are the roof beam-facia bracket 380 and the rack beam-facia bracket 710.

Since the said roof beam-facia bracket 380 and rack beam-facia bracket 710 are applied to a horizontal member which is integrated by a rack beam facia 140 resting on a roof beam facia 340, it is shown that the roof beam-facia bracket 380 is formed in the form of a double bracket 381, 722, and the rack beam-facia bracket 710 is formed in the form of a single bracket 713 or a double bracket 711, 712.

Although the roof beam 210 and column 240 are shown as a single main member, the beam-beam superposition bracket 7401741, 742, combined connection bracket 7901791, 792 and roof beam-facia bracket 3801381, 722, respectively, by applying one or both of the double brackets, one more layer of the same main member can be added to said roof beam 210 and column 240, respectively, to form said base frame of a more improved load-bearing structure.

In the connection part of said column 240 and roof beam 210, a double bracket 791, 792 form of a combined connection bracket 790 formed adjacent to said column-beam connection means 750 and beam-beam superposition connection means 740 will be re-described in another drawing separately by marking with reference symbol [viii].

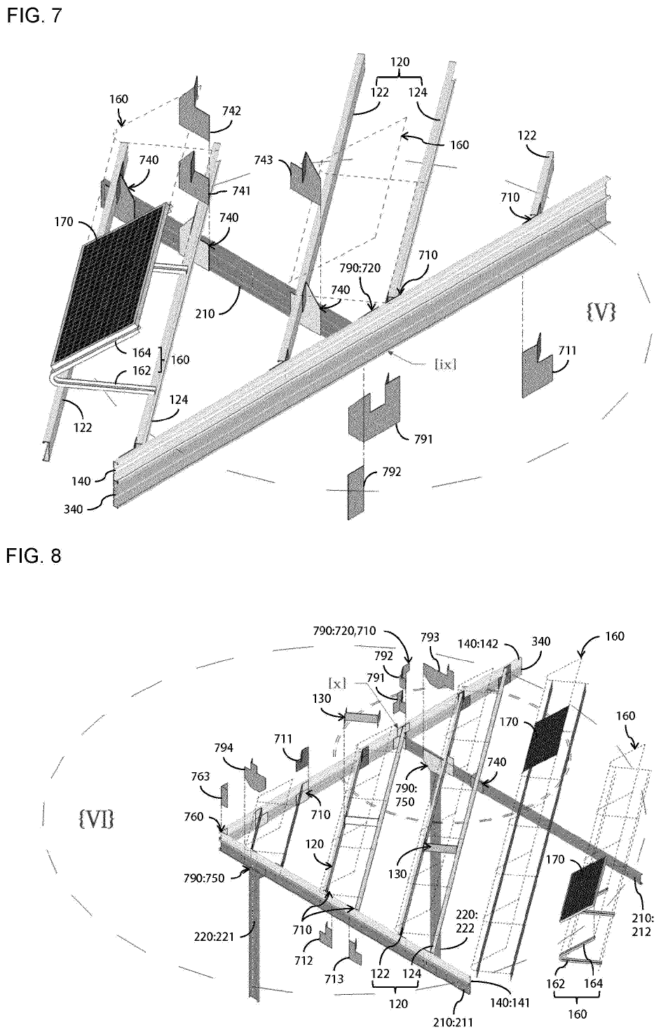

FIG. 7 is an enlarged view of the portion {V} indicated by the dashed oval in FIGS. 1 and 2 above.

The base frame shown here illustrates an application of an elevation frame (said cantilever frame) in which roof beam 210 extends substantially beyond the columns, and the ends of said roof beam 210 having eaves are finished with roof beam facia 340, on which rack beam pair 120|122, 124 finished with rack beam facia 140 are topped and secured to form said base frame.

Again, the rack beam pair 120 includes a southern rack beam 122 on the south side and a northern rack beam 124 on the north side, and the southern rack beam and the northern rack beam are placed parallel at certain intervals, and an inclined support member 160 including a solar panel 170 is installed and fixed thereon. Said inclined support member 160 includes a horizontal support part 162 and a slope part 164 having a predetermined angle of inclination, said support part 162 being fixed vertically (orthogonally) across said southern rack beam 122 and northern rack beam 124 in a plane over said southern rack beam 124, and said solar panel 170 being installed on said slope part 164.

The inclined support member 160 above the rack beam pair 120 and the solar panel 170 positioned thereon are secured by fastening means such as welding, self-drilling screws, or bolt-nut fasteners. The fastening means are not shown to improve the readability of the drawings. In this regard, both the aforementioned and the following fastening means are equivalent.

A roof beam 210 finished with said roof beam facia 340 is secured with roof beam-facia connection means 380, and a rack beam pair 120 rests on said roof beam 210 and is secured with beam-beam superposition connection means 740, a horizontal member united by a roof beam facia 340 overlaid with a rack beam facia 140, the ends of said rack beam pair 120 being secured by rack beam-facia connection means 710, the corresponding plate brackets being roof beam-facia bracket 380, beam-beam superposition bracket 740, and rack beam-facia bracket 710, respectively.

In the area where the end of the roof beam 210 ends with the roof beam facia 340, the roof beam-facia bracket 380 and the rack beam-facia bracket 710 are closely located to each other, showing that they are formed in the form of double brackets 791, 792 of the combined connection bracket 790, the other beam-beam superposition bracket 740 is formed in the form of double brackets 741, 742 and single brackets 743, and the rack beam-facia bracket 710 is formed in the form of single bracket 711.

The double bracket 791, 792 format of the combined connection bracket 790 formed adjacent to the roof beam-facia bracket 380 and the rack beam-facia bracket 710 in the area between the right roof beam facia 340 and the rack beam facia 140 will be described again in another drawing separately by denoting with reference symbol [ix].

FIG. 8 is an enlarged view of the portion {VI} indicated by the dashed oval in FIGS. 1 and 2 above, and is further expanded in scope compared to the foregoing.

The base frame shown herein is formed by two elevation frames (said portal frame having eaves), wherein two columns 220|221, 222 and two roof beams 210|211, 212 are paired to form each elevation frame in the same form.

The ends of the roof beams 210|211, 212 of the two elevation frames are finished with roof beam facia 340, and the rack beam pair 120|122, 124, which is finished with rack beam facia 140|141, 142, is placed on top and fixed to form the base frame.

Again, said rack beam pair 120 includes a southern rack beam 122 on the south side and a northern rack beam 124 on the north side, and said southern rack beam and northern rack beam are placed parallel at certain intervals, and an inclined support member 160 including a solar panel 170 is installed and fixed thereon. Said inclined support member 160 includes a horizontal support part 162 and a slope part 164 having a predetermined inclination angle, said support part 162 being fixed vertically (orthogonally) across said southern rack beam 122 and northern rack beam 124 on a plane, and said solar panel 170 being installed on said slope part 164.

The roof surface outline of said base frame is formed as a horizontal member (abbreviated as “outskirt member”) of an integral structure with rack beam facia 1401141, 142 on top of front roof beam 211 and left roof beam facia 340, wherein the two rack beam facia 140|141, 142, roof beam facia 340 and roof beam 210|211 are secured by main member joint connection means 760 at the vertex of the rectangular plane forming the corner of the flat roof, and the end of the rack beam pair 120 on said outskirt member is secured by rack beam-facia connection means 710, wherein the end of the roof beam 2101212 on said outskirt member is secured by the roof beam-facia connection means 380, and the rack beam pair 120 on the roof beam 2101212 inside said flat roof is secured by the beam-beam superposition connection means 740, and the two columns 220|221, 222 and the two roof beams 210|211, 212 are each fixed by column-beam connection means 750, and the corresponding plate brackets are main member joint bracket 760, rack beam-facia bracket 710, roof beam-facia bracket 380, beam-beam superposition bracket 740 and column-beam bracket 750, respectively.

At the end of said roof beam 2101212, roof beam-facia bracket 380 and rack beam-facia bracket 710, and at the top of column 220|222 supporting said roof beam 210|212, column-beam bracket 750 and beam-beam superposition bracket 740, and column-beam bracket 750 and rack beam-facia bracket 710 at the top of column 220|221 supporting the other roof beam 210|211, respectively, are located closely to each other so that they are formed in the form of double brackets 791, 792 or single brackets 793, 794 of combined connection bracket 790.

The main member joint bracket 760 is shown formed in the form of a single bracket 763, and the rack beam-facia brackets 710 are shown formed in the form of single brackets 711, 712, 713.

By attaching an orthogonal cross strut for rack beam 130 at a certain interval between southern rack beam 122 and northern rack beam 124 at a certain middle part of said rack beam pair 120, a Vierendeel truss is formed, which becomes a resistance structure against buckling of the flat frame under horizontal load.

Said cross strut for rack beam 130 is a plate fixture in the shape of C, one or a pair of which is connected between said rack beam pair 120 by fastening means such as a self-drilling screw in a straight line, and said pair of cross struts for rack beam 130 is formed by fixing the backsides together.

The lower end of said rack beam pair 120 or its end is connected and fixed to the roof beam 210 and roof beam facia 340, which form the elevation frame, thus forming a lattice structure in the form of #, On top thereof, a support part 162 forming an inclined support member 160 is fixed, so that by itself it becomes a load bearing structure for the load on the flat roof of said solar workpiece, but by adding the above cross strut for rack beam, the above load bearing structure is expected to be strengthened.

The double bracket 791, 792 form of the combined connection bracket 790 formed adjacent to the said roof beam-facia bracket 380 and the rack beam-facia bracket 710 in the area between the left roof beam facia 340 and the rack beam facia 140|142 will be described again in another drawing separately by marking with the reference symbol [X].

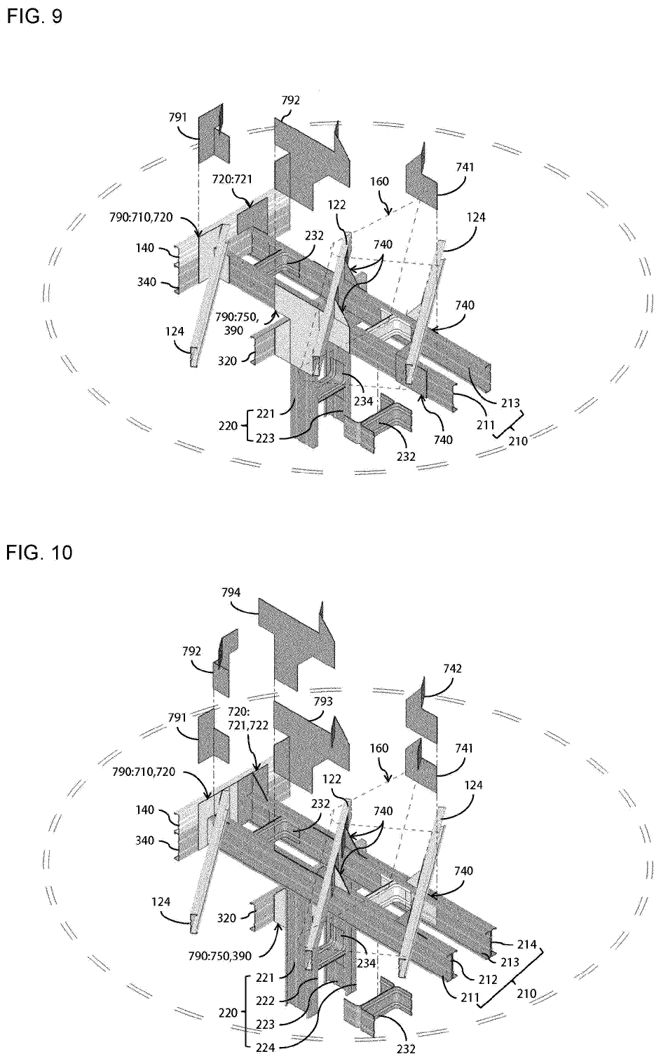

FIG. 9 illustrates a portion of an elevation frame formed by applying long span members of compound structures in pairs (abbreviated as “compound member pairs”) in addition to a single layer of main members in accordance with the technical idea of the embodiments of the invention with respect to the portion indicated by the double dotted oval in FIG. 8 above.

Said elevation frame includes roof beams 210, 211, 213 having eaves above columns 220, 221, 223 of said compound member pair, said columns and roof beams being individually secured, and said roof beams 210 being topped and secured by a rack beam pair 122, 124 finished with a rack beam facia 140. The roof beam 210 of said elevation frame is finished with roof beam facia 340, and a purlin 320 is added to the top of the column 220, so that the base frame is a load-bearing structure.

The purlin 320 is intentionally added here to show that the associated connection means can also be cut and fabricated accordingly and applied to the formation of the base frame. For reference, a roof beam facia is a horizontal member that terminates the ends of a roof beam at the same level, and a purlin is a main member that attaches a horizontal member to a roof beam, a bracing beam is a main member, other than a roof beam facia, that connects a horizontal member to an existing column at the same level as the roof beam, and when one or more columns are added to a section of said bracing beam, it is named and functions as a roof beam.

Said bracing beam and purlin are main members similar to said roof beam, connecting horizontally between sections of said columns of a certain height, said bracing beam being located flush with said roof beam and fixed between said elevation frames by column-beam connection means in the form of flush framing, wherein said purlin is located below said roof beam and is fixed between said elevation frames by column-purlin connection means in the form of layered framing.

Both ends of said two roof beams 210|211, 213 of said compound member pair are fixed with roof beam-facia connection means 380 to roof beam facia 340, which is integral with rack beam facia 140, and finished, and said rack beam pair 122 on which inclined support member 160 is installed, 124 finished with rack beam-facia connection means 710 on rack beam facia 140, resting on said roof beam 210 and secured with beam-beam superposition connection means 740, and supported by two columns 220|221, 222 at one part of said two roof beams 210|211, 213, respectively, and topped with said purlin 320, secured with column-beam connection means 750 and column-purlin connection means 390, respectively.

Said compound member pair 210, 220 includes a cross strut for main member 232, 234 between two roof beams 211, 213 and two columns 221, 223, respectively, at a certain intermediate part, so that a Vierendeel truss is formed and becomes a load-bearing structure against buckling under horizontal load. The cross strut for main member 232, 234, which is a E-shaped plate fixture in a form similar to the cross strut for rack beam 130 in the description of FIG. 8 above, is fixed with fastening means such as a self-drilling screw in a straight line between the compound member pair 210, 220.

As plate brackets corresponding to the above connection means, the roof beam-facia bracket 380 and rack beam-facia bracket 710 adjacent to the left are in the form of a single bracket 791 of the combined connection bracket 790, The column-beam bracket 750, column-purlin bracket 390, and beam-beam superposition bracket 740 adjacent to the center are also in the form of a single bracket 792 of the combined connection bracket 790, and the beam-beam superposition bracket 740 on the right is formed as a single bracket 741.

On the left, the roof beam-facia bracket 3801381 is formed in the form of a simple single bracket with two rectangular faces that contact the two main members, the roof beam facia and the back surface of the roof beam.

FIG. 10 shows a part of an elevation frame with two layers of compound member pairs in accordance with the technical idea of the embodiments of the invention relating to the same category as FIG. 9 above.

Said elevation frame includes a roof beam 210|211, 212, 213, 214 having an eave above said compound member pair of columns 220|221, 222, 223, 224, said columns and roof beams being individually secured, and said roof beam 210 being topped and secured by a rack beam pair 122, 124 finished with a rack beam facia 140. The roof beam 210 of said elevation frame is finished with roof beam facia 340, and a purlin 320 is added on top of the column 220, so that the base frame becomes a load-bearing structure.

The roof beam 210 and column 220 are two layers of main members that are integrated and applied by overlapping their backsides to form a single two-layer long span member by welding, direct connection by self-drilling screws or bolt nut fasteners.

As described above with reference to FIG. 9, the compound member pair 210, 220 of said two-ply long span member also includes a cross strut for main member 232, 234 between two roof beams 211, 213 and two columns 221, 223 at a certain intermediate part to form a load-bearing structure against buckling under horizontal load.

A plate bracket corresponding to roof beam-facia connection means 380, beam-beam superposition connection means 740, column-beam connection means 750 and column-purlin connection means 390 applied to said compound member pair 210, 220 is sandwiched between said two layers of main members and fixed.

As said plate brackets, roof beam-facia bracket 380 and rack beam-facia bracket 710 adjacent to the left side are in the form of double brackets 791, 792 of combined connection bracket 790, and column-beam bracket 750 adjacent to the center, column-purlin BRACKET 390 and beam-beam superposition bracket 740 are also in the form of double bracket 793, 794 of combined connection bracket 790, and on the right, beam-beam superposition bracket 740 is formed by double bracket 741, 742.

On the left, the roof beam-facia bracket 3801381, 722 is formed in the form of a double bracket in which the side in contact with the back surface of the roof beam facia, which is the main member, is a rectangular surface, and the side sandwiched between the back surfaces of the two layers of roof beams is a square plane with beveled sides (two angles are right angles, one angle is acute and the other angle is obtuse).

The plate bracket connects two or more main members, said main members including a horizontal member and a vertical member, which are divided into a first main member and a second main member, wherein said first main member is a main member on which the plate bracket is formed and which is supplemented by a column or a purlin to form a base frame or reinforcing structure, and wherein said second main member is a rack beam or a roof beam to form a flat roof of the solar workpiece to which said first main member is attached.

The plate bracket includes a rack beam-facia bracket, a roof beam-facia bracket, a beam-beam superposition bracket, a column-beam bracket, a column-purlin bracket, and a main member joint bracket, wherein said rack beam-facia bracket is applied to the rack beam-facia connection means, and said roof beam-facia bracket is applied to the roof beam-facia connection means, wherein the beam-beam superposition bracket is applied to the beam-beam superposition connection means, and the column-beam bracket is applied to the column-beam connection means, The term “column-purlin bracket” is applied to the column-purlin connection means, and the term “main member joint bracket” is applied to the main member joint connection means.

The column-purlin bracket, as applied to the connection at any contact point of one horizontal member and the back side of said purlin, which is a primary main member, to one vertical member and the side of said column, which is a secondary main member, in a layered framing method, comprising two rectangular planes based on the contact line where the back side of said vertical member and the back side of said horizontal member meet, one formed on the back surface of one side of the main member (hereinafter referred to as the “primary rectangular plane”), and the other formed on the back surface of one side of the secondary main member (hereinafter referred to as the “secondary rectangular plane”), wherein the primary square face is formed with a longitudinal side of the width of the main member and a transverse side of a certain length, and wherein the secondary square face is formed with a longitudinal side of the width of the main member and a transverse side of the width of the secondary square face, and wherein the two longitudinal sides of the secondary square face further extend to a certain length, an inclined plane is formed on the primary rectangular surface by connecting two vertices of the primary rectangular surface and the secondary rectangular surface adjacent to said contact line, and a single bracket is formed by bending the secondary rectangular surface at an acute or obtuse angle in the center of said contact angle with respect to the contact line of said primary rectangular surface, and said two single brackets are formed by doubling the other secondary rectangular surface with said primary rectangular surface in the same plane to form a double bracket.

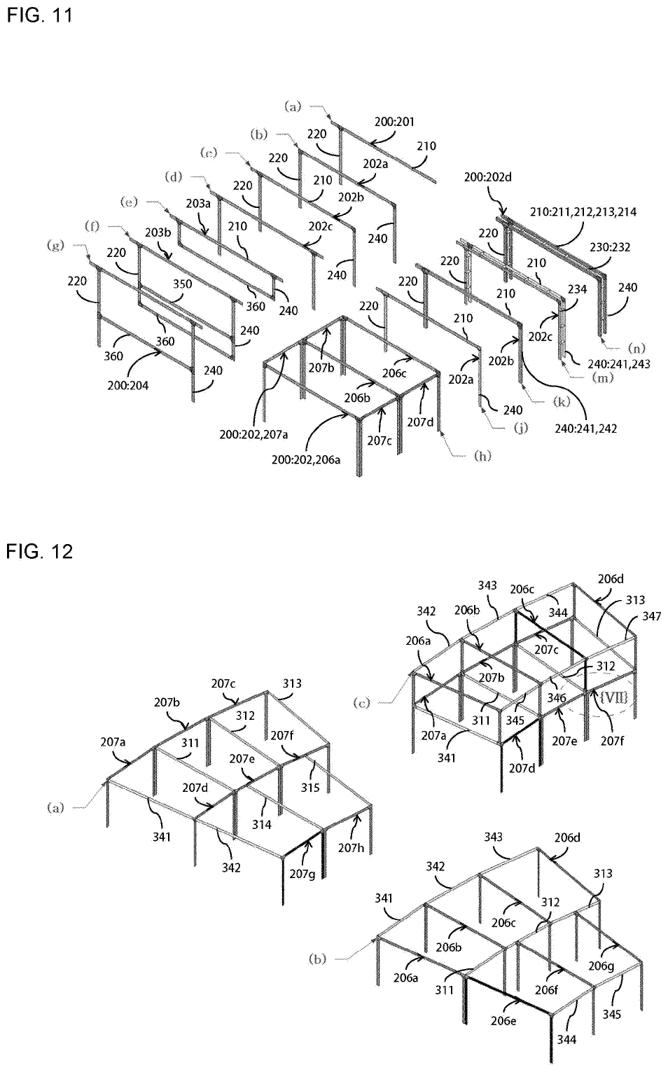

FIG. 11 illustrates a typical type and combination of elevation frames 200 forming a base frame for utilizing a subspace in accordance with embodiments of the invention.

Said elevation frame 200 includes a roof beam 210, which is a horizontal member, and one or more columns 220, 240, which are vertical members, wherein said roof beam is secured to a top part of said columns by column-beam connection means.

Said elevation frame is arranged crossing the inner space of said subspace, or along the boundary of said subspace, so that said roof beams are of a certain height, so that one or more polygonal horizontal surface roofs (abbreviated as ‘flat roofs’) are formed by fixing said rack beams on top of said roof beams.

The types of said elevation frame include a cantilever frame 201, a portal frame 202, a box frame 203, a pile frame 204 and a mixed frame.

The above cantilever frame 201, referred to as (a) in the drawings, is formed by fixing a top part of a column 220, which is a vertical member, and an end part of a roof beam 210, which is a horizontal member, with column-beam connection means. Although one end of said roof beam 210 is shown protruding outward from said column 220 to form an eave, of course, said cantilever frame 201 may also be formed with the end of said roof beam 210 aligned with said column 220.

Said portal frame 202, referenced by reference symbols (b), (c) & (d) in the drawings, is formed by supporting the top of the two vertical members, column 220, 240, and the two ends of the one horizontal member, roof beam 210, respectively, and securing them with column-beam connection means. Reference symbol (b) shows a respective portal frame 202a, 202b, 202c, wherein reference symbol (b) does not have eaves on both sides of roof beam 202a, reference symbol (c) has eaves on one side of roof beam 202b, and reference symbol (d) has eaves on both sides of roof beam 202c.

The box frame 203 referred to by reference symbols (e) & (f) in the drawings is formed by fixing the two end portions of the two horizontal members, roof beam 210 and bottom beam 360, to the top and bottom portions of the two vertical members, columns 220, 240, with column-beam connection means. One or more middle beams 350 are placed between roof beam 210 and bottom beam 360 of box frame 203a to form a modified box frame 203b.

The said pile frame 204 referred to by reference symbol (g) in the drawing is formed by fixing the two end portions of each of the two upper and lower horizontal members, the roof beam 210 and the bottom beam 360, to the upper and intermediate portions of the two vertical members, the columns 220, 240, with column-beam connection means, so that the said pile frame is a structure in which the columns protrude downwardly and extend from the said box frame 203a.

Both reference symbols (e), (f) & (g) show the existence of eaves on the roof beam 210 beyond the columns 220, 240 on both sides, but whether or not to have said eaves is determined according to the shape or conditions of the solar workpiece being planned.

Said mixed frame is an integrated structure optionally comprising said cantilever frame 201, portal frame 202, box frame 203 and pile frame 204, which are applied to the formation of said base frame.

Said roof beam 210, middle beam 350, and/or bottom beam 360, each of which has a certain length at both ends exceeding said column 220, 240, including an eave width in the case of a roof beam and a balcony width in the case of a bottom beam, such that the length of the roof beam and/or bottom beam is equal to or longer than the inner and outer spacing between the two columns.

Said elevation frame 200 includes cross-sectional frames 206 and side wall frames 207, depending on placement, wherein said cross-sectional frames 206 are disposed at certain intervals across the interior of said subspace, and said side wall frames 207 are disposed in a row on the exterior or interior of said subspace.

The base frame referred to as (h) in the drawing is a portal frame 202, formed by disposing cross-sectional frames 206a, 206b, 206c across the interior of said subspace, and side wall frames 207a, 207b& 207c, 207d along the periphery of said subspace.

The load bearing structure of said portal frame, formed by two vertical members, column 220, 240, and one horizontal member, roof beam 210, is a single layer member, which is a main member, a horizontal or vertical long span member having a rectangular section, a double layer member, a single layer pair, and a double layer pair.

The single layer member is a main member with an original rectangular cross-section, and the double layer member is formed from a single main member by joining the back surfaces of the two single layer members together by welding or self-drilling screws.

When the said single layer member is used to form an elevation frame, its back surfaces are connected and fixed in the same plane, and the application of the said double layer member is to fix the back surfaces of the same or similar single layer member to the back surfaces of the single layer member forming the said elevation frame.

Details of the features relating to the material, process, and shape of said main member will be described later in the description of FIG. 44.

The compound member pair, wherein said single layer pair is a main member formed as a long span member of a compound structure by pairing two single layer members parallel to each other at a certain interval, wherein the double layer pair is a main member formed of long span members of the compound structure in pairs with the two double layer members parallel to each other at certain intervals.

The portal frame 202a referred to as (j) in the drawing is a single layer member formed of columns 220, 240 and roof beam 210, and the portal frame 202b referred to as (k) is a double layer member formed of columns 220; 240|241, 242 and roof beam 210; the portal frame 202c referred to as (m) is a single layer pair, column 220; 240|241, 243 and roof beam 210; the portal frame 202d referred to as (n) is a double layer pair, column 220, 240 and roof beam 210|211, 212, 213, 214; the elevation frame 200. The above four forms of elevation frame 200 exemplify a combination of main members based on a portal frame having an eave on one side referred to as (c) in the drawing. The main members of the single layer pair and the double layer pair are fixed with a cross strut for main member 230 therebetween, and a plurality of cross struts for roof beam 232 and cross struts for column 234 are arranged at certain intervals to form an elevation frame of a load-bearing structure.

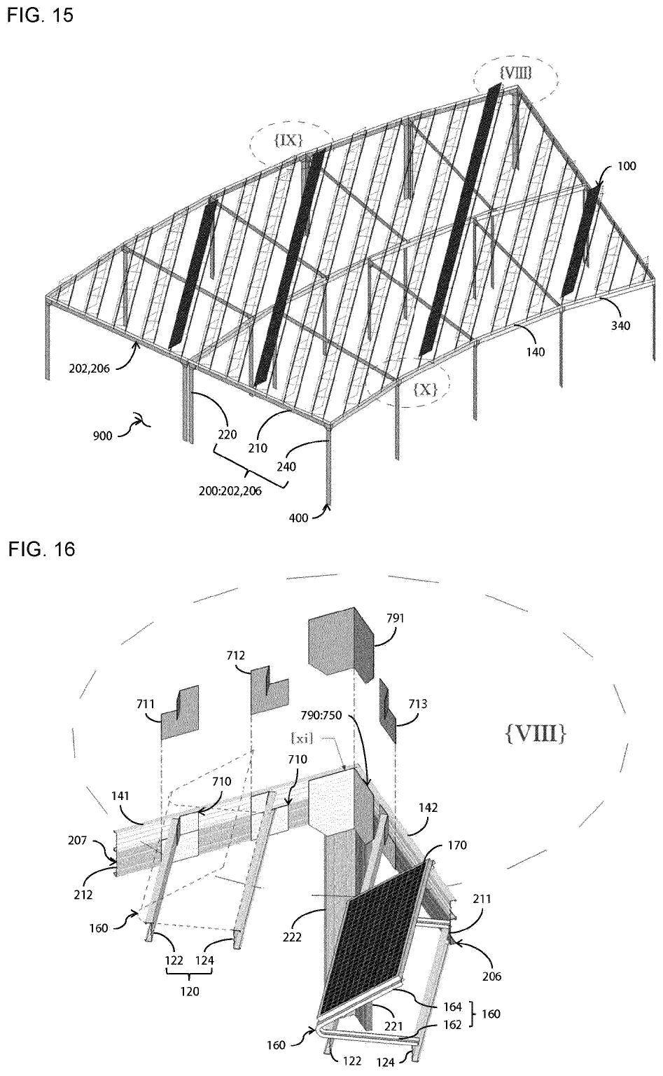

FIG. 12 illustrates typical types and combinations of elevation frames forming a base frame for utilizing a subspace in accordance with the technical idea of the embodiments of the invention. The elevation frames are illustrated here as portal frames without eaves, but other forms of elevation frames, such as, but not limited to, eaves, cantilever frames, or box frames, may be applied. Furthermore, the base frame is formed from a rectangular plane of an equilateral trapezoid such that the size or arrangement of the elevation frame is a subspace of a circular arc plane including the outer curves of the two arcs. Details of the base frame formed by the above arc plane will be described later in the description of FIG. 15. Of course, the technical ideas of the embodiments of the invention can also be applied to any polygonal plane formed by various sizes or arrangements of elevation frames.

A planar combination type of elevation frame for forming a base frame over a subspace includes one or more of a cross-sectional frame 206 of a crosswise type, a side wall frame 207 of a alongside type, and a mixed frame of a mixed type, wherein said cross-sectional frame 206 comprises a plurality of elevation frames spaced at certain intervals across the interior of said subspace and connecting the ends of adjacent roof beams to a roof beam facia 340 or the tops of adjacent columns to another bracing beam 310, wherein said side wall frames 207 are arranged in two or more rows in a longitudinal direction along an interior or exterior perimeter of said subspace, with said elevation frames being flush-framed between two opposing columns, one column and a roof beam, or two roof beams, with bracing beams 310 between said two rows, whereas, said mixed frame is a form in which said cross-sectional frame and said side wall frame are arranged in an optional mixture, and in the form arranged according to said combination type, a column made of the same main member is optionally added to the connection part of the bracing beam or the roof beam, or a purlin is fixed to an adjacent column in a layered framing manner.

Said base frame is in the form of one or more of a single building type, a consecutive building type, a multistory building type, and a mixed building type in three dimensions, wherein said single building type comprises columns arranged on the outer perimeter of said subspace, and said consecutive building type comprises one or more rows of columns inside said subspace, constructed by attaching one or more of said single building types immediately adjacent thereto, wherein said multistory building type is in the form of a plurality of base frames of equal or lesser floor area built on top of said single building type or consecutive building type, and wherein said mixed building type is a selective mix of said single building type, consecutive building type, or multistory building type to form a base frame according to the shape of a given subspace.

The base frame referred to as (a) in the drawing includes three rows of side wall frames 207, the first row being three 207a, 207b, 207c on the left, the second row also being three 207d, 207e, 207f in the middle, and the third row being two 207g, 207h on the right, wherein the above three rows of side wall frames 207 are formed by connecting pillar to pillar, pillar to roof beam, roof beam to roof beam, and roof beam to roof beam with roof beam faces 341, 342 and bracing beams 311, 312, 313, 314, 315 at the same height as the roof beams.

The base frame referred to as (b) in the drawing includes two groups of cross-sectional frames 206, the first group having four cross sections 206a, 206b, 206c, 206d on the left side and the second group having three cross sections 206e, 206f, 206g on the right side, whereas, the cross-sectional frame 206 of the above two groups is formed by connecting the columns to the columns, the columns to the roof beams, and the roof beams to the roof beams with roof beam faces 341, 342, 343, 344, 345 and bracing beams 311, 312, 313 at the same height as the roof beams.

The base frame referred to by (a) and (b) above is also applicable to a subspace having a curved outline as a consecutive building type.

The base frame referred to as (c) in the drawing is a multi-story structure, and the lower floor includes two rows of side wall frames 207 on the outside, the first row of three 207a, 207b, 207c on the left side, and the second row of three 207d, 207e, 207f) on the right side, and the upper floor includes a cross-sectional frame 206 with four cross sections (206a, 206b, 206c, 206d), the lower ends of the columns of said cross-sectional frame 206 being fixed to the upper ends of the columns of said lower floor side wall frame 207, wherein said downstairs side wall frame 207 and upstairs cross-sectional frame 206 are formed by connecting adjacent columns to columns, columns to roof beams, and roof beams to roof beams with roof beam fascia 341 and bracing beams 311, 312, 313 on the downstairs floor and roof beam fascia 342, 343, 344, 345, 346, 347 on the upstairs floor at the same height as the roof beams on each floor.

The base frame referred to in (c) above is a multistory building type, which is also applicable to a subspace having a curved outline.

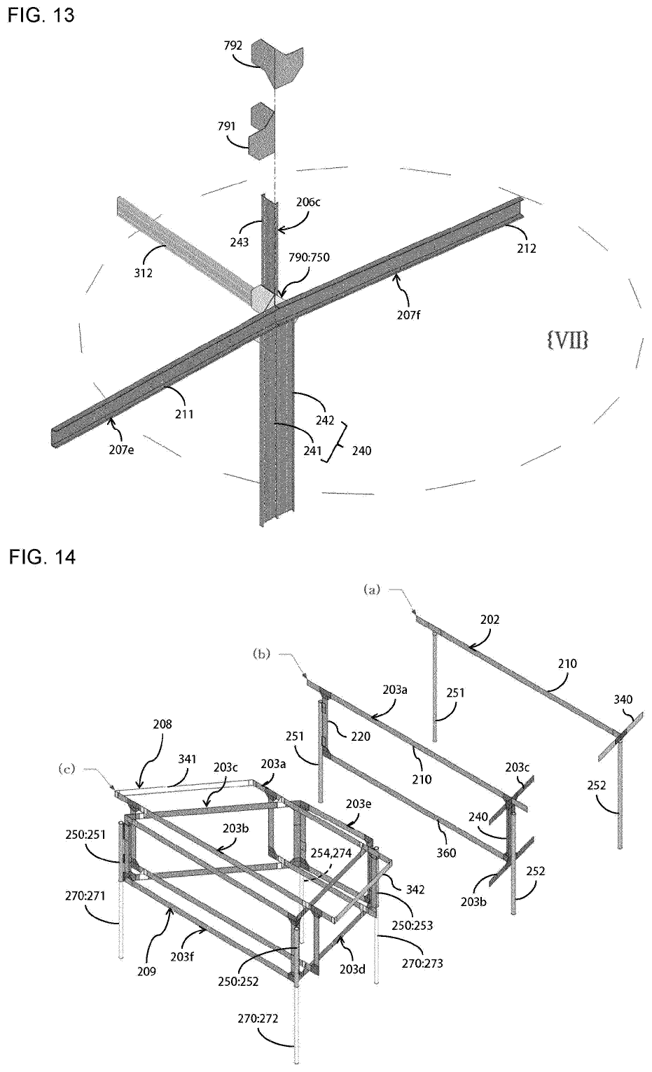

FIG. 13 is an enlarged and detailed view of the portion {VII} indicated by the dotted oval in FIG. 12 above.

Two side wall frames 207a, 207b are attached on each side so as to share two columns 240|241, 242, and a bracing beam 312 is attached to the top of said column 240 flush with the respective roof beams 211, 212, and a column 243 of cross-sectional frame 206c is fixed thereon with a combined connection means 790 comprising a plurality of column-beam connection means 750.

A plate bracket corresponding to said column-beam connection means 750 is shown, formed in the form of a double bracket 791, 792 of the combined connection means 790 to which the two columns 241, 242 and the two roof beams 211, 212 and the bracing beam 312 and another column 243 are attached and fixed at one site.

The two roof beams 211, 212 are shown with different main members and different rectangular cross-sectional channels, which are intentionally shown to illustrate embodiments of the invention with respect to different main member cross-sectional shapes.

Although the two roof beams 211, 212, one bracing beam 312 and three columns 241, 242, 243 are shown as a single layer of main members, by applying the double bracket 791, 792 format of the combined connection bracket 790, one more layer of the same main members can be added to the roof beams, bracing beams and columns, respectively, to form the base frame of a more improved load bearing structure.

FIG. 14 illustrates an example of a combination of an elevation frame supporting a base frame for utilization of a subspace to an object and an attachment structure of columns in accordance with embodiments of the invention, wherein the elevation frame and the combination are formed or added to a roof beam 210 and two columns 250, 270 made of different main members.

The elevation frame, referred to as (a) in the drawing, supports the portal frame 202 with the roof beam 210 and two cylindrical columns 251, 252 made of different main members, to which the roof beam facia 340 is attached and secured by column-beam connection means.

The elevation frame of the base frame referred to as (b) in the drawings is shown to be formed by attaching two box frames 203b, 203c to the right and left sides of the box frame 203a made of the same main member, and attaching cylindrical columns 251, 252 to each of the outer sides of the columns 220, 240 of the said elevation frame.

The merged formation of said base frame comprising one or more of a primary cubic frame and a secondary cubic frame, said primary cubic frame being formed in a planar combination type of said elevation frame, wherein said secondary cubic frame is formed as a vertical combination type of said elevation frame, further comprising said various types of elevation frames, such that said primary cubic frame is supported on said object.

The means for providing support to said object comprises a floating body, a pile or a mixed support, said floating body being installed in or under said primary cubic frame, wherein said pile is supported by attaching said pile to a column within said primary or secondary cubic frame, and wherein said mixed support method is supported by attaching said pile to a column within said primary cubic frame containing said floating body.

The base frame referred to as (c) in the drawings is in the form of supporting four corners of a hexahedral subspace of six box frames 203a, 203b&203c, 203d, 203e, 203f to an object by two kinds of columns 250|251, 252, 253, 254&2701271, 272, 273, 274. The base frame includes a first cubic frame 208 in the upper part and a second cubic frame 720 in the lower part, wherein the first cubic frame 208 is formed by closing two box frames 203a, 203b with two roof beam faces 341, 342, and the second cubic frame 720 is formed in a hexahedral structure with four box frames 203c, 203d, 203e, 203f, wherein the two box frames 203c, 203d by roof beams and bottom beams of the two box frames 203a, 203b of the corresponding primary structure, respectively, and fixedly supported by roof beams and bottom beams of the two box frames 203a, 203b, Attaching minor columns 251, 252, 253, 254 to each of the four corners of said secondary cubic frame 720, which in turn are connected to major columns 271, 272, 273, 274 to form an arbitrary square planar solar workpiece that is anchored.

According to the technical idea of the embodiments of the invention, the roof beam 210 of the elevation frame and the rack beam pair of the solar rack are formed into a lattice structure in the form of #, so that a flat roof of the solar workpiece is formed. When the said elevation frame is arranged and settled, it is expected that the effect of easily forming the said solar workpiece will be achieved by adding various kinds of pillars and a proper combination of the first cubic frame 208 and the second cubic frame 720.

### Embodiment 2

FIG. 15 is a conceptual illustration of a multipurpose solar energy system, as embodiment 2 of the invention, formed by a solar workpiece settled and constructed on an earth's surface 900 and having a roof of a circular arc plane comprising the outer curves of two arcs.

The interior space of the solar workpiece is utilized for various purposes such as curved roads, rivers, parking lots, and agricultural fields, and the solar workpiece includes a solar rack 100 on top and a base frame below, the base frame includes a plurality of elevation frames 200 and a footing part 400, and the elevation frames include one horizontal member, a roof beam 210, and one or more vertical members, columns 220, 240.

Said base frame is formed by placing cross-sectional frames 206 at certain intervals along a right-hand arc as a portal frame 202, which is a form of elevation frame 200, and terminating roof beam 210 of said portal frame 202 with roof beam facia 340 along said right-hand and interior arc of the space.

Said portal frame 202 is formed by supporting and fixing two columns 220, 240 at both ends of one roof beam 210, and cross-sectional frames 206 in the form of said portal frame 202 are disposed at certain intervals along the left arc side to form a left side beam, and finish the roof beam of said portal frame 202 with roof beam facia along said left side and space inner arc side.

The spatial inner arc sides of said right and left sides are located at a centerline area within said interior space, and said two-part base frame is a consecutive building type base frame constructed on an arc plane having two arc sides, wherein the rack beam pair of the solar rack 100 is secured to a horizontal member of the structure incorporating a rack beam facia 340 over a roof beam 210 or a roof beam facia 340 that finishes the perimeter of the roof surface of said base frame.

The solar workpiece may also be utilized as a road soundproof tunnel by being constructed on a road where the outline of the interior space is made of straight lines as well as curves.

FIG. 16 is an enlarged and detailed view of the {VIII} portion indicated by the dotted oval in FIG. 15. shown as a dashed oval in FIG. 15 above.

The rack beam pair 120 includes a southern rack beam 122 on the south side and a northern rack beam 124 on the north side, said southern rack beam and northern rack beam being placed parallel at certain intervals, and an inclined support member 160 being installed and fixed thereon.

Said inclined support member 160 includes a horizontal support part 162 and a slope part 164 having a predetermined angle of inclination, said support part 162 being fixed vertically (orthogonally) across said southern rack beam 122 and northern rack beam 124 on a plane, and said solar panel 170 being installed on said slope part 164.

The base frame shown herein includes two portal frames formed as elevation frames, one of which is a cross-sectional frame 206 formed by a roof beam 211 and a column 221 on the right side, and a side wall frame 207 formed by a roof beam 212 and a column 222 on the left side. Said base frame shows a composite structure in which the two roof beams 211, 212 form an elevation frame (said portal frame) and share the two columns 221, 222 as one.

Said rack beam facia 140 is incorporated on top of said roof beams 211, 212 to finish the outline of said arc plane, wherein said rack beam pair 120 is secured with rack beam-facia connection means 710, and the top of said shared column 221, 222 and the ends of the two roof beams 211, 212 are secured with column-beam connection means 750 to form said solar workpiece.

The rack beam-facia connection means 710 and the column-beam connection means 750 include a plate bracket attached to the connection part of the two main members for indirect connection by welding or by a self-drilling screw or a bolt-nut fastener, and the plate brackets corresponding to the above connection means are the rack beam-facia bracket 710 and the column-beam bracket 750, respectively.

The rack beam-facia bracket 710, which is applied to the horizontal member of the structure with the rack beam facia 141, 142 incorporated above said roof beam 211, 212 to finish the outline of the roof surface of said base frame, is formed in the form of a single bracket 711, 712, 713, and two column-beam brackets 750 for fixing the top of the column 221, 222 of the two elevation frames and the ends of the roof beams 211, 212 are formed into a combined connection bracket 790, which is formed into a single bracket 791.

The two rack beams 122, 124 of the rack beam pair 120 are shown in a face-to-face format, and thus the two single brackets 711, 712 of the rack beam-facia bracket 710 are symmetrically formed, but the two single brackets are not limited to the present position and can be applied to any position.

The form of the single bracket 791 of the combined connection bracket 790 of the two column-beam brackets 750 will be described again in another drawing separately by denoting it with the reference symbol [xi].

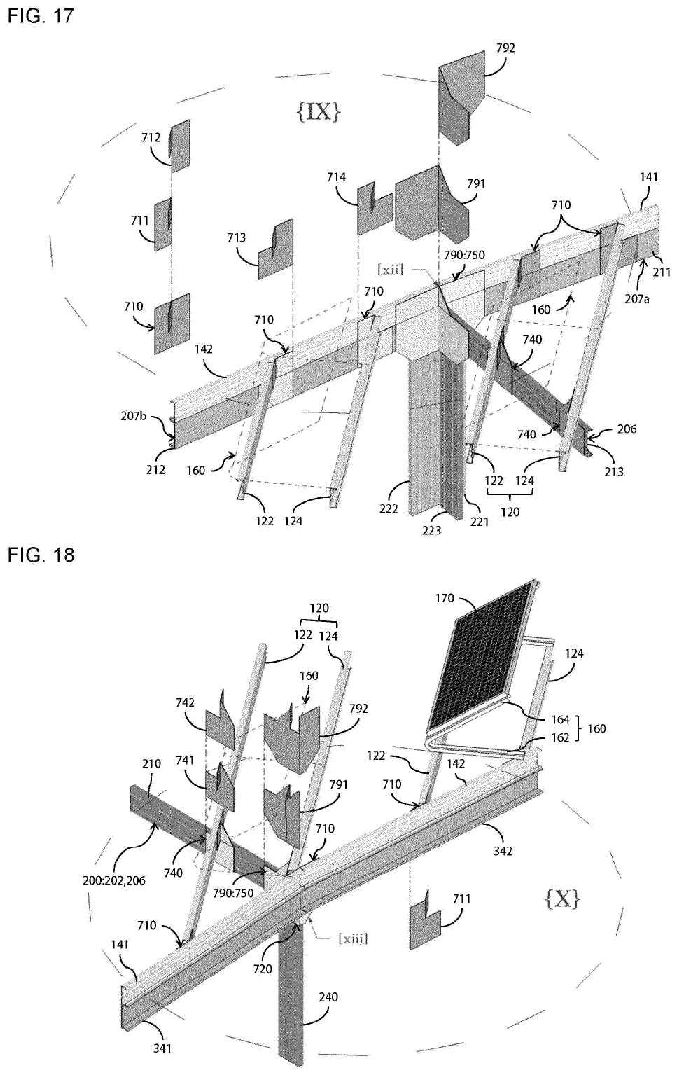

FIG. 17 is an enlarged view of the portion {IX} indicated by the dashed oval in FIG. 15 above . . .

The base frame shown here includes three portal frames made of elevation frames, two of which are side wall frames 207a, 207b made of roof beams 211, 212 and columns 221, 222 on the rear side arranged in a row on the periphery of said interior space, and the other is a cross-sectional frame 206 made of roof beams 213 and columns 223 on the front side located between said two side wall frames. Said base frame shows a composite structure with three roof beams 211, 212, 213 forming an elevation frame (said portal frame) each sharing three columns 221, 222, 223 as one.

The rack beam pair 120|122, 124 fixed above the roof beam 213 of said cross-sectional frame 206 includes a southern rack beam 122 on the south side and a northern rack beam 124 on the north side, on which an inclined support member 160 is installed and fixed.

A rack beam facia 141, 142 is incorporated on top of the roof beams 211, 212 of said side wall frames 207a, 207b, which form the outline of said interior space, respectively, to finish said arc planes, wherein said rack beam pair 120|122, 124 is fixed with rack beam-facia connection means 710, wherein said rack beam pair 120|122, 124 passing over roof beam 213 of said cross-sectional frame 206 is secured by beam-beam superposition connection means 740, and the top of said shared column 221, 222, 223 and the ends of both roof beams 211, 212, 213 are secured by column-beam connection means 750 to form said solar workpiece.

The rack beam-facia connection means 710, beam-beam superposition connection means 740 and column-beam connection means 750 comprise a plate bracket attached to the connection part of the two main members for indirect connection by welding, self-drilling screw or bolt nut fastener, the plate brackets corresponding to said connection means are rack beam-facia bracket 710, beam-beam superposition bracket 740 and column-beam bracket 750, respectively.

The rack beam-facia bracket 710, which is applied to the horizontal member in which the rack beam facia 141, 142 is integrated on the roof beam 211, 212, is formed in the form of a single bracket 713, 714, and the three column-beam brackets 750 for fixing the top of the columns 221, 222, 223 of the three elevation frames and the ends of the roof beams 211, 212, 213 are formed into a combined connection bracket 790, which is formed in the form of a double bracket 791, 792. Said rack beam-facia bracket 710 can also be applied in the form of a double bracket 711, 712.

The above two roof beams 211, 212 are shown by applying a channel with a different rectangular cross-section from the other main members, which is intentionally to show embodiments of the invention with respect to the cross-sectional shape of the various main members.

The double bracket 791, 792 form of the combined connection bracket 790, in which the three column-beam brackets 750 are united, is again described in another drawing separately by reference symbol [xii].

FIG. 18 is an enlarged view of the {X} region shown by the dashed oval in FIG. 15 above.

The rack beam pair 120 includes a southern rack beam 122 on the south side and a northern rack beam 124 on the north side, wherein the southern rack beam and the northern rack beam are placed parallel at certain intervals, and an inclined support member 160 is installed and fixed thereon.

Said inclined support member 160 includes a horizontal support part 162 and a slope part 164 having a predetermined angle of inclination, said support part 162 being fixed vertically (orthogonally) across said southern rack beam 122 and northern rack beam 124 on a plane, and said solar panel 170 being installed on said slope part 164.

The base frame shown herein is formed by a single elevation frame 200, a portal frame 202, and said portal frame 202, located in the center portion, is a cross-sectional frame 206 with a roof beam 210 and a column 240. At the top of column 240 of said cross-sectional frame 206, roof beam 210 is fixed with column-beam connection means 750, and roof beam facia 341, 342 are attached on both sides with roof beam-facia connection means 380, and corresponding rack beam facia 141, 142 are attached thereon to form the outskirt of said interior space as an integrated horizontal member (abbreviated as “outskirt member”).

Said rack beam pair 120|122, 124 is secured to said outskirt member with rack beam-facia connection means 710, and said rack beam pair 120|122, 124 passing over roof beam 210 of said cross-sectional frame 206 is secured with beam-beam superposition connection means 740 to form said solar workpiece.

The column-beam connection means 750, roof beam-facia connection means 380, rack beam-facia connection means 710 and beam-beam superposition connection means 740 include a plate bracket attached to the connection part of the two main members for indirect connection by welding, self-drilling screw or bolt nut fastener, The plate brackets corresponding to the above connection means are respectively column-beam bracket 750, roof beam-facia bracket 380, rack beam-facia bracket 710 and beam-beam superposition bracket 740.

rack beam-facia bracket 710, which is applied to said outskirt member, is formed in the form of a single bracket 711, and column-beam bracket 750 for fixing the top of column 240 of said cross-sectional frame 206 and the end of roof beam 210, which are located adjacent to each other at a central region in the drawing, roof beam-facia bracket 380 for attachment of roof beam facia 341, 342 to the ends of said roof beam 210, and rack beam-facia bracket 710 for fastening of rack beam 124 to said outskirt member, are combined into a combined connection bracket 790 to form a double bracket 791, 792.

Said roof beam facia 341, 342 are shown with a channel of a different rectangular cross-section than other main members, which is intentionally shown to illustrate embodiments of the invention with respect to the cross-sectional shape of various main members.

Said column-beam bracket 750, roof beam-facia bracket 380 and rack beam-facia bracket 710 are in the form of double brackets 791, 792 of a single combined connection bracket 790, which is indicated by reference symbol [xiii] and will be described again in another drawing separately.

### Embodiment 3

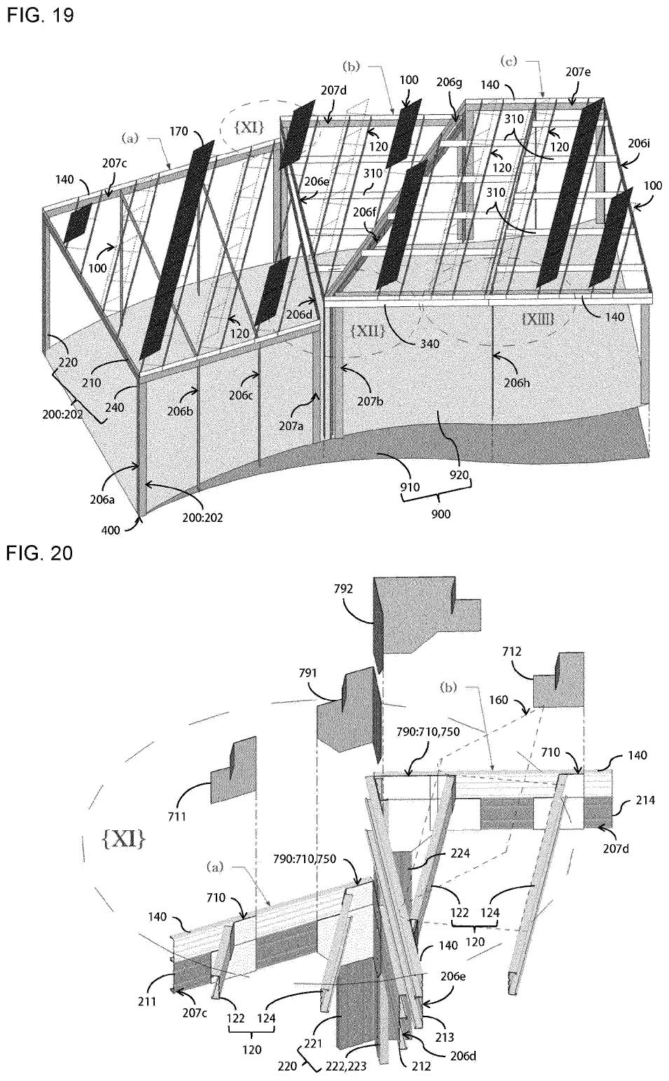

Referring now to FIG. 19, there is conceptually illustrated a multipurpose solar energy system formed by a solar workpiece having a roof of any polygonal plane, settled on an inclined earth's surface 900 as an object, as embodiment 3 according to the invention.

The interior space of the solar workpiece is utilized for various purposes such as curved and inclined roads, rivers, and agricultural fields, and the solar workpiece includes a solar rack 100 on top and a base frame below, wherein the solar rack 100 includes a flat frame with a rack beam pair 120, the base frame includes a plurality of elevation frames 200 and a footing part 400, and the elevation frames include a roof beam 210 as a horizontal member and one or more columns 220, 240 as vertical members.

The solar workpiece is formed by connecting the three parts of the base frame (a), (b) & (c) and is settled on a ground slope 920 having a certain inclination angle with respect to the ground water surface 910. The flat roofs of the three parts are formed with different heights, and the left side (a) is a square plane, the center (b) is a triangular plane, and the right side (c) is again a square plane.

The base frame (a) on the left is formed by a portal frame 202 with six elevation frames 200, four (206a, 207a, 206d, 207c) on the outside of the square plane and two (206b, 206c) across the interior space. Said elevation frame is divided into four cross-sectional frames 206a, 206b, 206c, 206d that cross said inner space according to the layout format, and two side wall frames 207a, 207d that form the outer perimeter of said inner space.

The rack beam pair 120 of said solar rack 100 is rested on the roof beam 210 of said base frame (a) and fixed in the form of layered framing, whereby the roof surface of the solar workpiece formed by said rack beam pair 120 and roof beam 210 is formed as a lattice structure in the form of #.

The center base frame (b) has a triangular roof surface formed by two cross-sectional frames 206e, 206f and one side wall frame 207c. Between said two cross-sectional frame 206e, 206F roof beams, a plurality of bracing beams 310 are arranged and fixed at certain intervals flush with said roof beams.

A rack beam face 140 is fixed to the roof beam of elevation frame 200, which finishes the perimeter of the roof surface in the two base frames (a) & (b), forming a horizontal member (abbreviated as “outskirt member”) of the integral structure, and the ends of said rack beam pair 120 are fixed to said outskirt member.

The base frame (c) on the right above is a structure having a square roof surface with three cross-sectional frames 206g, 206h, 206i, two side wall frames 2076, 207e forming the perimeter of said interior space, and a plurality of bracing beams 310. Said bracing beams 310 are fixed at certain intervals to the cross-sectional frames 206g, 206i on either side, centered on a cross-sectional frame 206h that crosses the middle portion of said base frame (c).

One side of the three cross-sectional frames 206g, 206h, 206i of said base frame (c) is a structure having a roof beam projecting forward past the columns and having an eave, said eave end being finished with a roof beam facia 340, A horizontal member (abbreviated as “outskirt member”) of a structure incorporating a rack beam facia 140 is formed over said roof beam facia 340 and the other roof beam to finish the perimeter of said base frame (c) roof surface, and the ends of said rack beam pair 120 are fixed to said outskirt member.

Since the rack beam pair 120 of said solar rack 100 forming the roof surface of said two base frames (b) & (c) is fixedly arranged in an east-west direction, a plurality of bracing beams 310 are added to promote a load-bearing structure of said roof surface, Accordingly, the flat roof of the solar workpiece formed by said rack beam pair 120 and bracing beams 310 is formed as a lattice structure in the form of #.

FIG. 20 is an enlarged and detailed view of the portion {XI} indicated by the dashed oval in FIG. 19. portion indicated by the dashed oval in FIG. 19 above.

The rack beam pair 120 includes a southern rack beam 122 on the south side and a northern rack beam 124 on the north side, wherein the southern rack beam and the northern rack beam are placed parallel at certain intervals, and an inclined support member 160 is installed and fixed thereon.

The corners of the two base frames shown here are formed by two portal frames, side wall frame 207c and cross-sectional frame 206d, on the left side (a), and side wall frame 207d and cross-sectional frame 206e, on the right side (b).

Said side wall frame 207c of said left base frame (a) includes roof beam 211 and column 221, said cross-sectional frame 206d includes roof beam 212 and column 222, and said side wall frame 207d of said right base frame (b) includes roof beam 214 and column 224, said cross-sectional frame 206e includes roof beam 213 and column 223, wherein columns 222, 223 forming said two cross-sectional frames 206D, 206e are shared by the two elevation frames and consequently form one column with three columns 220|221, 222, 223, 224 forming said two corners, showing a composite structure. Additional columns of the same main member may be added to the back of said column 222, 223 to form four columns in practice.

Above the roof beams 211, 212, 213, 214 of each of the two portal frames of said left and right base frames, rack beam facia 140 is integrated to form a horizontal member (abbreviated as “outskirt member”) of the structure that finishes the outer perimeter of the roof surface of said base frame, respectively. To said outskirt member, the ends of said rack beam pair 120|122, 124 are secured by rack beam-facia connection means 710.

The roof beam 211, 212, 213, 214 and the column 220|221, 222, 223, 224 forming the respective portal frames of said two base frames are each fixed with column-beam connection means 750, wherein said column-beam connection means 750, together with said rack beam-facia connection means 710, includes a plate bracket attached to the connection part of the two main members for indirect connection by welding or by a self-drilling screw or a bolt-nut fastener, and the plate brackets corresponding to said connection means are rack beam-facia bracket 710 and column-beam bracket 750, respectively.

The rack beam-facia bracket 710, which is fixed to said outskirt member at two parts away from said column 220, is formed in the form of a single bracket 711, 712, respectively, a plurality of column-beam brackets 750 at the top portion of said column 220 and a nearby rack beam-facia bracket 710 are shown to be formed into a combined connection bracket 790, formed in the form of a single bracket 791, 792 for each base frame (a) & (b).

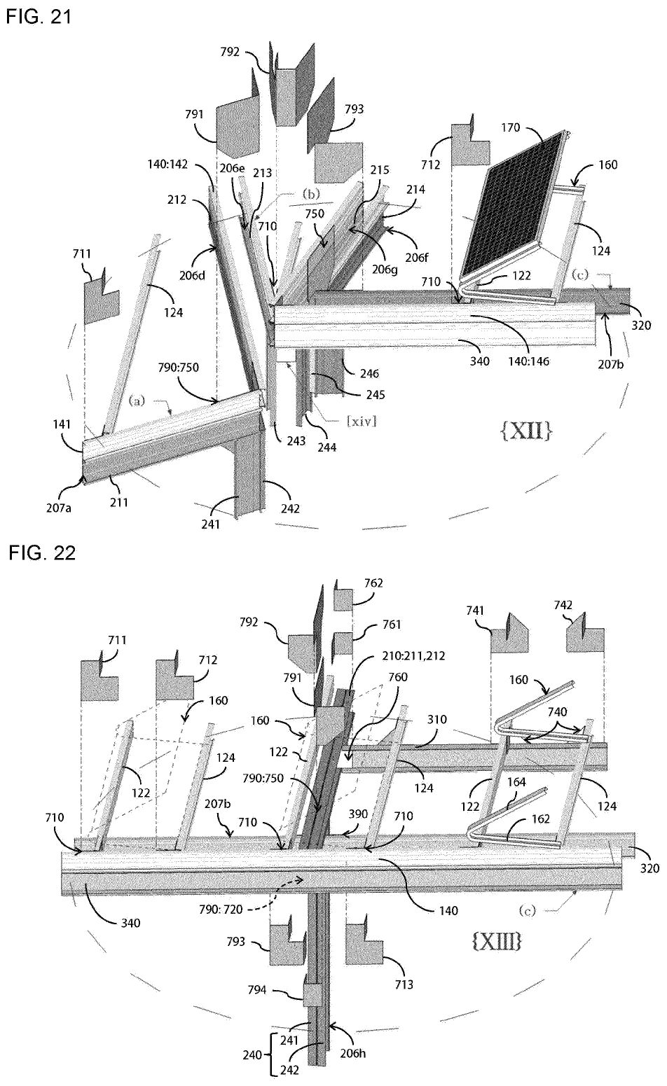

FIG. 21 is an enlarged view of the portion {XII} indicated by the dashed oval in FIG. 19 above.

The rack beam pair 120 includes a southern rack beam 122 on the south side and a northern rack beam 124 on the north side, said southern rack beam and northern rack beam being placed parallel at certain intervals, and an inclined support member 160 being installed and fixed thereon.

The inclined support member 160 includes a horizontal support part and an inclined part having a predetermined inclination angle, and the solar panel 170 is installed on the inclined support part.

The corners of the three base frames illustrated herein are formed by two portal frames, side wall frame 207a and cross-sectional frame 206d, on the left (a), two portal frames, cross-sectional frame 206e, 206f, on the center (b), and two portal frames, side wall frame 207b and cross-sectional frame 206g, on the right (c).

The elevation frame forming the base frame is generally formed in various types with one roof beam and one or more columns, but another elevation frame is formed by adding a horizontal member of a purlin or bracing beam to the existing elevation frame and adding one or more columns that are vertical members to the horizontal member.

Side wall frame 207b, located at the front of said right base frame (c), is formed by attaching purlin 320 to the top portion of column 245 just below a roof beam 215 of said cross-sectional frame 206g and adding column 246.

The roof beam 215 of said cross sectional frame 206g projects forward past column 245 to become a base frame having eaves, and the end of said roof beam 215 is terminated with a roof beam facia 340, over which are added rack beam facia 141, 142, wherein each of rack beam facia 140|141, 142 on top of roof beams 211, 212 of said left base frame (a) and roof beams 213, 214 of said center base frame (b) are integrated to form a horizontal member (abbreviated as “outskirt member”) that finishes the perimeter of the roof surface of each base frame.

To said outskirt member, the ends of said rack beam pair 122, 124 are fixed with rack beam-facia connection means 710, and the roof beams 211, 212, 213, 214, 215 and columns 240|241, 242, 243, 244, 245, 246 forming the respective portal frames of said three base frames are fixed with column-beam connection means 750, wherein said column-beam connection means 750, together with said rack beam-facia connection means 710, includes a plate bracket attached to the connection part of the two main members for indirect connection by welding or by a self-drilling screw or a bolt-nut fastener, and the plate bracket corresponding to said connection means is said rack beam-facia bracket 710 and said column-beam bracket 750, respectively.

The rack beam-facia bracket 710, which is fixed to the said outskirt member at both sides away from the said column 240, is formed in the form of a single bracket 711, 712, respectively, The plurality of column-beam bracket 750 at the top portion of said column 240 and the rack beam-facia bracket 710 in the vicinity of said central base frame (c) are shown as one combined connection bracket 790, formed in the form of a single bracket 791, 792, 793 for each base frame (a), (b) & (c).

The two column-beam brackets 750 and one rack beam-facia bracket 710 of said center base frame (c) are formed in the form of a single bracket 792 of one combined connection bracket 790, which is indicated by reference symbol [xiv] and will be described again in another drawing separately.

FIG. 22 is an enlarged view of the portion {XIII} indicated by the dashed oval in FIG. 19 above.

The rack beam pair includes a southern rack beam 122 on the south side and a northern rack beam 124 on the north side, said southern rack beam and northern rack beam being placed parallel at certain intervals, and an inclined support member 160 being installed and fixed thereon.

The inclined support member 160 includes a horizontal support part 162 and a slope part 164 having a predetermined inclination angle, and the solar panels are installed on top of the slope part 164.

The column 240|241, 242 and roof beam 210|211, 212 forming the cross-sectional frame 206h at the center of the base frame (c) shown herein are shown to be formed as a single two-layer long span member by overlapping the backs of the two main members and integrally fixing them by welding, direct connection by self-drilling screws or bolt-nut fasteners, and fixed with column-beam connection means 750.

The roof beam 210 of said cross-sectional frame 206h projects forward past the column 240 and has an eave, the end of said roof beam 210 is finished with a roof beam facia 340, and immediately below said roof beam 210 of said cross-sectional frame 206h, a purlin 320 is fastened to the top of said column 240 with column-purlin connection means 390. The end of said roof beam 210 is secured by roof beam-facia connection means 380 to a roof beam facia 340, and above said roof beam facia 340 is incorporated a rack beam facia 140 to form a horizontal member (abbreviated as “outskirt member”) to finish the perimeter of the roof surface of said base frame (c), and to said outskirt member the ends of said rack beam pair 122, 124 are secured by rack beam-facia connection means 710.

Since the rack beam pair is arranged in an east-west direction according to the technical idea of the embodiments of the invention, while the position of the earth's surface has an arbitrary direction, it is possible that said rack beam pair and the roof beam of the cross-sectional frame are arranged in approximately the same direction. In this case, the flat roof of the solar workpiece formed by the rack beam pair and the roof beam is difficult to be a lattice structure in the form of #, so a number of bracing beams at the same height on the sides of the roof beam are provided. By placing a bracing beam at the same height on the side of said roof beam and fixing said rack beam pair on top of the bracing beam, said flat roof is made into a lattice structure in the form of #and becomes a load bearing structure.

The arrangement direction of said rack beam pair 122, 124 and said roof beam 210 of said cross-sectional frame 206h is approximately the same, showing that a bracing beam 310 is fixed with main member joint connection means 760 at the same height on the side of said roof beam 210, and that said rack beam pair 122, 124 is placed on top of said bracing beam 310 and fixed with beam-beam superposition connection means 740.

Each of the rack beam-facia connection means 710, main member joint connection means 760, beam-beam superposition connection means 740, column-beam connection means 750, roof beam-facia connection means 380 and column-purlin connection means 390 includes a plate bracket attached to the connection part of the two main members for indirect connection by welding, self-drilling screw or bolt nut fastener, The plate brackets corresponding to the above connection means are rack beam-facia bracket 710, main member joint bracket 760, beam-beam superposition bracket 740, column-beam bracket 750, roof beam-facia bracket 380 and column-purlin bracket 390, respectively.

At the left and center parts away from said column 240, said rack beam-facia bracket 710, which is fixed to said outer member, is formed in the form of a single bracket 711, 712, 713, said main member joint bracket 760 is formed in the form of a double bracket 761, 762, and said beam-beam superposition bracket 740 is formed in the form of a single bracket 741, 742, respectively.

At the top portion of said column 240, adjacent column-beam bracket 750 and column-purlin BRACKET 390 are shown formed into one combined connection bracket 790 in the form of a double bracket 791, 792, and at the end of said roof beam 210, adjacent roof beam-facia bracket 380 and rack beam-facia bracket 710 are shown formed into another combined connection bracket 790 in the form of a double bracket 793, 794.

The above roof beam facia 340 and bracing beam 310 are shown with different rectangular cross-sectional channels than other main members, which is intentionally to illustrate embodiments of the invention with respect to different main member cross-sectional shapes.

### Embodiment 4

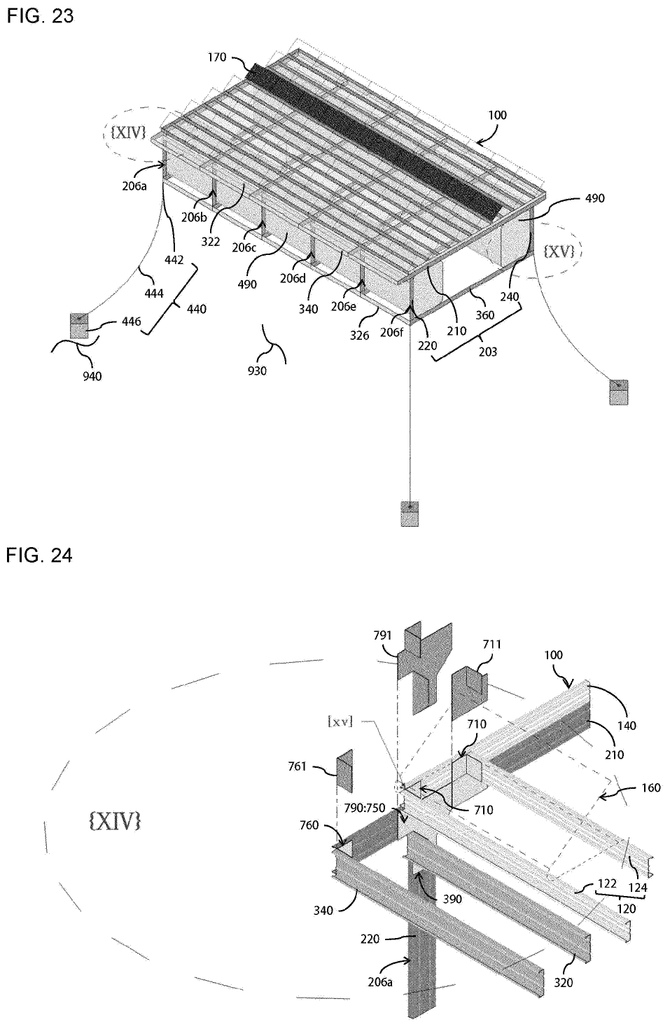

FIG. 23 is a conceptual illustration of a multipurpose solar energy system formed by a hexahedral solar workpiece having a roof of a rectangular plane for the application of a floating type solar energy system on water, as an embodiment 4 according to the invention.

The solar energy system is formed by forming a base frame of the hexahedron on a water surface 930, placing a floating body 490 therein, installing a solar rack 100 on the upper part thereof, and including a waterbed settlement means 440 on the lower part thereof.

In order for the solar panel 170 to be installed at a predetermined value of a suitable orientation and inclination angle, which is a north latitude inclination angle facing south in the case of a northern hemisphere region or a south latitude inclination angle facing north in the case of a southern hemisphere region, the solar rack 100 is positioned in an east-west direction, and the base frame of the lower part thereof is an elevation frame in the form of a box frame 203, which includes six cross-sectional frames 206a, 206b, 206c, 206d, 206e, 206f disposed across the subspace of said solar rack at certain intervals, and formed by closing the sides of said elevation frame with a roof beam facia 340, an upper purlin 322 and a lower purlin 326.

Said box frame 203 includes a roof beam 210, a bottom beam 360 and two columns 220, 240, said roof beam 210 terminating at the ends of said two columns 220, 240, or projecting outward from said two columns 220, 240 for a certain length to form a structure having an eave, and a floating body 490 positioned therein, which is shown to be positioned in a transverse direction with two purlins 322, 326, but said floating body 490 can also be positioned in a longitudinal direction (not shown) and can be installed in a number of modular forms.

Since a solar energy system such as a floating photovoltaic system installed on water such as an ocean, lake or dam has few restrictions on the direction of its positioning, it is settled in a suitable orientation so that the flat roof of the solar workpiece formed by the upper part of the solar rack and the base frame is a load-bearing structure, according to the technical idea of the embodiments of the invention.

Said waterbed settlement means 440 includes an anchor support member 442, an anchor rope 444 and an anchor 446, and said solar rack orient and fix said solar workpiece to the waterbed surface 940 with said waterbed settlement means 440 such that said solar panel 170 is positioned at a predetermined suitable orientation and inclination angle.

FIG. 24 is an enlarged and detailed view of the portion {XIV} indicated by the dashed oval in FIG. 23 above.

The rack beam pair 120 of the solar rack 100 includes a southern rack beam 122 on the south side and a northern rack beam 124 on the north side, said southern rack beam and northern rack beam being laid parallel at certain intervals, and an inclined support member 160 being installed and fixed thereon.

At the left front corner of the base frame shown here, on the roof beam 210 having the eaves of the far left cross-sectional frame 206a, a column 220 is fixed with column-beam connection means 750, and just below the roof beam 210 above said column 220, an upper purlin 320 is fixed with column-purlin connection means 390, the end of said roof beam 210 is secured by main member joint connection means 760 to the end of roof beam facia 340, and a rack beam facia 140 is incorporated above said roof beam 210 at said corner to form a structural horizontal member (abbreviated as “outskirt member 1210, 140) which finishes the left outer edge of the roof surface of said base frame.

Although not shown separately, the roof beams of cross-sectional frames 206b, 206c, 206d, 206e, which are located in the middle portion of said base frame, are finished with roof beam facia 340 and fixed with roof beam-facia connection means.

Said rack beam facia 140 is formed up to, but not limited to, the first rack beam pair 120|122, 124 in front of said base frame, and may extend to the location of said roof beam facia 340, in which case the rack beam facia is placed on top of said roof beam facia 340 to integrate with said outskirt member. To said base frame left outskirt member 210, 140, the ends of said rack beam pair 120|122, 124 are fixed by rack beam-facia connection means 710.

The main member joint connection means 760, column-beam connection means 750, column-purlin connection means 390 and rack beam-facia connection means 710 include a plate bracket attached to the connection part of the two main members for indirect connection by welding or by a self-drilling screw or bolt nut fastener, The plate brackets corresponding to the above connection means are main member joint bracket 760, column-beam bracket 750, column-purlin bracket 390, and rack beam-facia bracket 710, respectively.

The main member joint bracket 760 and the rack beam-facia bracket 710 are shown formed in the form of a single bracket 761, 711 respectively, and the adjacent column-beam bracket 750, column-purlin bracket 390 and the rack beam-facia bracket 710 at the top of the column 220 are shown formed in the form of a single bracket 791 as a combined connection bracket 790.

The combined connection bracket 790, which forms the adjacent column-beam bracket 750, column-purlin bracket 390 and rack beam-facia bracket 710 in the form of a single bracket 791 at the top of the columns of said base frame, is again described in another drawing separately by reference symbol [XV].

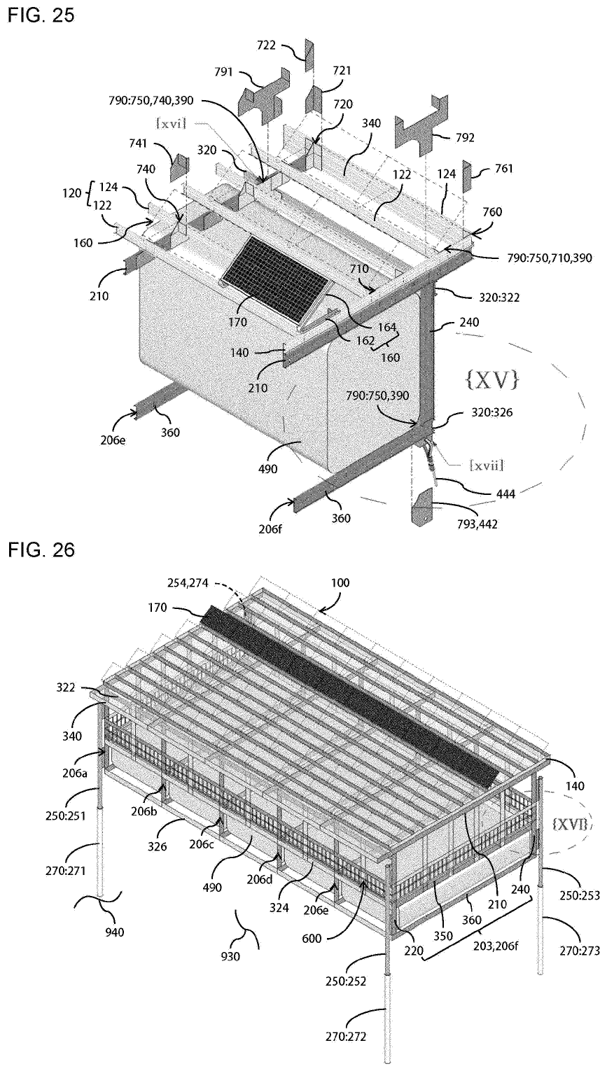

FIG. 25 is an enlarged view of the portion of {XV} indicated by the dashed oval in FIG. 23 above.

The rack beam pair 120 includes a southern rack beam 122 on the south side and a northern rack beam 124 on the north side, wherein the southern rack beam and the northern rack beam are placed parallel at certain intervals, and an inclined support member 160 is installed and fixed thereon. The inclined support member 160 includes a horizontal support part 162 and a slope part 164 having a predetermined inclination angle, and the solar panel 170 is installed on top of the slope part 164.

At the right rear corner of the base frame shown herein, a roof beam 210 and a column 220 having the eaves of the far right cross-sectional frame 206f are fixed by a column-beam connection means 750, and an upper purlin 3201322 just below said column 220 above roof beam 210 is fixed by a column-purlin connection means 390, and the end of said roof beam 210 and the end of roof beam facia 340 are fixed by a main member joint connection means 760, and the middle part of said roof beam facia 340 is fixed with roof beam-facia connection means 380, and at the right corner of said base frame, said rack beam facia 140 above said roof beam 210 and said northern rack beam 124 above said roof beam facia 340 are integrated to form a structural horizontal member (abbreviated as ‘outskirt member 1140, 210&340, 124’) which finishes the right outer edge of the roof surface of said base frame.

The ends of said rack beam pair 120|122, 124 are fixed by rack beam-facia connection means 710 to the outskirt member 210, 140 of cross-sectional frame 206f on the right side of said base frame, and the middle part of said rack beam pair 120|122, 124 is fixed by beam-beam superposition connection means 740 on the roof beam 210 of cross-sectional frame 206e located on the inside of said base frame. When the ends of the two cross-sectional frames 206e, 206f are finished with the roof beam facia 340, the right corner is fixed with the main member joint connection means 760 and the inside of the base frame with the roof beam-facia connection means 380.

The cross-sectional frame 206e, 206f bottom beam 360 is fixed at the bottom of the column 240 with column-beam connection means 750, and at the bottom of the column 240, the bottom purlin 3201326 is closed at the right end of the bottom beam 360 with column-purlin connection means 390. The roof beam 210 at the top of said cross-sectional frame 206e, 206f is fixed to the column 240 with column-beam connection means 750, and at the top of said column 240, the upper purlin 3201322 is located directly under the roof beam 210 and fixed with column-purlin connection means 390, thereby strengthening said base frame. The rack beam pair 120|122, 124 passing over the roof beam 210 above said column 240 is secured by beam-beam superposition connection means 740 or rack beam-facia connection means 710, which together with the adjacent said column-beam connection means 750 and column-purlin connection means 390 form one combined connection means 790 to secure the associated main member.

Said beam-beam superposition connection means 740, roof beam-facia connection means 380, main member joint connection means 760, and column-beam connection means 750 and column-purlin connection means 390 adjacent to the beam-beam superposition connection means 740 or rack beam-facia connection means 710, the combined connection means 790 comprising a plate bracket attached to the connection part of the associated main member for indirect connection by welding or by a self-drilling screw or bolt nut fastener, The plate bracket corresponding to said connection means is a single} combined connection bracket 790 comprising a beam-beam superposition bracket 740, a roof beam-facia bracket 380, a main member joint bracket 760 and a column-beam bracket 750 and a column-purlin bracket 390 adjacent to the beam-beam superposition bracket 740 or the rack beam-facia bracket 710, respectively.

The beam-beam superposition bracket 740 and the main member joint bracket 760 are each formed in the form of a single bracket 741, 761, the roof beam-facia bracket 380 is formed in the form of a double bracket 381, 722, and the column-beam bracket 750, the beam-beam superposition bracket 740 and the column-purlin bracket 390 are formed in the form of a single bracket 791 on the upper left side of the base frame, one combined connection bracket 790 of column-beam bracket 750, rack beam-facia bracket 710 and column-purlin bracket 390 is formed in the form of single bracket 792 at the upper right corner of said base frame, and one combined connection bracket 790 of column-beam bracket 750 and column-purlin bracket 390 is formed in the form of single bracket 793 at the lower right corner of said base frame.

The single bracket 793, located at the right lower corner of the base frame, includes an anchor fixing member 442 as a waterbed settlement means, to which an anchor rope 444 is attached to be settled on the waterbed.

The combined connection bracket 790, which is formed by connecting the adjacent column-beam bracket 750, beam-beam superposition bracket 740 and column-purlin bracket 390 in the form of a single bracket 791 at the upper part of the left column of said base frame, is indicated by reference symbol [XVI], The combined connection bracket 790 formed in the form of a single bracket 793 with the adjacent column-beam bracket 750 and column-purlin bracket 390 at the lower part of the right column of the base frame is indicated by the reference symbol [xvii] and is again described in another drawing separately.

### Embodiment 5

FIG. 26 is a conceptual illustration of a multipurpose solar energy system formed by a hexahedral solar workpiece having a roof of a rectangular plane for the application of a semi-floating type solar energy system on water, as an embodiment 5 according to the present invention.

A hexahedral base frame is formed on a water surface 930, a solar rack 100 is installed on top thereof, a floating body 490 is positioned on the bottom thereof, and a number of cylindrical major columns 270|271, 272, 273, 274 each having a piston-like minor column 250|251, 252, 253, 254 inserted therein, said minor columns being attached to and secured to the four corners of said base frame.

The solar energy system is constructed in a water body 930, such as a lake, swamp, dam, etc. at a suitable depth of water, and a floating body 490 is placed at the bottom of the base frame, so that the piston-type pontoon pillars 250 are inserted into the cylinder-shaped periodic column 270 fixed to the water body 940 to fluctuate up and down according to the change of water level, and the interior space of the base frame can be utilized for other purposes such as leisure or residence.

Since the position of said solar workpiece is less constrained by orientation, said solar rack 100 is positioned so that the solar panel 170 has a suitable orientation and inclination angle, which is a value determined in the vicinity of a north latitude inclination angle facing south for a northern hemisphere region or a south latitude inclination angle facing north for a southern hemisphere region, and said base frame is placed beneath it. It is shown here that the cross-sectional frames 206a, 206b, 206c, 206d, 206e, 206f across the solar rack 100 and its subspace are orthogonal, but are not limited thereto.

Said cross-sectional frames 206f are elevation frames, disposed at certain intervals below the solar rack 100, in the form of a box frame 203 with two columns 220, 240 on each side, formed by fixing a roof beam 210 at the top, a middle beam 350 at the center and a bottom beam 360 at the bottom. A floating body 490 is located between said middle beam 350 and bottom beam 360, and a space surrounded by a handrail 600 is left between said roof beam 210 and middle beam 350 to be utilized for certain purposes such as leisure.

Said solar rack side incorporates a rack beam facia 140 over said roof beam 210, and the end of said roof beam 210 having an eave beyond the two columns 220, 240 of said cross-sectional frame is finished with a roof beam facia 340, so that the roof surface of said base frame is formed as a load bearing structure. Furthermore, on both sides of said cross-sectional frame, an upper purlin 322 is fixed to the top of the two columns 220, 240 directly below the roof beam 210, and a middle purlin 324 and a lower purlin 326 are attached to the positions of said middle beam 350 and bottom beam 360, respectively, incorporating said handrail 600 just above said middle beam 350 into an elevation frame forming an outline of said base frame, so that said hexahedral solar workpiece is formed as a load-bearing structure.

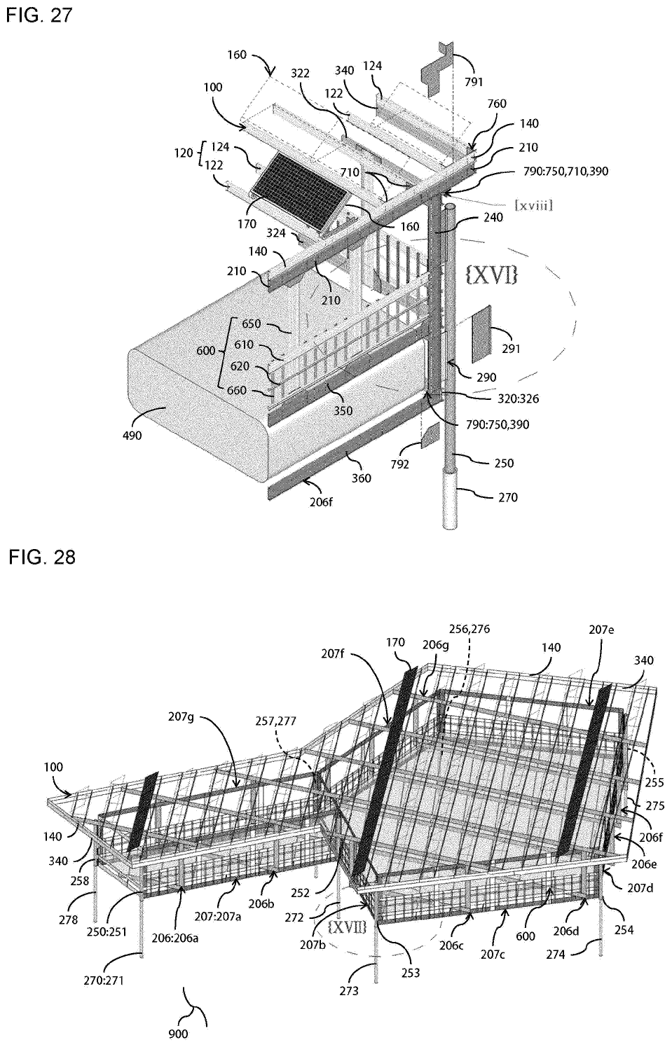

FIG. 27 is an enlarged and detailed view of the portion {XVI} indicated by the dotted oval in FIG. 26 above.

The rack beam pair 120 of the solar rack 100 includes a southern rack beam 122 on the south side and a northern rack beam 124 on the north side, said southern rack beam and northern rack beam being placed parallel at certain intervals, and an inclined support member 160 being installed and fixed thereon. Said solar panel 170 is installed on said inclined support member 160.

At the right rear corner of the base frame illustrated herein, the roof beam 210 and column 220 having the eaves of the far right cross-sectional frame 206f are fixed by the column-beam connection means 750, the upper purlin 320 just below the roof beam 210 above said column 220 is fixed by the column-purlin connection means 390, and the end of said roof beam 210 and the end of the roof beam facia 340 are fixed by the main member joint connection means 760, whereas, at the right corner of said base frame, said rack beam facia 140 on top of said roof beam 210 and said northern rack beam 124 on top of said roof beam facia 340 are integrated to form a structural horizontal member (abbreviated as ‘outskirt member 1140, 210&340, 124’) which finishes the right outer edge of the roof surface of said base frame.

The ends of said rack beam pair 120|122, 124 are fixed to the outskirt member 210, 140 of said base frame right cross-sectional frame 206f by rack beam-facia connection means 710, and the ends of said roof beam facia 340 and roof beam 210 of said cross-sectional frame 206f by main member joint connection means 760.

In the space between the middle beam 350 and the bottom beam 360 of said cross-sectional frame 206f, a floating body 490 is located, and in the space between the roof beam 210 and the middle beam 350, a handrail 600 having a handrail horizontal member 610, 620 and a handrail vertical member 650, 660 is integrated with an elevation frame forming an outline of said base frame, just above said middle beam 350 for utilization for separate leisure or residential purposes. Said handrail horizontal members include a long horizontal member 610 and a short horizontal member 620, and said handrail vertical members include a long vertical member 650 and a short vertical member 660, with each of said long horizontal member 610 and short horizontal member 620 fixed to a post in a purlin-like fashion, wherein said long vertical member 650 is spaced and secured between said middle beam 350 and said roof beam 210, and between said middle purlin 324 and said upper purlin 322.

The column 240 of said cross-sectional frame 206f is fixed with roof beam 210, middle beam 350 and bottom beam 360 and column-beam connection means 750, and an upper purlin 322 directly below said roof beam 210 on the side of said cross-sectional frame 206f, and middle purlin 324 and bottom purlin 3201326 of the same height of said middle beam 350 and bottom beam 360, respectively, are fixed to said column 240 with column-purlin connection means 390, so that said base frame is strengthened.

Although the ends of rack beam pairs 120|122, 124 passing through roof beam 210 at the top of said column 240 are finished with rack beam-facia connection means 710 to said outskirt members 140, 210, adjacent said column-beam connection means 750 and column-purlin connection means 390 are formed into one upper combined connection means 790 to secure the associated main member, and at the bottom of said column 240, said column-beam connection means 750 and column-purlin connection means 390 are also formed into a lower combined connection means 790.

A piston-type side member 250 attached to the side of said column 240 forming a right rear corner of said base frame is fixed by column-beam connection means 290 with a column-purlin bracket 291, and said side member 250 is inserted into and settled on a cylindrical periodic column 270.

The rack beam-facia connection means 710, the column-beam connection means 750 and the column-purlin connection means 390, the upper combined connection means 790, and the lower combined connection means 790, comprising a plate bracket attached to the connection part of the relevant main member, and indirectly connected by welding, self-drilling screw or bolt nut fastener, The plate bracket corresponding to the above connection means is shown to be formed in the form of a single bracket 791, 792 with a rack beam-facia bracket 710, a single upper combined connection bracket 790 with a column-beam bracket 750 and a column-purlin bracket 390, and a single lower combined connection bracket 790 with a column-beam bracket 750 and a column-purlin bracket 390, respectively.

The adjacent rack beam-facia bracket 710, column-beam bracket 750 and column-purlin bracket 390 formed in the form of a single bracket 791 at the top of the column of the base frame are again described in another drawing separately by reference symbol [xviii].

### Embodiment 6

Referring now to FIG. 28, there is shown a conceptual illustration of a multipurpose solar energy system formed by an arbitrary polygonal plane solar workpiece, which is constructed by erecting poles on an earth's surface, as embodiment 6 according to embodiments of the invention.

Any polygonal plane solar workpiece supported by a periodic column 270 anchored to an earth's surface 900 includes a primary cubic frame 206 in an upper portion and a secondary cubic frame 207 in a lower portion in the form of a box frame, and the two cubic frames are formed by merging.

Said solar workpiece is supported by columns 270, 250 on said earth's surface 900, so that it is constructed regardless of the positioning direction or condition of the solar energy system. Depending on the layout of said location, said SOLAR RACK 100 is first positioned so that said solar panel 170 has a suitable orientation and inclination angle in the vicinity of a suitable inclination angle of north latitude facing south for northern hemisphere regions or south latitude facing north for southern hemisphere regions, and said primary CUBIC FRAME 206 is placed thereunder. Said primary cubic frame 206 includes seven cross-sectional frames 206|206a, 206b, 206c, 206d, 206e, 206f, 206g disposed and crossing the interior space of said solar workpiece at certain intervals, whereas, said cross-sectional frame 206 is in the form of a box frame having eaves, and the flat roof of said solar workpiece formed by said cross-sectional frame 206 and the solar rack 100 becomes a lattice structure in the form of a #and becomes a load bearing structure.

The secondary cubic frame 207 has seven side wall frames 207|207a, 207b, 207c, 207d, 207e, 207f, 207g arranged on the outer periphery of the polygonal plane of the solar workpiece, and the side wall frames 207 are in the form of a box frame without eaves, wherein eight minor columns 250|251, 252, 253, 254, 255, 256, 257, 258 are attached to the corresponding corners at the vertices of said polygonal plane and fixed respectively to the major columns 270|271, 272, 273, 274, 275, 276, 277, 278.

By merging said first cubic frame 206 and second cubic frame 207, each roof beam is supported and fixed by a roof beam and a bottom beam by a bottom beam, so that a solar workpiece of said polygonal plane is formed.

The roof beam ends of said primary frame, cross-sectional frame 206, abutting the sides of said polygonal plane, are terminated with roof beam facia 340, and above said roof beam facia 340 is a horizontal member incorporating rack beam facia 140 to form the outline of said base frame roof surface.

The secondary frame, side wall frame 207, includes a handrail 600 at a certain height along the bottom beam, and the handrail is attached to and integrated with the side wall frame to form a vertical load bearing structure.

Said primary cubic frame or secondary cubic frame may further comprise a roof, floor and walls or railings as optional subordinate frames, said roof being secured by a sheet type structure attached to said roof beams, said floor being secured by a sheet type structure attached to said floor beams, and said walls being secured by sheet type structures attached to the sides of said columns, the handrail is formed as an integral elevation structure with the columns at the corners of the floor, whereby the roof becomes an uncovered structure, the floor and walls become a safety structure and the interior space is divided according to the use, and the solar workpiece is formed as a structure in which the roof and floor share the horizontal load and the walls and handrail share the vertical load.

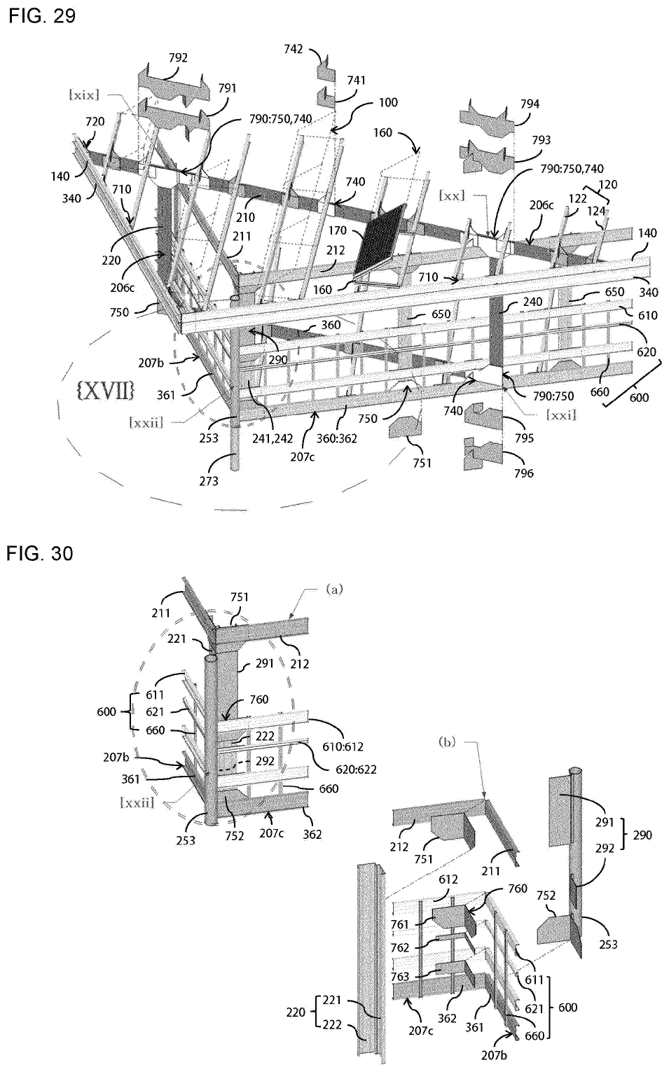

FIG. 29 is an enlarged, detailed view of the {XVII} section shown by the dashed oval in FIG. 28 above.

The rack beam pair 120 of the solar rack 100 includes a southern rack beam 122 on the south side and a northern rack beam 124 on the north side, said southern rack beam and northern rack beam being placed parallel at certain intervals, and an inclined support member 160 being installed and fixed thereon. Said solar panel 170 is installed on said inclined support member 160.

As said rack beam pair 120 of the solar rack 100 is fixedly arranged in the east-west direction, in order to make the flat roof of the solar workpiece a load-bearing structure, the cross-sectional frame 206c, which is a primary frame, is arranged so that said flat roof becomes a lattice structure in the form of #. Said cross-sectional frame 206C is formed in the form of a box frame by fixing a roof beam 210 having eaves to the top of two columns 220, 240 and a bottom beam 360 to the bottom of said columns with column-beam connection means 750. While said roof beam 210 is not necessarily orthogonal to said rack beam pair 120, it is preferred that the intersection angle is at least 30 degrees in order for the technical ideas of the embodiments of the invention to be effectively expressed. The interior space of said box frame is formed to be utilized for separate leisure or residential purposes.

Said rack beam pair 120 is secured to said roof beam 210 with beam-beam superposition connection means 740, and both ends of said roof beam 210 are finished with roof beam facia 340 along the perimeter of the multi-angle flat roof of the solar workpiece, Above said roof beam facia 340, rack beam facia 140 is integrated to form a horizontal member (abbreviated as “outskirt member 1140, 340) that finishes the perimeter of said flat roof. To said outskirt member, the end of said rack beam pair 120 is fixed with rack beam-facia connection means 710, and the end of said roof beam 210 is fixed with roof beam-facia connection means 380.

Said primary frame, cross-sectional frame 206C, is a secondary frame in the form of a box frame, with two side wall frames 2076, 207C forming the sides of said solar workpiece polygonal plane, with the roof beam 211 of said two side wall frames 2076, 207C, 212 are placed directly below the roof beam 210 of said cross-sectional frame 206c, and the bottom beams 361, 362 of said two side wall frames 2076, 207c are placed directly below the bottom beam 360 of said cross-sectional frame 206c, and are respectively fixed with beam-beam superposition connection means 740. At both ends of the column 241, 242 of each of the two side wall frames 2076, 207c, the two roof beams 211, 212 and the two bottom beams 361, 362 are respectively fixed by column-beam connection means 750.

Above the bottom beams 361, 362 of each of the two side wall frames 2076, 207c, a railing 600 is integrated to form a vertical load-bearing structure. The handrail 600 includes handrail horizontal members 610, 620 and handrail vertical members 650, 660, wherein the handrail horizontal members include long horizontal member 610 and short horizontal member 620, and the handrail vertical members include long vertical member 650 and short vertical member 660, wherein each of the long horizontal member 610 and the short horizontal member 620 is fixed to a column in a purlin-like form at the bottom of the interior space of said box frame, said long vertical member 620 being disposed at certain intervals and fixed between the roof beam 211, 212 and the bottom beam 361, 362 with column-beam connection means 750, and said short vertical member 660 being disposed at certain intervals and fixed between the long horizontal member 610 and the bottom beam 360 at the top.

Each of the two columns 241, 242 forming the corners of said polygonal solar workpiece where said two side wall frames 2076, 207c abut, are integral and shared as a single column, said column being connected to a minor column 253 attached to the outer side of said corner and secured by column-column connection means 290, said minor column being anchored to another major column 273 anchored to the surface of the earth. In accordance with the technical idea of the embodiments of the invention, the columns added in the formation of said polygonal solar workpiece are not necessarily limited to the combination of both elements of said boil column 253 and the master column 273, but only one of the two columns 253, 273) may be added.

The beam-beam superposition connection means 740 of said rack beam pair 120 and roof beam 210, the column-beam connection means 750 of said bottom beam 3601362 and long vertical member 650 of the handrail 600, and the left column 220 top portion and the right column 240 top portion of said primary frame, cross-sectional frame 206c, and at the bottom of said right column 240, one combined connection means 790 comprising a column-beam connection means 750 and a plurality of beam-beam superposition connection means 740, wherein a plate bracket is added to the connection part of the associated main member to provide an indirect connection by welding or a self-drilling screw or a bolt-nut fastener, The plate brackets corresponding to the above connection means are shown to be formed in the form of double brackets 741, 742 for the beam-beam superposition bracket 740, single brackets 751 for the column-beam bracket 750, double brackets 791, 792 for the combined connection bracket 790 at the top of the left column 220, double brackets 793, 794 for the combined connection bracket 790 at the top of the right column 240, and double brackets 795, 796 for the combined connection bracket 790 at the bottom of the right column 240.

The coupling of the columns added to the solar workpiece is more particularly described in the following drawings by reference symbol [xviii].

FIG. 30 is an embodiment according to the invention with respect to the portion [xxii] indicated by the double-dashed ellipse in FIG. 29 above, showing the joining and disassembling of the columns in a solar workpiece formed by adding separate columns.

With respect to the columns applied to the corners of said solar workpiece forming the space above the polygonal plane, the portion of the drawing referred to as (a) shows the added column 253 in the engaged state and (b) in the disengaged state.

The roof beams 211, 212 and bottom beams 361, 362 of the two side wall frames 207b, 207c forming the sides of said polygonal plane are secured by column-beam connection means 751, 752 at the upper and lower ends of the column 221, 222, respectively, and said two columns 221, 222 are united and shared as one column, said column being connected to an additional column 253 applied to the outer side of said corner and secured by column-column connection means 290|291, 292. In addition to said column-beam connection means, said column-beam connection means 752 can be fixed to said side columns 253 to strengthen the support of said solar workpiece.

In the lower part of said two side wall frames 2076, 207c, horizontal members 610|611, 612; 620|621, 622 and vertical members 660 of the handrail 600 are placed at certain intervals in the same plane, so that the horizontal members of the same height are fixed by main member joint connection means 7601761, 762, 763, and said vertical members 660 are fixed to horizontal members 610, 620 and bottom beam 361, 362 in an additive form. The main member joint connection means 760 abuts the column 220 and thus functions almost identically to the column-purlin connection means.

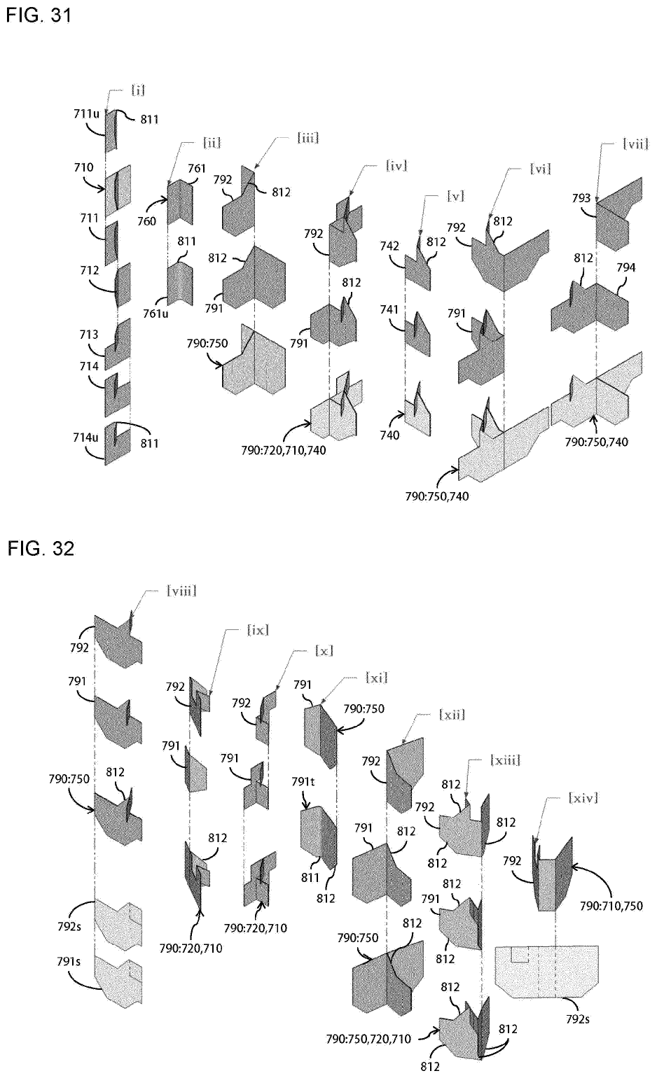

FIG. 31 illustrates shapes according to the technical idea of the embodiments of the invention for certain plate brackets [i] to [vii] described above.

Reference symbol [i] in the drawings is an example showing various plate bracket shapes 711, 712, 713, 714, 715, 716 of the rack beam-facia connection means 710 shown in FIG. 3, including one double bracket 711, 712, two single brackets 713, 714 and two modified single brackets 715, 716.

In a rack beam-facia bracket 711, the ends of a pair of rack beams are secured with rack beam-facia connection means 710 to a horizontal member (abbreviated “outskirt member”) of a structure incorporating a rack beam-facia over a roof beam, roof beam facia, or bracing beam that finishes the perimeter of a flat roof of a solar workpiece, 712 are applied single or double by forming two single brackets 711, 712 to the left and right of the contact line where the rack beam and the back surface of said outskirt member meet (abbreviated as ‘reference line’). Said double bracket 711, 712 can be applied as a single horizontal member by overlapping two layers of rack beams centered on the back surface.

Said two single brackets 713, 714 are adapted to be applied by selecting one or the other by forming two single brackets 713, 714 covering said left and right sides with said reference line as the center. Said two single brackets 713, 714 may be double-layered horizontal members positioned below said outskirt member, and of course the application of a double-layered rack beam is also possible.

The two single brackets 711u, 714u corresponding to the two single brackets 711, 714 above show that the curved surface 811 is formed by bending each with a certain (minimum) radius of curvature.

Reference symbol [ii] in the drawing is an example of a plate bracket shape of the main member joint connection means 760 shown in FIG. 3, which is in the form of a single bracket 761, and shows that the curved surface 811 is formed by bending 761u with a certain radius of curvature.

Reference symbol [iii] in the drawing shows two adjacent column-beam connection means 750 shown in FIG. 3 forming one combined connection means 790, and double brackets 791, 792 of the combined connection bracket 790 as plate brackets. Said combined connection bracket 790 includes an inclined edge 812 that shares two posts and is secured to said outskirt member with which the rack beam facia is integrated on the roof beam and extends to the top of said rack beam facia.

Reference symbol [iv] in the drawings is to FIG. 4, which shows the adjacent roof beam-facia connection means 380, rack beam-facia connection means 710 and beam-beam superposition connection means 740 forming a single combined connection means 790 and a double bracket 791, 792 of the combined connection bracket 790 as a plate bracket. A roof beam is secured at its end to a roof beam facia by a roof beam-facia bracket 380, a rack beam pair is secured at its end to an outskirt member having a rack beam facia incorporated on said roof beam facia by a rack beam-facia bracket 710, and a roof beam and a beam-beam superposition bracket 740, with said three brackets 380, 710, 740) are adjacent and formed into one said combined connection bracket 790, said combined connection bracket 790 being formed in the form of a double bracket 791, 792 to support a cylindrical column of a different shape from the main member below the area where said roof beam connects to said roof beam facia.

The reference symbol [V] in the drawing is an example of a plate bracket shape of the beam-beam superposition connection means 740 shown in FIG. 4, which shows the double bracket 741, 742 format of the beam-beam superposition bracket 740. Said beam-beam superposition bracket 740 is applied to fix a rack beam passing over a roof beam, and only one of said double brackets 741, 742 can be applied, or two layers of roof beams can be overlapped with the back surface centered to form a base frame as a single horizontal member. Said beam-beam superposition bracket 740 includes a sloping edge 812 from the top of the rack beam to the top of the roof beam on a side abutting the roof beam.

Reference symbols [vi] and [vii] in the drawings show a combined connection means 790 by which the four columns and four roof beams shown in FIG. 5 are joined at a single site, wherein the columns and roof beams are each applied as two layers of main members that are integral with each other face-to-face. The combined connection means 790 is roughly divided into two parts, left [vi] and right [vii], and a plurality of adjacent column-beam connection means 750 and beam-beam superposition connection means 740 form one combined connection bracket 790, respectively, and are applied clockwise in the form of double brackets 791, 792&793, 794, respectively. The side abutting the roof beam includes an inclined surface 812 from the top of the rack beam to the top of the roof beam.

FIG. 32 illustrates the shape of certain plate brackets [viii] to [xiv] described above in accordance with embodiments of the invention.

The reference symbol [viii] in the drawing is shown in FIG. 6, and is applied in the form of a double bracket 791, 792 of the combined connection bracket 790 by forming the adjacent column-beam connection means 750 and the beam-beam superposition connection means 740 into one combined connection means 790, as a roof beam is supported by a column and a rack beam passes over it. Said combined connection bracket 790 may be applied to the joining of a two-layer main member in which said column and said roof beam are respectively integrated with their backsides facing each other. The side abutting said roof beam and column includes a sloping edge 812 from the top of the rack beam to the top of the roof beam. Each of the double brackets 791, 792 is shown in the unfolded plane 791s, 792s before bending, with the solid lines sheared and the dashed lines bent.

Reference symbols [ix] in the drawings refer to the roof beams shown in FIG. 7, which shows a combined connection means 790 in which a rack beam is joined with a rack beam-facia connection means 710 at a site where a roof beam facia terminates the end of one roof beam shown in FIG. 7 with a roof beam-facia connection means 380, and above said roof beam facia is applied an outskirt member, which is a horizontal member in which the rack beam facia is integrated. Said combined connection means 790 is applied in the form of a double bracket 791, 792 of said combined connection bracket 790, and the side abutting said roof beam includes an inclined side 812 from the top of the rack beam to the top of the roof beam. FIG. 7 is shown from a different angle than in FIG. 6 to better illustrate the shape of the combined connection bracket 790.

The reference symbol [x] in the drawing is a reference to FIG. 7. 8, which shows a combined connection means 790 in which a rack beam is joined with a rack beam-facia connection means 710 at a site where a roof beam facia terminates the end of a roof beam with a roof beam-facia connection means 380, and an outskirt member, a horizontal member with an integrated rack beam facia, is applied above said roof beam facia. The combined connection means 790 is applied in the form of a double bracket 791, 792 of the combined connection bracket 790, but does not include the sloping sides found in other roof beam-facia brackets.

Reference symbol [xi] in the drawings is to FIG. 16, wherein two portal frames, side wall frames, share one column to form a corner, and two column-beam connection means 750 supporting each roof beam at the top of said corner are applied in the form of a single bracket 791 of the combined connection means 790. Above said two roof beams, said single bracket 791 is fixed to an outskirt member, which is a horizontal member with an integrated rack beam face, wherein the bending portion of said single bracket 791 has a curved surface 811 of a certain (minimum) radius of curvature so that a rounded corner is formed, and the side in contact with the back surface of the roof beam has an inclined surface 812 from the lower end of the side in contact with the back surface of the column to the lower end of the roof beam.

Reference symbols [xii] in the drawings are shown in FIG. 17, which shows a base frame formed by three portal frames, one cross-sectional frame and two side wall frames sharing each column to form a corner of a convex obtuse angle, and three column-beam connection means 750 supporting each roof beam at the top of said corner in the form of double brackets 791, 792 of one combined connection means 790. Above the two roof beams of the two side wall frames forming the outline of said base frame, the rack beam fascia becomes an integral horizontal member, and said double bracket 791, 792, respectively, the side abutting said cross-sectional frame roof beam and the column includes a sloping edge 812 from the top of the rack beam facia to the top of the roof beam.

Reference symbol [xiii] in the drawings refers to the portal of FIG. 18, wherein in a base frame formed by one portal frame, columns of one cross-sectional frame form a corner of a concave obtuse angle, one column-beam connection means 750 supporting a roof beam at the top of said corner, and one roof beam-facia connection means 380 securing a roof beam facia at both ends of said roof beam, and a rack beam-facia connection means 710 for fixing a rack beam to a horizontal member (abbreviated as “outskirt member”) which is integrated with said roof beam facia and forms the outer periphery of the roof surface of said base frame, and which is applied in the form of double brackets 791, 792 of a single combined connection means 790. Said double brackets 791, 792 each include an inclined edge 812 on a side that encompasses a neighboring main member without directly contacting said roof beam, column and outskirt member back surface. For example, the side of the roof beam and the side that contacts the backside of the column has a sloping edge 812 from the bottom of the roof beam to the bottom of the side that contacts the backside of the column.

Reference symbol [xiv] in the drawings refers to FIG. 21, wherein there is shown a column-beam connection means 750 for securing a respective roof beam over said two columns, spaced more or less adjacent to each other, in a base frame formed by two portal frames, and a rack beam-facia connection means 710 for fixing the ends of the rack beams to a horizontal member having an integrated rack beam facia above said roof beams, in the form of a single bracket 792 of a combined connection means 790. The bottom figure shows an unfolded plane 792s before bending of said single bracket 792, wherein the solid line is sheared and the dashed line is bent.

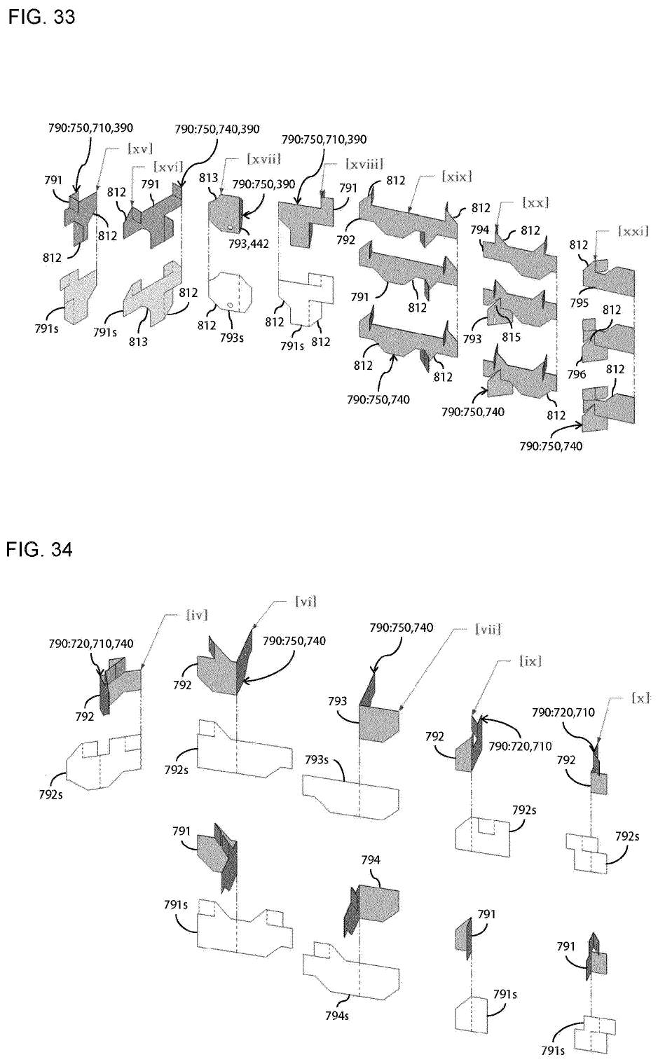

FIG. 33 illustrates a shape according to the technical idea of the invention for certain plate brackets [xv] to [xxi] described above.

The reference symbol [xv] in the drawings refers to FIG. 24, which shows a column-beam connection means 750 for fastening a column to a roof beam of a cross-sectional frame having eaves, and a column-purlin connection means 390 for fastening an upper purlin directly below said roof beam to said column, a rack beam-facia connection means 710 for securing a rack beam to a horizontal member incorporating a rack beam facia above said roof beam, adapted in the form of a single bracket 791 of said combined connection means 790. In said single bracket 791, the side contacting said upper purlin has an inclined side 812 from the bottom of the upper purlin to the bottom of the side contacting the back surface of the column, the side abutting said roof beam and the back side of the column has a sloping edge 812 from the bottom of the outer side of the back side of said roof beam toward the back side of the column, wherein in the unfolded plane 791s before bending of said single bracket 791, the solid lines are sheared and the dashed lines are bent.

Reference symbol [xvi] in the drawings is to FIG. 25, shown in the upper left center, a column-beam connection means 750 for fastening a column to a roof beam of a cross-sectional frame having eaves, and a column-purlin connection means 390 for fastening an upper purlin directly below said roof beam to said column, and a beam-beam superposition connection means 740 for securing a rack beam above said roof beam, applied in the form of a single bracket 791 of said combined connection means 790. In said single bracket 791, the side contacting said upper purlin has an inclined side 812 from the bottom of the upper purlin to the bottom of the side contacting the back side of the column, said side abutting the roof beam and the back side of the column has a curved side 813 from the bottom of the inner side of the back side of said roof beam toward the back side of the column, wherein in the unfolded plane 791s before bending of said single bracket 791, the solid line is sheared and the dashed line is bent. The curved side 813 is a variation of the sloped side and is intended to provide space for the installation of a floating body within the solar workpiece.

Reference symbol [xvii] in the drawing is shown at the bottom right of FIG. 25, wherein a column-beam connection means 750 for fixing a column to a bottom beam of a cross-sectional frame and a column-purlin connection means 390 for fixing a bottom purlin to said column at the end of the beam are applied in the form of a single bracket 793 of a combined connection means 790, to which an anchor fixing member 442 is added as a waterbed settlement means. In said single bracket 793, the side contacting said bottom purlin has an inclined side 812 from the top of said bottom purlin to the top of the side contacting the back surface of the column, and the side contacting said bottom beam and the back surface of the column has a curved side 813 from the top of the inner back surface of said bottom beam to the back surface of the column, wherein the lower end of said single bracket 793 protrudes and extends to form an anchorage 442, and wherein in the unfolded plane 793s of said single bracket 793 before bending, the solid lines are sheared and the dashed lines are bent. Said curved side 813 is a modified shape of an inclined side to provide space for the installation of a floating body within the solar workpiece.

Reference symbols [xviii] in the drawings refer to FIG. 27, shown in the right rear corner, with column-beam connection means 750 for fastening a column to a roof beam of a cross-sectional frame having eaves, and column-purlin connection means 390 for fastening an upper purlin directly below said roof beam to said column, a rack beam-facia connection means 710 for securing a rack beam to a horizontal member incorporating a rack beam facia above said roof beam, adapted in the form of a single bracket 791 of said combined connection means 790. In said single bracket 791, the side contacting said upper purlin has an inclined side 812 from the bottom of the upper purlin to the bottom of the side contacting the back surface of the column, the side abutting the roof beam and the back side of the column has a sloping edge 812 from the bottom of the inner side of the back side of the roof beam toward the back side of the column, wherein in the unfolded plane 791s before bending of said single bracket 791, the solid lines are sheared and the dashed lines are bent.

Reference symbols [xix] in the drawings refer to FIG. 29 at the top of the left column of the cross-sectional frame, which is a primary frame, with column-beam connection means 750 for securing a roof beam above the left column, and two beam-beam superposition connection means 740 for securing a rack beam pair above said roof beam, and a beam-beam superposition connection means 740 for securing another roof beam of the secondary frame directly below said roof beam, applied in the form of double brackets 791, 792 of one combined connection means 790. In said double bracket 791, 792, the sides abutting the back surfaces of said roof beam and column, respectively, have inclined sides 812 at the bottom of both sides of said column, from the top of said rack beam pair to the top of said roof beam, and from the bottom of the other roof beam of said secondary frame to the bottom of the roof beam of said primary frame.

Reference symbol [xx] in the drawings refers to a transverse beam that is a primary frame in FIG. 29 at the top of the right column of the cross-sectional frame, which is the primary frame, with a column-beam connection means 750 for securing a roof beam above the right column, and two beam-beam superposition connection means 740 for securing a rack beam pair above said roof beam, and a beam-beam superposition connection means 740 for securing another roof beam of the secondary frame directly below said roof beam, applied in the form of double brackets 793, 794 of one combined connection means 790. In said double bracket 793, 794, the sides abutting the backs of said roof beam and column, respectively, have inclined sides 812 at the bottom of both sides of said column, from the top of said rack beam pair to the top of said roof beam, and from the bottom of the other roof beam of said secondary frame to the bottom of the roof beam of said primary frame.

The reference symbol [xxi] in the drawings refers to FIG. 29 at the bottom of the right column of the cross-sectional frame, which is the primary frame, with column-beam connection means 750 for securing a bottom beam under the right column, and beam-beam superposition connection means 740 for securing a long horizontal member of the handrail above said bottom beam, and the beam-beam superposition connection means 740 for securing another bottom beam of the secondary frame directly below said bottom beam, in the form of double brackets 795, 796 of the combined connection means 790. In said double bracket 795, 796, the side abutting the back of said bottom beam and the column, respectively, has an inclined side 812 inwardly of said column and an inclined side 812 from the top of said long horizontal member to the top of said bottom beam. The side abutting the back surface of the bottom beam of said secondary frame is cut and bent relative to the side abutting the back surface of the bottom beam of said primary frame.

FIG. 34 shows the shape of the unfolded plane before bending of certain objects ([iv], [vi], [vii], [ix], [x]) among the plate brackets described above, wherein the solid lines are sheared and the dashed lines are bent.

Reference symbol [iv] in the drawing shows one of the double brackets 792 of the combined connection bracket 7901380, 710, 740 of FIG. 4 and FIG. 31 and the unfolded planes 792s.

Reference symbols [vi] and [vii] in the drawings show each of the double brackets 791, 792&793, 794 of combined connection bracket 7901750, 740 in FIGS. 5 and 31 and the corresponding unfolded planes (791s, 792s&793s, 794s).

Reference symbol [ix] in the drawings shows double bracket 791, 792 of combined connection bracket 7901380, 710 in FIGS. 7 and 32 and the corresponding unfolded planes (791s, 792s).

The reference symbol [x] in the drawings shows the double bracket 791, 792 of the combined connection bracket 7901380, 710 and the corresponding unfolded planes 791s, 792s in FIGS. 8 and 32.

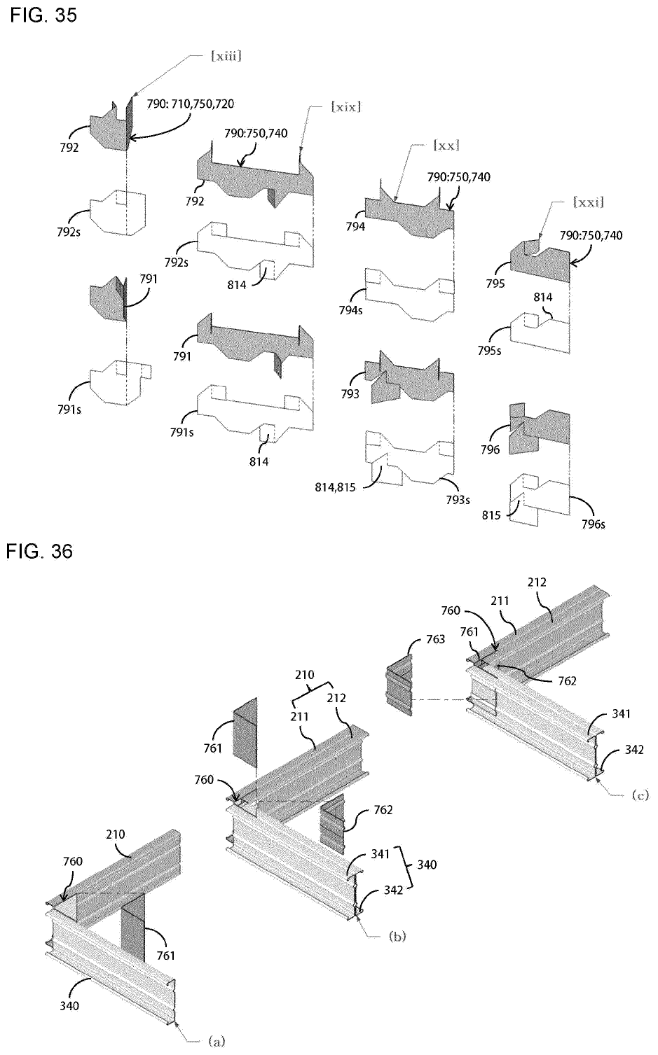

FIG. 35 shows the shape of the unfolded plane before bending of certain objects ([xiii], [xix], [xx], [xxi]) of the aforementioned plate brackets, wherein the solid lines are sheared and the dashed lines are bent.

Reference symbol [xiii] in the drawings shows the double bracket 791, 792 of the combined connection bracket 790|710, 750, 380 in FIGS. 18 and 32 and the corresponding unfolded planes (791s, 792s).

Reference symbols [xix], [xx] and [xxi] in the drawings show double brackets 791, 792; 793, 794&795, 796 of combined connection bracket 790|710, 750, 380 and corresponding unfolded planes (791s, 792s; 793s, 794s&795s, 796s) in FIGS. 27 and 33, respectively. The two double brackets 791, 792&793, 794 referred to as [xix] and [xx] above include a face 814 that is fixed to the lower roof beam, said face (abbreviated as “overlap face—814”) being formed by winding overlapping portions of the remaining faces that abut adjacent columns and the back surface of the upper roof beam. Although the vertex portion of said overlap plane 814 is transformed into a bevel to form a pentagonal plane, it is possible to leave said overlap plane 814 as a square plane and dig out the overlapping portion from the remaining faces. The double bracket 795, 796 referred to in [xxi] above includes a side 815 which is fixed to the bottom beam of the lower part, and said side (abbreviated as “borrowing side—815”) is formed to be a load-bearing structure by borrowing a certain portion of the remaining side which abuts the adjacent column and the back surface of the bottom beam of the upper part, but the shape of said borrowing side 815 is determined by considering the structural stability of said remaining side.

FIG. 36 illustrates the application of a main member joint bracket 760 for securing two main members, roof beam 210 and roof beam facia 340, which form the apex of a base frame roof surface.

Said main member joint bracket has the same shape and function as a roof beam-facia bracket applied to the ends of the roof beam and roof beam facia.

When a rack beam facia is integrated parallel to said roof beam and roof beam facia on top of said roof beam and roof beam facia to form a horizontal member (abbreviated as “outskirt member”) of the structure to finish the outer perimeter of said solar workpiece flat roof, the width of said main member joint bracket includes the entire width of said outskirt member.

Reference symbol A in the drawing shows a main member joint bracket 761 in the form of a single bracket applied to a main member joint connection means 760 for fixing a roof beam 210 and a roof beam facia 340 made of a single layer of main members having a curved rectangular cross-section. The main member joint bracket 761 is applied to the back surfaces of the two main members for fixation by an indirect connection method such as welding, self-drilling screw or bolt nut fastener. The specific geometry of said indirect fastening method is not shown in the drawings. In this regard, it is the same as in the preceding or following description.

reference symbol (b) in the drawing shows a main member joint connection means 760 for fixing a two-ply roof beam 211, 212 and a roof beam facia 341, 342 by attaching the backsides of two identical main members, with a planar bracket 761 sandwiched between the two-ply main members, and a curved bracket 762 overlaid on the inner side of the two-ply main members.

Reference symbol (c) in the drawing shows that a curved bracket (763) is added to the outer side of the two-layer main member in addition to the main member joint connection means (760) of reference symbol (b) above and is fixed.

Said curved brackets 762, 763 are formed and applied according to the shape of the surfaces of the abutting main members.

These main member joint brackets are applied to a longitudinal connection of two main members at either contact, and include two rectangular planes based on the contact line where the two main members meet, one on the back of one side of the first main member (abbreviated as “primary rectangular plane”), The other is formed on the backside of one side of the secondary main member (abbreviated as “secondary rectangular plane”), each of said primary rectangular plane and secondary rectangular plane having a width of the main member on one side and a certain length on the other side, and the range of the angle of the plane formed by said primary rectangular plane and secondary rectangular plane is 180 degrees or less.

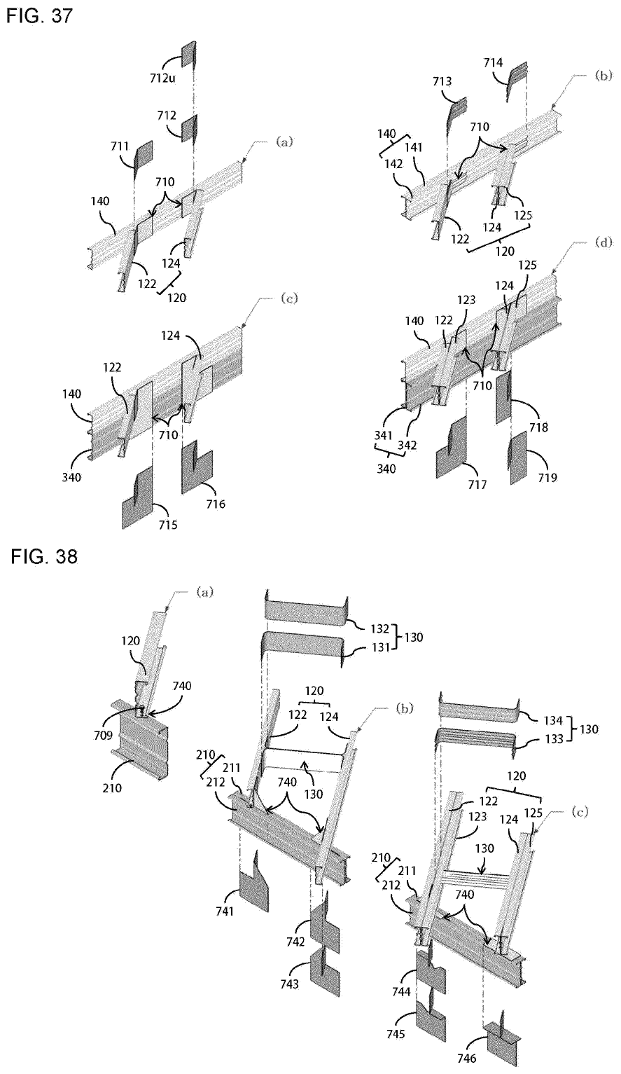

FIG. 37 illustrates the application of a rack beam-facia bracket 710 for securing a rack beam pair 120 and a rack beam face 140 that form the perimeter of a flat frame of a solar rack.

Rack beam-facia connection means 710 is formed so that said rack beam pair 120 is fixed to a single rack beam facia 140, or so that said rack beam facia 140 is fixed to a horizontal member (abbreviated as “outskirt member”) which is integral with said roof beam facia 340 and which forms the outer perimeter of said solar workpiece flat roof.

Reference symbol (a) in the drawing shows a single bracket type rack beam-facia bracket 711, 712 applied to the rack beam-facia connection means 710 for fixing the rack beam pair 120/122, 124 to the rack beam face 140, which is a single layer of main member having a curved oblong cross-section, respectively. Two rack beam-facia brackets 711, 712 are applied to the southern rack beam 122 and the northern rack beam 124, respectively, but they can be interchanged or applied to either of them alone, and a rack beam-facia bracket 712u is shown in which a portion bent at a certain (certain) angle has a curved surface with a certain (certain) (minimum) radius of curvature. The rack beam-facia bracket 711, 712, 712u is applied to the back surfaces of the two main members to be fixed by welding, self-drilling screws, or indirect fastening by bolt-nut fasteners.

Reference symbol (b) in the drawing shows a single bracket type (rack beam-facia bracket 713, 714) applied to the rack beam-facia connection means 710 for securing a single rack beam 122 and two rack beams 124, 125 to two layers of rack beam facia 140|141, 142. The (rack beam-FACIA BRACKETS 713, 714 are curved surfaces of the same format and are applied to the back surface of the one-ply southern rack beam 122 and the outer curved surface of the two-ply northern rack beam 124, 125, respectively.

Reference symbol (c) in the drawing shows a rack beam-facia bracket 715, 716 in the form of a single bracket applied to the rack beam-facia connection means 710 for securing the one-ply southern rack beam 122 and the northern rack beam 124 to the said outskirt member in which the one-ply rack beam facia 140 is integrated on the said roof beam facia 340. Two rack beam-facia brackets 715, 716 span the entire width of the outskirt member and can be interchangeable, or either can be applied to either side of the rack beam pair.

Reference symbol (d) in the drawing indicates that in reference symbol (c), said roof beam facia 340 of the outskirt member is made of two layers of horizontal members 341, 342, and the rack beam pair is formed of two layers of horizontal members, respectively, a southern rack beam) 122, 123) and northern rack beam 124, 125), and a rack beam-facia bracket applied to the rack beam-facia connection means 710 for securing the northern rack beam 124, 125, are shown in the form of a single bracket 717 and a double bracket 718, 719. Said single bracket 717 is secured between said southern rack beams 122, 123, and said double brackets 718, 719, both or one of which is inserted between said northern rack beams 124, 125.

Referring now to FIG. 38, the application of beam-beam superposition bracket 740 to secure rack beam pair 120, which forms the flat roof of the solar workpiece, to roof beam 210 and the reinforcement structure 130 of rack beam pair 120 is shown.

In accordance with the technical ideas of the embodiments of the invention, a base frame is formed from a plurality of elevation frames including roof beams 210 and columns, and a solar rack is formed by securing an inclined support member over rack beam pair 120, which is disposed in an east-west direction, wherein the flat roof of the solar workpiece formed by the installation of the solar rack on the said base frame becomes a load-bearing structure by fixing the rack beam pair 120 on the roof beam 210 with the beam-beam superposition connection means 740 to form a lattice structure in the form of #.

The beam-beam superposition connection means 740 is applied not only to fixing the roof beam and rack beam pair, but also to fixing other horizontal members, including roof beam facia, bracing beam and purlin, on one horizontal member, and includes an indirect connection with the plate bracket, beam-beam superposition bracket 740.

Reference symbol (a) in the drawing shows a rack beam pair 120 being secured with self-drilling screws 709 to a roof beam 210 or roof beam facia, each of which is a single main member having a curved rectangular cross-section. This beam-beam superposition connection means 740 by self-drilling screws 709 is applicable not only to two layers of main members, but also to intermediate parts of upper and lower horizontal members.

The reference symbol (b) in the drawing shows two types of beam-beam superposition bracket 740 applied to the beam-beam superposition connection means 740 for fixing a single-layer rack beam pair 120|122, 124 to two-layer roof beams 210|211, 212. Said beam-beam superposition bracket 740 can be applied in the form of single bracket 741 and double bracket 742, 743. When one of the double brackets 742, 743 is applied, it becomes a form of single bracket 741. A Vierendeel truss is formed by attaching an orthogonal cross strut for rack beam 130 at certain intervals between the rack beam pair 120 in one layer, so that it becomes a load bearing structure against buckling under horizontal load. Said cross strut for rack beam 130 is a plate fixture in the shape of E, wherein one or a pair thereof is connected between said rack beam pair 120 by fastening means such as a self-drilling screw in a straight line, and said pair of cross struts for rack beam 130 is formed by fixing them face to face.

Reference symbol (c) in the drawing shows a beam-beam superposition bracket 740 in the form of a double bracket 744, 745 and a single bracket 746 applied to the two-layered roof beam 210|211, 212 of the rack beam pair 120|122, 123&124, 125 in reference symbol (b) above. The double brackets 744, 745 are formed by cutting and bending a single flat plate, one of which may be optionally applied. The single bracket 746 on the right is shown to be formed by cutting and welding a flat plate. Said cross strut for rack beam 130, which is applied between said rack beam pair 120 of two layers each having a curved rectangular cross-section, is formed as a plate fixture with a L-shaped surface.

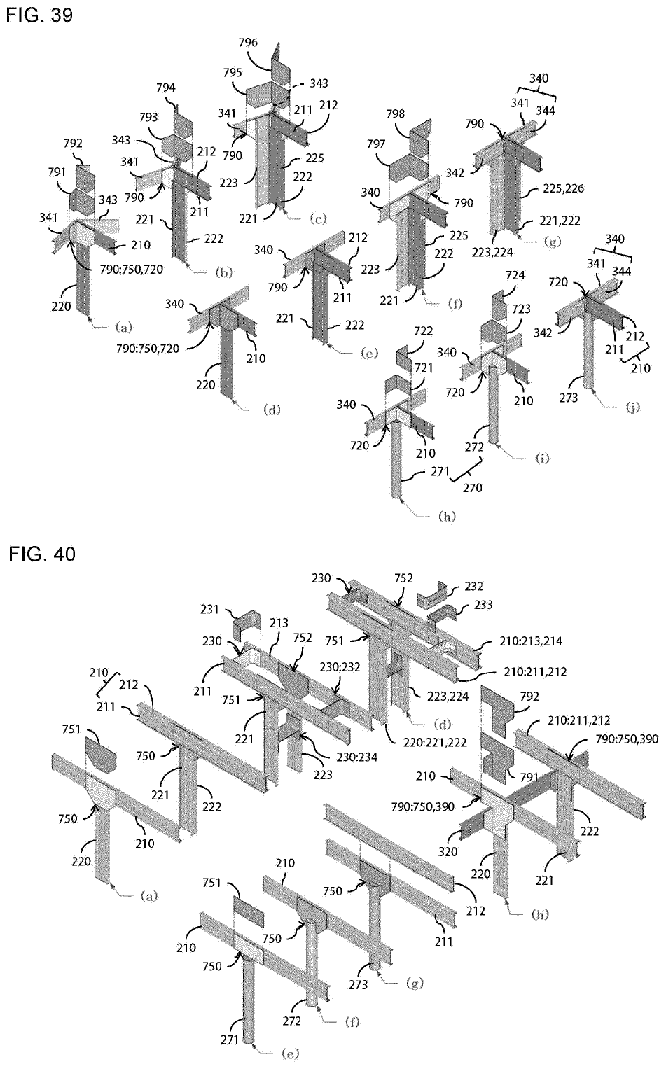

In FIG. 39 illustrates the application of a combined connection bracket 790 incorporating a column-beam bracket 750 for fastening a column and a roof beam of an elevation frame forming the apex or side of a base frame roof surface, and a roof beam-facia bracket 380 for finishing the ends of said roof beam with a roof beam facia, and the coupling of the main member to another column 270.

In the formation of said polygonal vertex, reference symbols (a), (b) & (c) in the drawings show a column-beam connection means 750 for securing a column 220 of a main member and a roof beam 210 in one layer, and a combined connection means 790 for securing a roof beam-facia connection means 380 at the end of a roof beam 210 with two roof beam faces 341, 343 forming a convex vertex of a polygonal plane. The combined connection means 790, which is a plate bracket applied to the combined connection means, is in the form of a double bracket 791, 792 and is fixed in an indirect connection method by welding, a self-drilling screw or a bolt-nut fastener to the associated main member, column 220, abutting the back surface of roof beam 210 and roof beam facia 341, 343.

Reference symbol (b) in the drawing shows a combined connection means 790, which integrates a column-beam connection means for fixing a column 221, 222 and a roof beam 211, 212 in two layers of a main member, and a roof beam-facia connection means for fixing an end of a roof beam 210 with two roof beam fascia 341, 343 in one layer forming a concave vertex of a polygonal plane. The combined connection means 790, which is a plate bracket applied to said combined connection means, is in the form of a double bracket 793, 794, which abuts the back surface of said roof beam fascia 341, 343 and is inserted and fixed between each of the two layers of column 221, 222 and roof beam 211, 212.

Reference symbol (c) in the drawing shows a combined connection means 790 which integrates the column-beam connection means and the roof beam-facia connection means into a single column by adding a column 223, 255 to the back surface of the two roof beam facias 341, 343 of the one layer forming the concave vertex of the polygonal plane in reference symbol (b) and integrating it into a single column in addition to the two existing columns 221, 222. The combined connection means 790, which is a plate bracket applied to said combined connection means, is in the form of a double bracket 795, 796, which abuts the back side of the column 223, 225 attached to the roof beam facia 341, 343, and is inserted and fixed between each of the two layers of column 221, 222 and roof beam 211, 212.

Reference symbols (d), (e), (f) & (g) in the drawings relate to the formation of a base frame with an elevation frame located at a midpoint of one side of said polygonal plane, reference symbol (d) shows the application of a combined connection means 790, which is a plate bracket, integrating a column-beam connection means 750 for securing a roof beam 210 with a column 220 of an elevation frame made of one main member and a roof beam-facia connection means 380 for securing an end of the roof beam 210 with one roof beam facia 340 forming a side of the polygonal plane. Reference symbol (e) shows the column 221, 222 and roof beam 211, 212 of reference symbol (d) formed as a two-layer main member. Reference symbol (f) shows a double bracket 797, 798 type, which is a combined connection means 790 of plate brackets that integrates a column-beam connection means and a roof beam-facia connection means into a single column by adding a column 223, 255 to the back side of the roof beam facia 340 by attaching it to the column 221, 222 of reference symbol (e).

The combined connection means 790 of the above reference symbols (d), (e) & (f) are formed in the shape of a plate bracket similar to the above reference symbols (a), (b) & (c), respectively, and are fixed by an indirect connection method. The reference symbol (g) is a two-layer reinforcement of the one-layer main member in the reference symbol (f), and the two layers of the main member are integrated with their respective back surfaces. The application of a combined connection bracket 790, a plate bracket, in which two layers of columns 223, 224&225, 226 are placed on either side of the existing column 221, 222 to form a single column by adding another horizontal member 342, 344 to the back side of the roof beam facia 340|341 to integrate them into one.

Reference symbols (h), (i) & (j) in the drawing show that roof beam-facia connection means 380, to which roof beam 210 is fixed at a middle portion of roof beam facia 340, one side of said polygonal plane, is fixed on top of main member and column 270, which are of different shapes, so that an elevation frame is formed, and a base frame is made. The roof beam-facia connection means 380 is in the form of double brackets 381, 722&723, 724 of a plate bracket, and the reference symbol (h) is to fix the roof beam 210 and the roof beam face 340 with the said double brackets 381, 722, and to support and fix them on the said horizontal members 210, 340 and the cylindrical column 2701271, which are different main members, and reference symbol (i) is to fix roof beam 210 and roof beam facia 340 with said double bracket 723, 724, in which the plate bracket extends below said horizontal member, and to fix it by fitting the extended part thereof into cylindrical column 270271). Reference symbol (j) is a reinforcement of the one-ply main member in reference symbol (i) with two layers, and the two layers of the main member are integrated with their respective back surfaces.

FIG. 40 illustrates the application of a column-beam bracket 750 for fixing at an intermediate part of a column and a roof beam of an elevation frame so that the flat roof of the solar workpiece can have an eave, and the combination of said column and roof beam for conversion into a load-bearing structure.

The reference symbols (a) & (b) in the drawings relate to the formation of said elevation frame, in which horizontal member 210 and vertical member 220, which are main members having a curved rectangular cross-section, are fixed by column-beam connection means 750, wherein reference symbol (a) shows the application of the column-beam bracket 750, which is a plate bracket, in the form of a single bracket 751, to the fixing of beams 210 and column 220 made of one layer of main members, and reference symbol (b) shows the application of said column-beam bracket 750 to the fixing of beams 210|211, 212 and column 221, 222 made of two layers by adding one layer of main members each to the main members of reference symbol (a).

Reference symbols (c) & (d) in the drawings illustrate the formation of elevation frames that become long span members of compound structures in pairs (abbreviated as -compound member pairs|) by adding one or two more adjacent main members, as described above in FIGS. 9 and 10, respectively. Reference symbol (c) shows two elevation frames having two roof beams 211, 213 and column 221, 223 secured with column-beam brackets 751, 752, respectively, located adjacent to each other to form a planar cross strut between said compound member pair for main member 2301231, 232, 233, 234, and reference symbol (d) is a curved cross strut for main member 230|232, 233 between the two overlapping roof beams 210|211, 212 & 213, 214 and column 220|221, 222 & 223, 224 fixed with column-beam bracket 751, 752, respectively, as described in the foregoing FIGS. 9 and 10, said cross strut for main member 230231, 232, 233, 234, which is a plate fixture in the shape of E, is fixed with fastening means such as a self-drilling screw between the compound member pair 210, 220 in a straight line in order to form a load-bearing structure against buckling in response to a horizontal load.

Reference symbols (e), (f) & (g) in the drawings show a form in which a section of a roof beam 210212, 212 made of a main member having a curved oblong cross-section is supported and fixed by cylindrical columns 271, 272, 273, as in the application of cylindrical columns different from the main member described above in FIG. 39. Reference symbol (e) shows a form in which a column-beam bracket 750, a plate bracket of a square plane, is attached to a roof beam 210, which is a main member in one layer, in the form of a single bracket 751, and supported and fixed by a cylindrical column 271, reference symbol (f) is to protrude the lower part of the square-planar plate bracket of reference symbol (e) to form a hexagonal-planar column-beam bracket 750 that is attached to the roof beam 210, and to support and fix the lower part thereof with a cylindrical column 272. Reference symbol (G) is to fix column-beam bracket 750 in the same form as reference symbol (f) between two layers of roof beam 211, 212 and fix it to a cylindrical column 273).

The reference symbol (H) in the drawing is for fixing a column 220|221, 212 at a portion of a roof beam 210|212, 212, which is a main member having a curved rectangular cross-section, and for attaching a purlin 320 to the top of the column 220 just below said roof beam 210, by integrating the adjacent plate brackets, column-beam bracket 750 and column-purlin bracket 390, into a single combined connection bracket 790 in the form of a double bracket 791, 792 in the form of a double bracket 791, 792, wherein the left side shows the structure applied to a single layer of main member, roof beam 210 and column 220, and the right side shows the structure applied to two layers of roof beam 210|211, 212 and column 221, 221. The purlin 320 is also cut to a suitable length, and by adding another layer, the base frame becomes a load bearing structure.

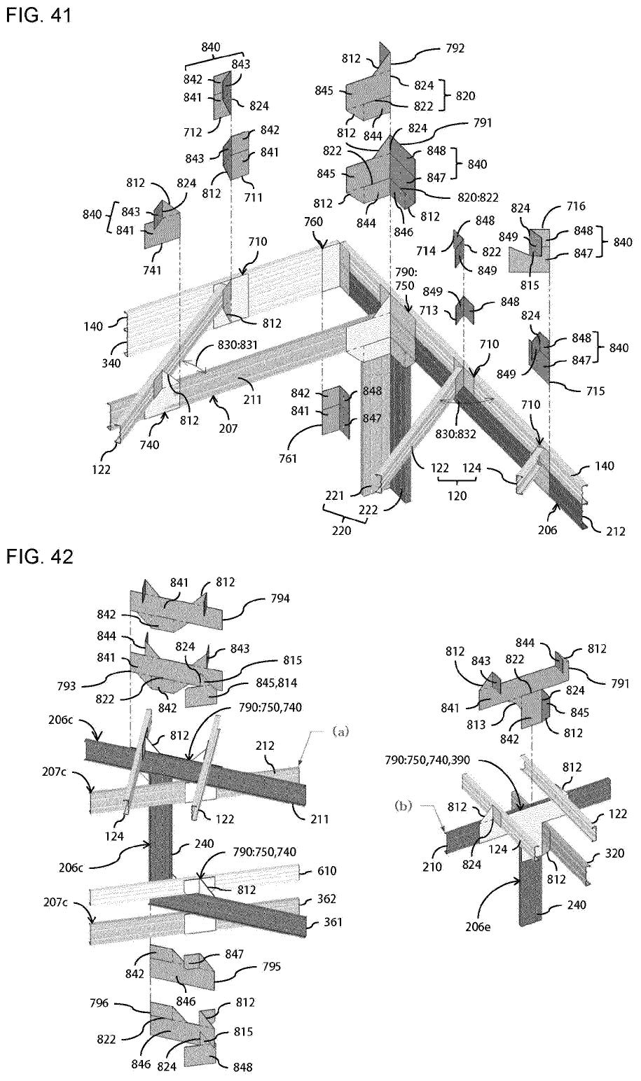

FIG. 41 illustrates the shape of a plate bracket that is cut and bent into a single flat plate without an attachment process such as welding in accordance with the technical idea of the present invention, and a beam-beam superposition bracket applied to a corner of the base frame as a cross-sectional frame 206 and a side wall frame 207 having eaves in the description of FIG. 3 above, a rack beam-facia bracket, a main member joint bracket and a column-beam bracket, and a plate bracket formed as a combined connection bracket.

The plate bracket is formed according to the shape of the connection part of the main member, and the basic shape of the plate bracket includes a contact line 820, a contact angle 830, and two contact surfaces 840, wherein the contact line 820 is a reference line at which the back surfaces of the two main members meet, and the contact angle 830 is an angle at which the two main members meet, comprising an acute angle on one side and an obtuse angle on the other side, said two contact surfaces 840 are rectangular planes in contact with the back surfaces of the two main members, said rectangular planes comprising one side of the width of the back surfaces of the main members and the other side of a corresponding length, each pair having an inwardly concave outer side of one vertex of said union of the two contact surfaces, supplemented by a triangular plane having an inclined side 812.

From left, a first beam-beam superposition bracket 740 is shown in the form of a single bracket 741, which is applied to a connection at one of the contact surfaces where one horizontal member, a first main member roof beam 211, is crossed over another horizontal member, a second main member southern rack beam 122, in a layered framing arrangement, wherein said primary main member of one of said two horizontal members includes one (long) rectangular face 841 (abbreviated as “primary rectangular face”) centered on said contact line 820 on the back of said main member, another (shorter) rectangular face 843 (abbreviated as ‘secondary rectangular face’) on the backside of one side of the main member, centered on said contact line, and including a triangular plane with an inclined side 812 extending from the vertex of said primary rectangular face to connect with the end of the contact line of the secondary main member to form a hexagonal plane, wherein the secondary quadrangular face is bent at an acute angle 831 or obtuse angle at said contact angle 830 relative to the contact line of said hexagonal plane to form a single bracket 741, wherein each of said acute and obtuse angle bent single brackets may be formed as a double bracket by overlapping said hexagonal plane and placing the secondary quadrangular face in the same plane.

The second rack beam-facia bracket 710 on the left is in the form of a double bracket 711, 712, and one of the two types of rack beam-facia brackets 710 on the right is in the form of a double bracket 713, 714, and the other is in the form of a single bracket 715, 716. The ack beam-facia bracket 716 of the modified shape of the single bracket 715 is a triangular borrowing surface 815 added to form a load-bearing structure, which is rotated 60 degrees counterclockwise about the two dotted line axis for ease of understanding.

The rack beam-facia bracket 710 and the roof beam-facia bracket are applied to the connection of one contact of a first main member (rack beam facia 140 or roof beam facia 340), which is a horizontal member, to an end contact of a second main member (rack beam 120 or roof beam 211), which is another horizontal member, in a flush-framing manner, and include two rectangular planes based on said contact line, wherein a first rectangular plane 848 is formed on the backside of one side of the main member, and a second rectangular plane 849 is formed on the backside of the end of the second main member, wherein said secondary square faces are bent at an acute angle 832 or obtuse angle in the center of said contact angle 830 relative to the contact line of said primary square faces to form single brackets 713&714, said two single brackets having said primary square faces in the same plane and other said secondary square faces doubly overlapping to form a double bracket.

Wherein said rack beam facia 140 is formed as a horizontal member (abbreviated as “outskirt member”) to finish the perimeter of the roof surface of the base frame in an integral construction laid in a layered framing format over a roof beam facia 340, roof beam 212, or bracing beam, wherein said rack beam-facia bracket 710 or roof beam-facia bracket for connection of said rack beam 120 or roof beam 211 to said outskirt member also comprises a single bracket and a double bracket, wherein said single bracket is formed by said primary square faces 843&849 extending downwardly for rack beam 122 or upwardly for roof beam 211, including double faces 841, 842&847, 848 above and below said contact area of said rack beam facia and roof beam facia, further comprising a triangular plane including a sloping edge 812, wherein said secondary square faces are inclined to extend from a vertex outside said contact line to connect with a vertex across said contact line of said extended primary square faces 711&712, wherein said two single brackets are merged in the same manner as above in either or both applications to form said double brackets 711, 712, and wherein said one particular shaped single bracket 715 is formed by said primary square faces not only extending downward in the case of a rack beam or upward in the case of a roof beam, but also extending twice as far sideways past said contact line.

The main member joint bracket 760, which fixes the corner of the roof surface of the base frame located in the center of the drawing, is applied to the connection of said outskirt member with the main member joint connection means in the longitudinal direction in the form of a single bracket 761, forming a half-line on both sides. Said main member joint bracket 761 includes, on one side, a contact surface 841 contacting a back surface of the roof beam facia 340 and a contact surface 842 contacting a back surface of the rack beam facia 140 thereon, and, on the other side, a contact surface 847 contacting a back surface of the roof beam 212 and a contact surface 848 contacting a back surface of the rack beam facia 140 thereon. The solid lines shown within said main member joint bracket 761 are the contact lines of the associated main member 340, 240, 212.

In the center portion of the drawing, said cross-sectional frame 206 and side wall frame 207 are shown to share their respective columns 221, 222 as an integral part of a single structure, wherein a single combined connection bracket 790 is formed and applied in the form of a double bracket 791, 792 incorporating two column-beam brackets securing corresponding roof beams 211, 212 thereon. The solid lines shown in each of said combined connection bracket 791, 792 are contact lines between the associated main members 221, 222, 211, 212, 140, and the dashed lines show the outline of said main members. Said combined connection bracket 7901791, 792 is formed with a rectangular contact surface 844, 846, 845, 847, 848 tangent to the back surface of each of said associated main members, and a triangular surface having an inclined side 812 including one vertex of said contact surface.

The rectangular contact surface 840 is formed by extending the back surfaces of the associated main members, when they are in the same plane, longitudinally and extending outwardly a certain length of each side of the overlapping rectangular surface that does not include the end of the back surface, When the back surfaces of the associated main members intersect at a certain contact angle 830, a rectangular face is formed with two transverse sides of a certain length and two longitudinal sides of the width of the main member, based on the contact line or a straight line through the contact point. A triangular plane including said inclined sides 812 is formed by a plane not tangent to the back surface of the main member, extending from two adjacent vertices of said rectangular plane or from one vertex to a certain point.

The plate bracket comprising the two rectangular faces and the triangular plane having said contact angle 830 is designed to be a load bearing structure when cut and bent into a single flat plate and applied as a connection means of the associated main member.

Although the combined connection bracket 790 is shown in the form of a double bracket 791, 792, either of the two brackets can be used as a single bracket 791|792 as a connection means for the associated main member. Using the single bracket 791 on the inside of the base frame as an example, a column-beam bracket connecting the end of the roof beam 211 of the side wall frame 207 to the column 221 and a column-beam bracket connecting the end of the roof beam 212 of the cross-sectional frame 206 to the column 222 are attached, so the two are merged into one based on the vertical contact line 820 on the back of the related main member. Said two column-beam brackets are integral with rack beam face 140 on roof beam 212 of said cross-sectional frame 206 to include a triangular plane with contact surfaces 844, 845, 846, 847, 848 and slopes 812 that encompass said outskirt member of said base frame roof surface.

By subtracting column 221 from said side wall frame 207 and simply adding roof beam 211, said roof beam functions as a bracing beam, and said bracing beam is applied to roof beam 212 of said cross-sectional frame 206 as a main member joint bracket or as a column-beam bracket having a certain contact angle with said column 222.

FIG. 42 illustrates the shape of a plate bracket for connection of a plurality of beams and columns according to embodiments of the invention, wherein (a) the cross-sectional frame 206c having eaves in the description of FIG. 29 above is shown as a combined connection bracket 793, 794, 795, 796 applied to a base frame supported by a side wall frame 207c, rotated 180 degrees in a plane for better understanding, and (b) the cross-sectional frame 206c having eaves in the description of FIG. 25 above is shown as a combined connection bracket. 25 as applied as combined connection bracket 791 to the overlay fixing of purlin 320 on top of column 240 supporting roof beam 210 in cross-sectional frame 206e having eaves, wherein plate bracket 793, 794, 791 is in the form of a merger of beam-beam superposition bracket 740 fixing rack beam pair 122, 124 on top of roof beam 211, 210.

The combined connection bracket at the top of reference symbol (a) in the drawing is in the form of a double bracket 793, 794, in which one column-beam bracket 750 and three beam-beam superposition bracket 740 are merged. Said column-beam bracket 750 is applied to the connection of roof beam 211 of cross-sectional frame 206c and column 240, and one of said three beam-beam superposition bracket 740 is applied to fix said roof beam 211 by supporting it with roof beam 212 of side frame 207c, and the other two beam-beam superposition bracket 740 are applied to fix rack beam pair 122, 124 above said roof beam 211 of cross-sectional frame 206c. Application of only one of said double brackets 793, 794 does not interfere with the connection of the associated main members 211, 240, 212, 122, 124, but both may be applied and the two roof beams 211, 212 and column 240, which are main members, may be reinforced with two layers of main members by attaching one more layer to the back of each.

At the bottom of the reference symbol A in the drawing, a combined connection bracket is in the form of a double bracket 795, 796 in which one column-beam bracket 750 and two beam-beam superposition bracket 740 are merged. Said column-beam bracket 750 is applied to the connection of bottom beam 361 of cross-sectional frame 206c and column 240, and one of said two beam-beam superposition bracket 740 is fixed by supporting said bottom beam 361 with bottom beam 362 of side frame 207c, and the other is fixed with long horizontal member 610, a railing horizontal member, on said bottom beam 361. Said handrail horizontal member is integrated into said side frame 207c so that it becomes a vertical load bearing structure. Application of only one of said double brackets 795, 796 will not interfere with the connection of the associated main members 240, 361, 362, 610, but both may be applied and the two bottom beams 361, 362 and column 240 may be strengthened into two layers of main members by attaching one more layer to each of their respective backs.

The solid lines shown in each of said four combined connection brackets 793, 794, 795, 796 are contact lines between said associated main members 211, 240, 122, 124, 212, 361, 610, 362, and the dashed lines show the outline of said main members, A rectangular contact surface 841, 842, 843, 844, 845, 846, 847, 848 tangent to the back surface of each of said associated main members is formed, and a triangular plane having an inwardly concave outer vertex of the union of said contact surfaces is added as an inclined surface 812. The triangular plane including the inclined surface 812 is formed by extending the contact surface outwardly so that the plate bracket becomes a load-bearing structure, and the application of a two-layer main member is contemplated.

In the two combined connection brackets 793, 796 for connection of both associated main members, the triangular plane added to the contact surface 845, 848, which is the surface abutting the lower horizontal member 212, 362, is formed by a borrowing surface 815 borrowing from another adjacent contact surface 841, 846. The bottom contact surface 845 of the top-positioned combined connection bracket 793 also becomes an overlap surface 814 that overlaps the adjacent triangular planes. The shape of the overlapping surface 814 and the borrowing surface 815 is considered and determined to be a load bearing structure.

Reference symbol (b) in the drawing is a combined connection bracket 791 in the form of a single bracket, in which one column-beam bracket 750, a column-purlin bracket 390, and two beam-beam superposition bracket 740 are merged. Said combined connection bracket 791 has square planar contact surfaces 841, 842, 843, 844, 845 corresponding to the associated main members 210, 240, 124, 122, 320, and includes a horizontal contact line 822 and a perpendicular contact line 824 as contact lines with which the back surfaces of said main members are in contact, further comprising a triangular plane having a inclined surface 812 or a curved side 813 with an outer stool of one vertex concave inwardly to the union of said contact surfaces. The curved side 813 is simply in accordance with the shape of the floating body, which is another component added to the base frame, and is not intended to limit the technical ideas of the embodiments of the invention.

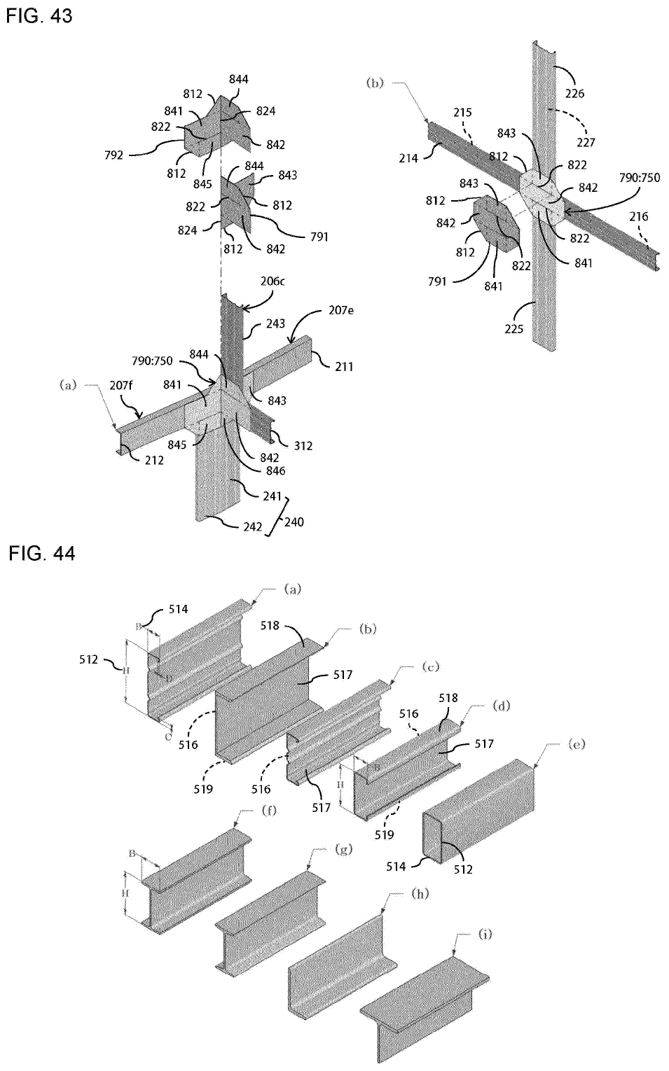

FIG. 43 illustrates an exemplary shape of a plate bracket for cross-connection of columns and beams, (a) showing a platform framing method applied to a multistory building type base frame referred to in the description of FIG. 13 above, rotated 180 degrees in a plane for convenience, and (b) showing a balloon framing method applied to the orthogonal connection of beams and columns.

The rack beam-facia connection means and the roof beam-facia connection means are respectively based on the above flush framing method of the two horizontal members, and the beam-beam superposition connection means is based on the above layered framing method of the two horizontal members, The column-beam connection means and the column-purlin connection means form a base frame by connecting the columns, which are vertical members, and the beams and purlins, which are horizontal members, wherein the connection of the columns and beams takes the form of platform framing and the connection of the beams and purlins takes the form of balloon framing.

The combined connection bracket 790 of reference symbol (a) in the drawing is a merged form of three column-beam brackets 750 in the form of a double bracket 791, 792. One of the three column-beam brackets 750 is applied to column 241 and roof beam 211 of side wall frame 207e, another to column 242 and roof beam 212 of side wall frame 207f, and the third to column 243 of cross-sectional frame 206c and bracing beam 312 of the lower floor. Both plate brackets 791, 792 are required for the anchoring of said three elevation frames 207e, 207f, 206c by integrating said columns 241, 242 and sharing them as one column 240 and adding another column 243 on top of it, and are allowed to become a load bearing structure with two layers of main members by adding one layer to each of the associated main members.

A contact surface 841, 842, 843, 844, 845, 846 in said combined connection bracket 7901791, 792 abuts a corresponding associated main member 212, 312, 211, 243, 242, 241 back surface, wherein said back surface includes a horizontal contact line 822 and a perpendicular contact line 824 as tangential contact lines, and wherein a triangular plane is added having an inwardly concave one vertex of the union of said contact lines as a sloping side 812.

The combined connection bracket 790 of reference symbol (b) in the drawings is a merger of two column-beam brackets 750 in the form of a single bracket 791. One of said two column-beam brackets 750 is applied to fixing a column 255 and a roof beam 214, and the other is applied to fixing said roof beam 214 and another column 226. Said roof beam 214 is fixed with the two column 225, 226 butted together so as to be orthogonal to the same plane in the middle part. The orthogonal form of the load bearing structure is completed by adding one column 227) and two roof beams 215, 216 as a single layer of main members on the back of the related main members 225, 214, 226.

The contact surfaces 841, 842, 843 in said combined connection bracket 7901791 abut the corresponding associated main member 225, 214, 226 back surfaces, and include a horizontal contact line 822 as a contact line along which said back surfaces abut, and a triangular plane with an inclined edge 812 is added connecting one contact surface to a nearby vertex of the other contact surface in said contact surfaces 841, 842, 843.

FIG. 44 illustrates a typical shape of a main member applicable to embodiments of the invention.

The main member includes the following features with respect to materials, processes, and shapes, wherein the material of the main member includes one or more of metals, synthetic resins, and composite materials, and the forming process of the main member includes one or more of a cold or hot roll forming process, an extrusion process, a pultrusion process, and a composite material manufacturing process, wherein the cross-sectional shape of said main member includes one or more of E-shape, C-shape (channels), -shape, H-shape, I-shape, L-shape (i.e., angles), and T-shape, and said main member is formed with a single said cross-sectional shape or, further comprising a horizontal member and a vertical member having mixed said cross-sectional shapes, and further comprising a composite member formed by merging two or more said main members by welding or by self-drilling screws or bolt-nut fasteners.

In the drawings, reference symbols (a) & (c) show a horizontal or vertical long span member having a rectangular section with a specific shape, wherein (b) is L-shaped, (d) is C-shaped (channels), and (e) is-shaped. Said rectangular section is a rectangular plane formed by a long side 512 of height H and a short side 514 of width B, wherein the side including said long side 512 comprises a backside 516 and a frontside 517, and the side including said short side 514 comprises an upper side 518 and a lower side 519. Said backside 516 of said rectangular cross-section is a closed side, and said frontside 517 is an open side. The main member of the above rectangular section can be applied as a horizontal member or a vertical member in one layer, but in order to form a load-bearing structure, the same or similar main member can be added in one more layer, and the two layers can be fixed together by welding, self-drilling screw, or direct connection by bolt nut fastener to form a single two-layer long span member.

Included in the main member other than the above rectangular cross-section is a long span member having the cross-sectional shape of the H-shape of reference symbol (f), the I-shape of reference symbol (g), the L-shape (i.e., angles) of reference symbol (h), and the T-shape of reference symbol (i) in the drawings. In addition to the above main member, the long span member may further include a cylindrical column and a square tube pillar, and the long span member may be formed from a composite main member formed by merging two or more of the above main members by welding, self-drilling screw, or bolt nut fastener.

The main members of the above rectangular cross-sectional shapes (a), (b), (c), (d) & (e) are applied as general horizontal members and vertical members of the base frame according to the embodiments of the invention, the remaining cross-sectional shapes (f), (g), (h) & (i), cylindrical columns, prismatic columns, and composite main members are applied to bracing beams, purlins, columns, etc. of said base frame.

Reference symbols (a) & (c) in the drawings with the above specific shapes show a main member having a specific rectangular cross-sectional shape, said rectangular cross-section including one long side (H) 512, 516 and two short sides (B) 514, 518, 519, said long side having a backside 516, wherein said short side 514 on either side thereof is bent to project at right angles respectively to form two flanks 1518, 519, whereby said rectangular cross-section is E-shaped, and said two short side ends include a flange (c) and an end (d) respectively, said flange being bent at right angles from said short side ends and parallel to the long side, wherein said rectangular cross-section is C-shaped, and said end is again bent inwardly at a right angle from said flange end to form a frontal side, wherein the corner formed between said long side, short side, flange and end comprises a rounded shape with a certain radius of curvature, wherein said long side includes two pairs of convex depressions of different depths inwardly, said depressions including a lesser depression and a greater depression, said lesser depression and greater depression being spaced at a certain interval and formed symmetrically on each side inwardly from the end of said long side.

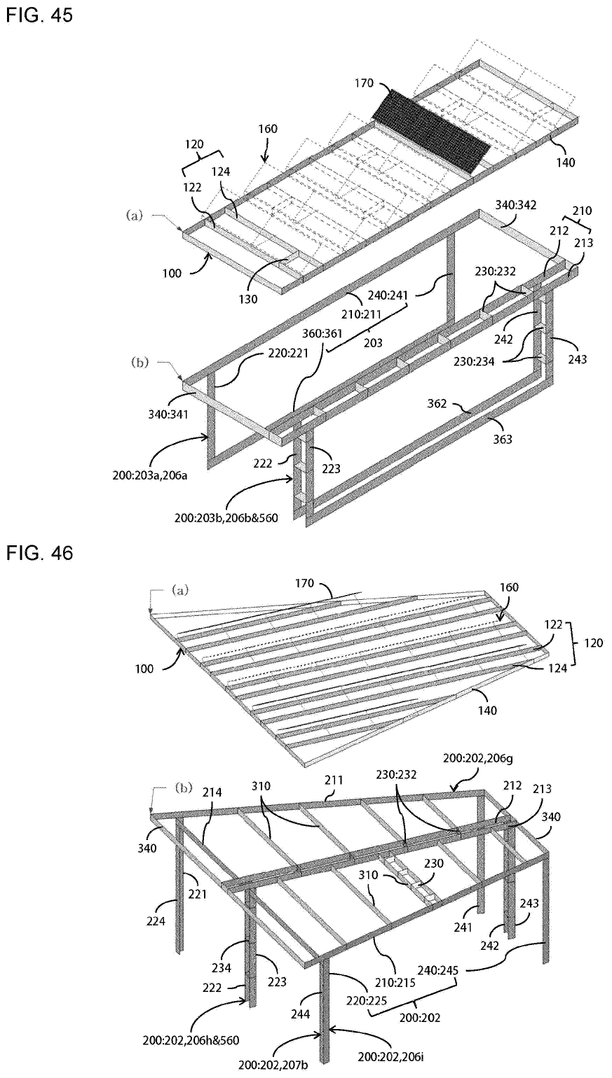

FIG. 45 is an exploded view of a solar workpiece in which the rack beam pair 120 of the solar rack 100 and the roof beam 210 of the elevation frame 206a, 206b are nearly orthogonal.

In accordance with the technical ideas of the embodiments of the invention, the solar panel 170 is installed at a predetermined value of a suitable orientation and inclination angle, which is a north latitude inclination angle facing south for a northern hemisphere region or a south latitude inclination angle facing north for a southern hemisphere region. Accordingly, the rack beam pair 120|122, 124 are arranged parallel to each other at certain intervals in the east-west direction, an inclined support member 160 having the said inclination angle is fixed on the said rack beam pair 120, and the solar panel 170 is installed on the said inclined support member. The space between said rack beam pair 120 is fixed with a cross strut for rack beam 130, the end of which is finished with a rack beam face 140, so that said solar rack 100 is formed as a load-bearing structure.

In the drawings, reference symbol (a) show said solar rack 100, and (b) show a base frame supporting said solar rack 100. Said base frame is formed by an elevation frame 200 having eaves on both sides, and said elevation frame is two cross-sectional frames 206a&206b in the form of box frames 203a&203b. The cross-sectional frame 206a on the left is a main member integrated in one or two layers, and the box frame 203A is formed by the column 221, 241, roof beam 211 and bottom beam 361 on both sides, cross-sectional frame 206B on the right side is formed with two columns 222, 223&242, 243, two roof beams 212 & 213 and two bottom beams 362&363 on both sides, which are compound member pairs 560, by placing the same main members at certain intervals and fixing them between them with cross strut for main member 230|232, 234, so that box frame 203b is formed.

Terminating the ends of said roof beam 210|211, 212, 213 with roof beam facia 340|341, 342, wherein a rack beam facia 140 is integrated parallel to said roof beam facia 340 and roof beam 210 to form a horizontal member (abbreviated as “outskirt member”) of the structure finishing the outer perimeter of the flat roof of said solar workpiece, so that said base frame is strengthened as a load-bearing structure by means of said outskirt member.

Said solar workpiece illustrates a solar rack 100 being applied to a location where it can have a suitable orientation and inclination angle, wherein a rack beam pair 120 of said solar rack rests on a roof beam 210 of said base frame and is fixed in a layered framing format, whereas, the flat roof of the solar workpiece formed by said rack beams 122, 124 and roof beam 210 becomes a lattice structure in the form of #, and furthermore, by fixing said inclined support member 160 on said rack beam pair 120, said flat roof becomes a load-bearing structure.

FIG. 46 is a top-to-bottom exploded view of a conceptual solar workpiece in which the rack beam pair 120 of the solar rack 100 and the roof beam 340 of the elevation frames 206a, 206b are placed substantially parallel. The solar workpiece is illustrated with reference to the description of FIGS. 19 and 22 above, and is rotated through a certain angle in the plane for ease of reading.

According to the technical idea of the embodiments of the invention, as the solar panel 170 is installed with a suitable orientation and inclination angle, the rack beam pair 120|122, 124 are arranged in parallel at certain intervals in the east-west direction, and the inclined support member 160 is fixed thereon, the ends of which are finished with a rack beam face 140, so that the solar rack 100 is formed as a load-bearing structure.

In the drawings, reference symbol (a) show the solar rack 100, and (b) show a base frame supporting the solar rack 100. Said base frame is formed by an elevation frame 200 having an eave on one side, said elevation frame being three cross-sectional frames 206g, 206h&206i in the form of a portal frame 202 and one side wall frame 207b. The cross-sectional frame 206g&206i on the left and right sides are main members integrated in one or two layers, and the portal frame 202 is formed by the column 221, 241&225, 245 and the roof beam 211&215 on both sides, The cross-sectional frame 206h in the center is formed from two columns 222, 242 & 223, 243 and two roof beams 212 & 213 on both sides, which are compound member pair 560, by placing the same main member at a certain interval and fixing the same between them with a cross strut for main member 230|232, 234, so that the portal frame 202 is formed.

Each end of said roof beams 210|211, 212, 213, 214 is terminated with a roof beam facia 340, wherein a rack beam facia 140 is integrated parallel to said roof beam facia 340 and roof beam 210 to form a horizontal member (abbreviated as “outskirt member”) of the structure finishing the outer perimeter of the flat roof of said solar workpiece, so that said base frame is strengthened as a load-bearing structure by means of said outskirt member.

A side wall frame 207b located at the front forms a portal frame 202 with columns 224, 244 on both sides and a roof beam 214, wherein said roof beam 214 is attached to the top of side columns 221, 222, 223&225 having eaves of other cross-sectional frames 206g, 206h&206i to become a structure supporting respective roof beams 211, 212, 213&215, thereby strengthening said solar workpiece. When only roof beam 214 is applied to said side wall frame 207b without columns 224, 244 on either side, said roof beam becomes a purlin forming a base frame.

As said rack beam pair 120 is arranged in approximately the same direction as the three cross-sectional frames 206g, 206h&206i, a plurality of bracing beams 310 are arranged at certain intervals in the same plane between the roof beams 211, 212 & 213, 215 of said cross-sectional frames as a supporting structure, wherein the flat roof formed by fixing said rack beams 122, 124 above said multiple bracing beams 310 becomes a lattice structure in the form of #, and said solar workpiece becomes a load-bearing structure. Also, by applying the compound member pair 560 applied to the main member of the center cross-sectional frame 206h to the bracing beam 310, the solar workpiece is expected to be strengthened against loads.

### Embodiment 7

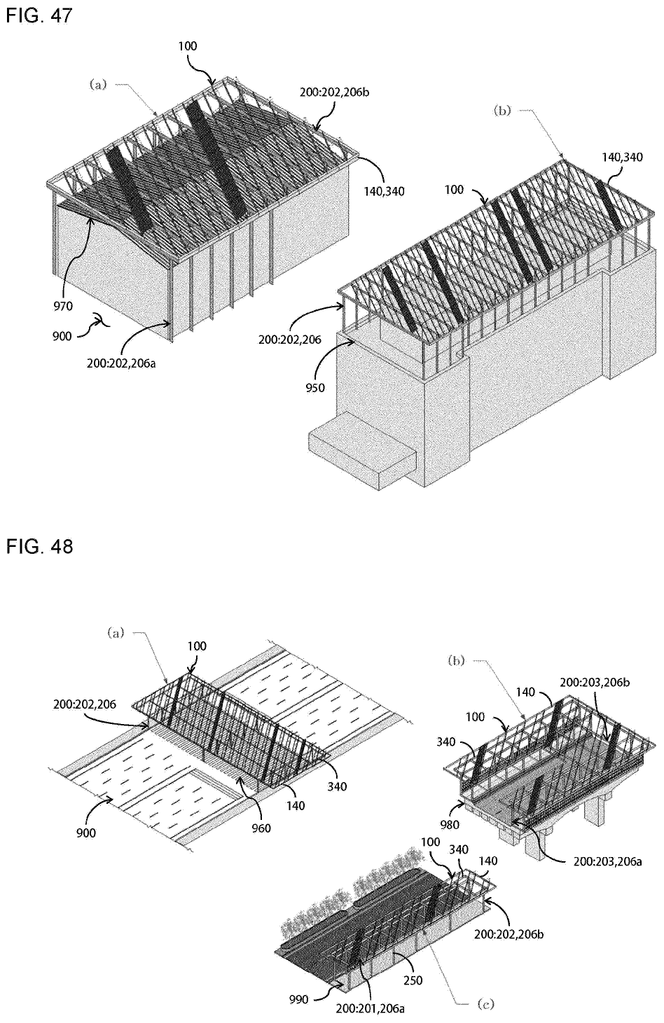

FIG. 47 illustrates Example 7, which is applicable to a building structure according to embodiments of the invention, conceptually illustrating a multipurpose solar energy system formed by a solar workpiece on a building rooftop 950 of reference symbol (a) and a building roof 970 of reference symbol (b).

Reference symbol (a) in the drawings relates to the application of a multipurpose solar energy system having a solar workpiece with a flat roof on a roof of various types, including a gable roof 970 of a building, such as a warehouse, factory, or workshop, to produce solar energy that does not interfere with the original use of the subspace.

Across said building roof 970, cross sectional frames 206a, 206b in the form of portal frame 202, which may or may not be having an eave with elevation frame 200, are spaced at certain intervals to be secured over the earth's surface 900 or building roof 970. The cross-sectional frame 206a fixed on the earth's surface 900 and the cross-sectional frame 206b fixed on the building roof 970 are selectively applied according to the load-bearing state of the building roof or other conditions. By adding one or more columns supporting the intermediate parts of the roof beams of said cross-sectional frame 206a, 206B, the effect of distributing the load of the roof beams can be expected.

The end of the roof beam of the portal frame 202 covering the roof of the building 970 is finished with a roof beam facia 340 to form the roof surface perimeter of the base frame, and in fixing the solar rack 100 thereon, the rack beam facia 140 is integrated with the roof beam facia 340 or roof beam of the flat roof perimeter to form a load-bearing structure to strengthen the solar workpiece.

Reference symbol (b) in the drawings relates to the application of a multipurpose solar energy system for further utilization of the subspace and production of solar energy by adding the solar workpiece to the rooftop 950 of an apartment or office building. Cross-sectional frames 206 in the form of portal frames 202, which may or may not be having eaves with elevation frames 200 along the perimeter of said building rooftop 950, are placed and secured at certain intervals across said subspace. The height of said elevation frame 200 is set higher than the height of any doorways or facilities for ventilation and air conditioning present on said building rooftop 950 so that a flat roof of the solar workpiece is formed.

The roof beam ends of said cross-sectional frame 206 are finished with roof beam facia 340 to form the roof surface perimeter of the base frame, and in fixing the solar rack 100 thereon, the rack beam facia 140 is integrated with the roof beam facia 340 or roof beam of said flat roof perimeter to form a load-bearing structure to strengthen said solar workpiece.

### Embodiment 8

FIG. 48 is an embodiment 8 applied to civil structures according to embodiments of the invention, conceptually illustrating a multipurpose solar energy system formed by a solar workpiece over a crosswalk 960 of reference symbol (a), a bridge 980 of reference symbol (b) and a sidewalk 990 of reference symbol (c).

Reference symbol (a) in the drawings relates to the application of a multipurpose solar energy system for the production of solar energy by adding a solar workpiece above a crosswalk 960 constructed on a roadway 900 such that the subspace remains utilized as a pedestrian walkway. Cross sectional frames 206 in the form of portal frames 202, which are elongate and have eaves with a plurality of elevation frames 200 in the longitudinal direction of said crosswalk 960 and have columns added in the middle, are placed and fixed at certain intervals across said subspace. The crosswalk 960 is constructed in accordance with the “Rules for Determination, Structure and Installation Standards of Urban and County Planning Facilities” (abbreviated as “Rules for Installation Standards of Urban Planning Facilities”), and the scale of the solar workpiece, including the height of the elevation frame 200 applied thereto, is as stipulated in the “Rules for Structure and Facility Standards of Roads” (abbreviated as “Road Structure Rules”).

The roof beam end of the cross-sectional frame 206 applied to the above crosswalk 960 is finished with a roof beam facia 340 to form the roof surface outline of the base frame, in securing the solar rack 100 thereon, the rack beam facia 140 can be integrated with the roof beam facia 340 or roof beam of the flat roof perimeter to form a load bearing structure to strengthen said solar workpiece.

Reference symbol (b) in the drawings relates to an application of a multipurpose solar energy system in which a solar workpiece having a flat roof is added to a roadway or sidewalk of the bridge 980 to produce solar energy that does not interfere with the original passing use of the subspace. Cross sectional frames 206a, 206b in the form of box frames 203, which may or may not be having eaves with elevation frames 200 across the width of said bridge 980 to form a solar workpiece wider than the width of said sidewalk, are placed at certain intervals on top of said bridge 980.

If only the sidewalk of said bridge 980 is to be covered, apply the cross-sectional frame 206a in the form of a box frame 203 having an eave, and if both the roadway and the sidewalk of said bridge 980 are to be covered, apply the cross-sectional frame 206b incorporating the roof beam of said box frame 203. The ends of the roof beams of said cross-sectional frame 206a, 206B are finished with a roof beam facia 340 to form an outline of the roof surface of the base frame, and in fixing the SOLAR RACK 150 thereon, the length of the rack beam pair disposed in an east-west direction extends to a certain extent beyond the outline of said flat roof and ends with a rack beam facia 140 to form said solar workpiece.

It will be appreciated that the above box frame 203, to which the floor plate is added, is not limited to the formation of a solar workpiece for a multipurpose solar energy system to be installed on a bridge. Instead of the above box frame 203, a portal frame may be applied, but this may have limitations in expanding the width of the sidewalk.

Reference symbol (c) in the drawings relates to the application of a multipurpose solar energy system in which a solar workpiece having a flat roof is added to the sidewalk 990 next to the driveway, so that the production of solar energy is added without interfering with the original walking use of the subspace.

Across the width of said sidewalk 990, cantilever frames 201 in the form of elevation frames 200 and cross-sectional frames 206a, 206b in the form of portal frames 202 are placed and settled at certain intervals and said cross-sectional frames 206a, 206b's roof beam ends are finished with a roof beam facia 340, and a separate column 250 is added to the roof beam facia 340 on the outer side to form a base frame, and a SOLAR RACK 100 is fixed thereon. The rack beam pair lengths of said solar rack 150 extend a certain length beyond the perimeter of said flat roof, terminating in the rack beam facia 140.

In most applications of the foregoing embodiments of the invention, the roof surface of the base frame and the flat frame of the solar rack form the same perimeter, resulting in a load bearing structure, but the solar workpiece illustrated in FIG. 48 shows that the flat frame of the solar rack extends beyond the perimeter of the roof surface of the base frame. In accordance with the technical idea of the embodiments of the invention, the choice of whether to have the same or different perimeters in the formation of the flat roof of the solar workpiece is determined by considerations of structural loads, landscape, etc.

By forming a solar workpiece comprising an impermeable & shade layer between the roof surface of the base frame, which covers the roof of a building or is installed on a sidewalk, and the flat frame of the solar rack 100, according to the technical idea of the embodiments of the invention, an additional effect of promoting roof waterproofing or pedestrian comfort can be expected.

The objects of application for forming a solar workpiece according to the technical idea of the embodiments of the invention include a building structure and a civil structure, wherein the building structure is completed by forming a base frame in accordance with the original primary use of the building, and further includes separate facilities (abbreviated as “internal facilities”) or is installed on the outside of the building (abbreviated as “external installation”) to meet or improve the primary use of the building, wherein said building structure includes structures such as residential buildings, shops, schools, workshops, factories, warehouses, barns, sheds, planters, breeders, fish farms, fish ponds, and (semi-shaded) horticultural facilities, and said internal facilities include power, communication, lighting, irrigation and pesticide and liquid spraying facilities, and harmful tide control nets as separate utilities, and wherein said external installation is formed by erecting columns on or around the roof of all or part of the floor area of said building to form said base frame.

Said base frame is installed in addition to or integral with existing or new civil structures, said civil structures being parking lots, parks, rivers, bridges, railroads, roads, intersections, and sidewalks, sewage treatment plants, water treatment plants, marinas, moorings, (train) platforms, road soundproofing tunnels, and the like, and said base frame is formed in the form of a cloister by erecting columns inside, outside, or at the boundaries of said civil structures.

The space in which said base frame is installed includes land, water, and swamp, and said base frame is installed by erecting poles at the boundary or inside of said space, and the floating mooring type of said base frame including said floating body includes an anchor and a pile mooring, wherein said anchor is connected to said base frame by a line and fixed to the bottom of the water, and wherein said pile mooring is fixed to said base frame by inserting a cylinder into said base frame which is operable at a certain height up and down with said pile as a fixed axis.

Said base frame further comprising, in addition to said separate utility facilities, a landscaping structure on the inside for landscaping by attracting vines to a certain position, and including facilities for converting the space between the roof and the floor of said cubic frame forming said base frame into a walkway, pathway or camping deck, and, if said space is water, into a swimming pool or fishpond at the lower end thereof.

According to the technical idea of the embodiments of the invention, the construction method of the said multipurpose solar energy system, which is constructed as a solar workpiece including a solar energy panel (abbreviated as “solar panel”) on an object on an earth's surface and for the purpose of utilizing a subspace, according to a process achieved including the following steps, is as follows.
(1) A construction planning stage comprising the following steps in a process for preparing said solar workpiece for construction on a given object:
(a) a design stage comprising the following steps, in a process utilizing a digital map of the site and a global positioning system (GPS) to ensure that said solar panel has a suitable orientation and inclination angle:
1) surveying the outer extent of said subspace, and causing said roof beams to be of a certain height so that one or more polygonal horizontal flat roofs (abbreviated “flat roofs”) are formed by fixing said rack beams on top of said roof beams, and causing said rack beam pairs to be fixed in a layered framing manner on top of said roof beams forming said flat roofs,
2) said rack beam pair is oriented in an east-west direction such that the solar panels have an inclination angle of due south in the northern hemisphere or due north in the southern hemisphere,
3) wherein the inclined support member installed above said rack beam pair has an inclination angle within the range of the latitude of the location minus the tilt of the earth's axis of rotation (obliquity≈23.5°), or is predetermined and molded with an inclination angle value that produces maximum energy production during an annual or specific period of time,
4) the spacing in the north-south (or north-south) direction between said rack beam pairs is such that they are adjacent but sufficiently spaced so that the shading effect of the solar panels in front and behind them is minimized,
5) said elevation frame is arranged so that the flat roof of the solar workpiece formed by said rack beams and roof beams is formed as a lattice structure in the form of #, and
6) If the acute angle of intersection between said rack beam and said roof beam is 30 degrees or less, said bracing beam is added and fixed between said elevation frame in the form of flush framing at the same height as the roof beam so that said rack beam and said bracing beam are formed into a lattice structure in the form of #,
7) consequently, said design step determines the layout of the multi-use solar energy system so that the poles within said elevation frame are properly positioned on said object;
(b) performing a survey of candidate points on said object to anchor the footing part of said pole; and
(c) determining said framing settlement means from said survey; and
(d) if the candidate points for settling said footing part are unsuitable for the application of said framing settlement means, determine the layout of the multipurpose solar energy system by relocating said poles in said design stage; and
(e) in accordance with said layout, to complete the detailed design of said solar workpiece to comply with the seismic design standards and road transportation regulations;
(2) the factory fabrication stage, which is the process of factory fabricating the components of said solar rack and base frame, further comprising the following steps:
(a) the transportation restrictions prescribed by the Road Traffic Act and the transportation conditions from the factory to the site are investigated, and the main members of said solar rack and base frame are cut accordingly, and assembled to an acceptable scale,
(b) fabricate plate brackets which are assembled on site and which are perforated in the main member for fixing the connection means, and which are applied to the connection means of the said elevation frame and the horizontal members and vertical members attached thereto according to the shape of the said base frame; and
(c) said plate bracket is formed by cutting and bending one metal plate sheet according to the shape of the connection means of said main member;
(3) the site transportation stage, wherein said component of the multipurpose solar energy system manufactured in said factory production stage is transported to the site as prescribed by the Road Traffic Act;
(4) an on-site assembly stage in which said components of said multipurpose solar energy system transported in said on-site transportation stage are assembled unit by unit in a process that includes the following steps:
(a) Preparing the construction means required for land excavation work, framing assembly work and aerial loading work,
(b) preparing concrete or pile foundations for the settlement of the framing settlement means at the locations determined in the above design stage within the object, with the construction means for said land excavation; and
(c) the size of the components of the solar workpiece to be assembled on the ground by said framing settlement means, considering the ability of the elevating means to,
1) said solar rack is assembled by attaching inclined support members on a rack beam pair basis, with or without solar panels, depending on the permitted scale; and
2) said elevation frames forming said base frame are assembled individually,
(d) said elevation frames are lifted by said elevated support member and settled by said erecting support member on said foundation,
(e) the assembly of said base frame is accomplished by applying the main members, roof beam facia, roof beams and purlins, between said elevation frames, in accordance with the above design steps,
1) Secure the ends of adjacent roof beams with said roof beam facia, or
2) flush with said roof beam and secured to said bracing beam in a flush-framed configuration, or
3) located below said roof beams and secured by said purlins in the form of layered framing,
(f) Elevating said solar rack above the roof surface of said base frame by means of elevated loaded construction to secure said roof beams and rack beams, and assembling said solar workpiece by adding rack beam facia in accordance with the above design steps,
(g) in the case of said solar rack excluding solar panels, completing the on-site assembly of said solar workpiece by raising the solar panels to the roof of said solar workpiece by means of an aerial load carrying means and attaching the solar panels to said inclined support member;
(5) a step of completing construction of a multipurpose solar energy system, wherein the process of said on-site assembly step further comprises the following steps:
(a) After completion of said solar workpiece, work on the remaining portion of the structure to conform to the original primary use of the structure and the addition of separate facilities therein to conform to or improve said primary use,
(b) remove from the site said means of construction used in the work on the site and clean up the site; and
(c) connect the power lines required by the electricity transaction under the Electricity Business Act and other applicable laws and regulations, and install and commission the necessary electrical facilities; and
(d) the construction method of the multipurpose solar energy system, comprising the step of completing the construction of the said multipurpose solar energy system by obtaining the safety and performance certification from the authority following the said commissioning.

While the embodiments of the present invention already shown and described relate to a few typical solar workpieces, various other embodiments of the present invention in various modified forms or uses may be envisioned, the technical ideas described in the claims of the present invention being self-evident, they are not specifically shown and are not further described.

The construction method of the above multipurpose solar energy system includes a process in which the relevant components according to the embodiments of the present invention are manufactured in a factory, transported to a site, and then assembled on site to form a construction.

The on-site construction is a simple assembly process and consequently does not require highly skilled construction workers, which can reduce construction costs and provide a robust, high-quality solar building.

While various preferred embodiments of the invention have been described above, it will be apparent that various modifications and variations are possible within the spirit and spirit of the invention, and that such modifications and variations fall within the scope of the proposed claims.

1. A solar energy system comprising a solar energy panel (abbreviated as ‘solar panel’) built on an object on an earth's surface and utilizing a subspace, the solar workpiece including a solar rack on top and a base frame below,
wherein said solar rack includes a plurality of rack beams forming one or more pairs (abbreviated as ‘rack beam pairs’) and one or more inclined support members and solar panels,
wherein said rack beam is a horizontal member and is disposed in an east-west direction, and
wherein said rack beam pair includes a southern rack beam) on the south side and a northern rack beam) on the north side,
wherein said southern rack beam) and northern rack beam) are parallel to each other at certain intervals,
wherein the plurality of rack beam pairs is disposed in parallel at certain intervals,
wherein the inclined support member comprises a horizontal support part and a slope part having a predetermined inclination angle,
wherein said support part is fixed in an orthogonal shape across a plane above said southern rack beam) and northern rack beam),
wherein said solar panels are attached to said slope part,
wherein said base frame comprises a plurality of elevation frames and a footing part,
wherein said elevation frames include at least one horizontal member, a roof beam, and at least one vertical member, a vertical column,
wherein said roof beam is fixed to a top part of said column by column-beam connection means,
wherein said elevation frame is arranged crossing the inner subspace, or along the perimeter of said subspace,
wherein said roof beams are of a certain height, such that one or more polygonal horizontal flat roofs (abbreviated as “flat roofs”) are formed by fixing said rack beams on said roof beams,
wherein said roof beam is disposed in a different direction from said rack beam,
wherein said footing part is fixed to said object by including framing settlement means at the bottom part of said column,
whereas, said rack beam is resting on said roof beam and is fixed in the form of layered framing with beam-beam superposition connection means,
wherein the flat roof of the solar workpiece formed by said rack beam and roof beam together is formed as a lattice structure in the form of #,
wherein the column-beam connection means and the beam-beam superposition connection means each comprise a direct connection by welding, self-drilling screw or bolt nut fastener, or an indirect connection with a plate bracket,
wherein said column comprises a cylindrical column, a square tube pillar, a truss type column, or a main member applied to said rack beam or roof beam, having a length of a certain height to enable said object to function,
wherein said main member comprises a horizontal or vertical long span member having a rectangular section formed by a roll forming process,
a multipurpose solar energy system, characterized in that said solar panels are consequently installed at a predetermined value (abbreviated as “suitable orientation and inclination angle”) in the vicinity of a north latitude inclination angle facing south in the case of a northern hemisphere region or a south latitude inclination angle facing north in the case of a southern hemisphere region.

2. The solar rack of claim 1, wherein said solar rack and said base frame each optionally further comprise the following components,
further comprising, as a component of said solar rack, a rack beam facia, which is a horizontal member,
further comprising a roof beam facia, bracing beam, or purlin as a horizontal member as a component of said base frame,
wherein said rack beam facia is a main member similar to said rack beam, secured to the ends of adjacent rack beams by rack beam-facia connection means,
wherein said roof beam facia is a main member similar to said roof beam, and is fixed to the end of an adjacent roof beam by roof beam-facia connection means,
whereas, said bracing beams and purlins are main members similar to said roof beams, connected horizontally between sections of said columns of a certain height,
whereas, said bracing beam is located at the same height as said roof beam and is fixed between said elevation frames by column-beam connection means in the form of flush framing,
wherein said purlins are located below said roof beams and are fixed between said elevation frames by column-purlin connection means in the form of layered framing,
wherein said rack beam-facia connection means, roof beam-facia connection means, column-beam connection means and column-purlin connection means are welded, A multipurpose solar energy system characterized by direct connection by welding, self-drilling screw or bolt nut fastener, or indirect connection with a plate bracket.

3. The elevation frame of claim 2, wherein said elevation frame optionally comprises one or more of a cantilever frame, a portal frame, a box frame, a pile frame and a mixed frame,
wherein said cantilever frame is formed by fixing one top part of a column, which is a vertical member, and one end part of a roof beam, which is a horizontal member, with column-beam connection means,
wherein the portal frame is formed by supporting the top of two vertical members and the end part of one horizontal member of the roof beam, respectively, and fixing them with column-beam connection means,
wherein the box frame is formed by fixing the two end parts of the roof beam and the floor beam, which are two horizontal members, to the top and bottom parts of the columns, which are two vertical members, with column-beam connection means,
whereas, the pile frame is formed by fixing the two end portions of the two vertical members, the roof beam and the floor beam, to the top and intermediate portions of the columns, respectively, with column-beam connection means,
wherein said pile frame is a structure in which the columns extend downwardly from said box frame,
wherein said mixed frame is a united structure comprising an optional mixture of said cantilever frame, portal frame, box frame and pile frame, which is applied to the formation of said base frame,
whereas, said roof beams and floor beams each have a certain length at their respective ends in excess of said columns, comprising an eave width in the case of the roof beams and a balcony width in the case of the floor beams,
whereas, the lengths of the roof beam and the floor beam are thus equal to or greater than the inner and outer spacing between the two columns,
a multipurpose solar energy system characterized in that said horizontal member and vertical member include a cylindrical column, a square tube pillar, an I beam or an H beam in addition to a main member having a rectangular section.

4. The main member of claim 3, wherein said main member optionally comprises the following features with respect to material, process, and shape,
the material of said main member comprises one or more of a metal, a synthetic resin or a composite material,
the forming process of said main member includes one or more of a cold or hot roll forming process, an extrusion process, a pultrusion process, and a composite material manufacturing process,
wherein the cross-sectional shape of the main member comprises one or more of C-shape, C-shape, -shape, H-shape, I-shape, L-shape, and T-shape,
wherein said main member comprises a horizontal member and a vertical member formed in a single cross-sectional shape, or having a mixed cross-sectional shape, a composite member formed by joining two or more of said main members by welding or by a self-drilling screw or bolt-nut fastener,
wherein said main member is assembled by being fixed at certain positions in the longitudinal direction with main member joint connection means,
the multipurpose solar energy system, characterized in that said main member forms a half-line with respect to said certain position and has a corner of a certain angle (not more than 180 degrees).

5. Claim 4, wherein each of said column, rack beam, roof beam, rack beam facia, roof beam facia, bracing beam and purlin further comprises a main member similar to the main member used,
wherein the back surfaces of the two main members of the one ply are butted together to form a single two-ply long span member by direct connection by welding, self-drilling screws, or bolt-nut fasteners,
comprising a cross strut for rack beams between said one or said two ply main member pairs of rack beams,
wherein said cross strut for rack beam is a plate fixture in the shape of E, one or a pair thereof being connected between said rack beam pair in an orthogonal manner with fastening means such as a self-drilling screw,
wherein said pair of cross struts for rack beams are formed by fastening them face to face,
a compound member pair, wherein said one or two layers of main members (abbreviated as ‘single layer member’ and ‘double layer member’, respectively) are formed by placing one more layer of main members (abbreviated as ‘single layer pair’ and ‘double layer pair’, respectively) parallel to each other and forming a pair of long span members of the compound structure,
wherein said elevation frame comprises columns and roof beams of said compound member pairs,
further comprising a cross strut for main member between said compound member pairs,
wherein said cross strut for main member is a plate fixture in the shape of ⊏, one or a pair of which are orthogonally connected between said compound member pair by fastening means, such as a self-drilling screw,
wherein said pair of cross struts for main member are formed by fastening their back surfaces together,
accordingly, a multipurpose solar energy system characterized in that said rack beam pair including said cross strut for rack beam and said elevation frame including said cross strut for main member are formed as a Vierendeel truss, whereby said solar workpiece becomes a load bearing structure.

6. The rack beam-facia connection means, roof beam-facia connection means, column-purlin connection means, and beam-beam superposition connection means of claim 5, column-beam connection means, and main member joint connection means refer to the corresponding two main members, rack beam and rack beam facia, respectively, roof beam and roof beam facia, column and purlin, rack beam and roof beam, column and roof beam, roof beam and roof beam or bracing beam, and main member and main member as connection means, including direct connection by welding, self-drilling screw or bolt nut fastener,
wherein said connection means further comprises an indirect connection by welding, self-drilling screw or bolt nut fastener by adding a bracket to the connection part of the two main members,
wherein said bracket is shaped to be attached to a connection part of said main member,
wherein the formation means of said bracket comprises one or more of casting processing, press processing, sheet metal processing, and composite material processing,
wherein said sheet metal processing comprises one or more of shaping means of shearing, bending, and welding,
wherein the bracket comprises a plate bracket formed from a single sheet of plate, and
wherein the sheet metal fabrication comprises the form of a single bracket, a double bracket, and a combined bracket,
wherein said single bracket is formed in one piece and applied to one point of said connection part,
wherein said double bracket is formed in the form of two pieces and applied together to a point of said connection part,
the form of said merging bracket is applied to said connection part as a whole by merging the shapes of the corresponding brackets at points where there are two or more adjacent connection parts or three or more main members passing through the connection part to form a single bracket or a double bracket,
wherein said plate bracket is formed by cutting and bending a single metal plate sheet according to the shape of said connection part,
wherein the plate bracket comprises a rack beam-facia bracket, a roof beam-facia bracket, a column-purlin bracket, a beam-beam superposition bracket, a column-beam bracket, and a main member joint bracket,
wherein the rack beam-facia bracket is applied to the rack beam-facia connection means,
wherein the roof beam-facia bracket is applied to the roof beam-facia connection means,
wherein the column-purlin bracket is applied to the column-purlin connection means,
wherein the beam-beam superposition bracket is applied to the beam-beam superposition connection means,
wherein the column-beam bracket is applied to the column-beam connection means,
wherein the main member joint bracket is applied to the main member joint connection means,
“rack beam-facia bracket”, “roof beam-facia bracket”, “column-purlin bracket”, and
“beam-beam superposition bracket”, column-beam bracket, and main member joint bracket, characterized in that when said plate brackets are adjacent and overlap, the overlapping planes are cut into a single plane and formed into a single bracket or a double bracket in the form of a combined connection bracket to be applied integrally to said connection part.

7. The elevation frame of claim 6, optionally comprising one or more of a cross-sectional frame of a transverse type, a side wall frame of a longitudinal type, and a mixed frame of a mixed type as a planar combination type of said elevation frame for forming said base frame for the purpose of constructing a solar workpiece applied to said object,
wherein said cross-sectional frames are disposed in a plurality at certain intervals across the interior of said object, and wherein the ends of adjacent roof beams are connected by roof beam fascias or the tops of adjacent columns are connected by other bracing beams,
wherein said side wall frames are arranged in two or more rows in a longitudinal direction along an interior or exterior perimeter of said object, and wherein bracing beams are connected in a flush-framing manner between two opposite columns between said two rows, between one column and a roof beam, or between two roof beams,
wherein said mixed frame is arranged in a form wherein said cross-sectional frame and side wall frame are optionally mixed,
wherein, in the form arranged according to said combination type, columns made of the same main member are optionally added to the connection part of the bracing beam or roof beam, or purlins are fixed to the adjacent columns in a layered framing method,
wherein said form of base frame optionally includes one or more of a single building type, a consecutive building type, a multistory building type, and a mixed building type in three dimensions,
wherein said single building type is in the form of columns disposed at the outer perimeter of said object,
wherein said CONSECUENT BUILDING TYPE is constructed by attaching one or more of said single building type immediately adjacent thereto, and includes one or more rows of columns inside said object,
wherein said multistory building type comprises a plurality of base frames of equal or lesser floor area built on top of said single building type or consecutive building type,
wherein said mixed building type is formed by selectively mixing said single building type, consecutive building type, or multistory building type to form a base frame according to the shape of a given object,
further comprising one or more of a primary cubic frame and a secondary cubic frame as a merged combination type of an elevation frame to form said base frame,
wherein said first cubic frame is formed in a planar combination type of said elevation frame,
wherein said secondary cubic frame is formed as a perpendicular combination type of said elevation frame such that said primary cubic frame is supported on said object,
wherein said means for supporting said object comprises a floating body, a pile, or a combination support,
wherein said floating body is installed in or under said primary cubic frame,
wherein said piles are attached to posts within said primary cubic frame or secondary cubic frame,
wherein said mixed support method is supported by said piles being attached to columns within said primary cubic frame comprising said floating body,
wherein said primary or secondary cubic frame further comprises a roof, floor and walls or railings which are optionally subordinate frames,
wherein said roof is secured by a sheet type structure over said roof beams,
wherein said floor is secured by a sheet type structure attached to said floor beams, said walls are secured by a sheet type structure attached to the sides of said columns,
wherein said parapet is formed as an integral elevation structure with said columns at said floor corners,
a multipurpose solar energy system, characterized in that said roof becomes a non-forest structure, said floor and walls become a safety structure and divide the interior space according to the use, and further characterized in that a solar workpiece is formed in a structure wherein said roof and floor share horizontal loads and the walls and railings share vertical loads.

8. Claim 7, wherein the object on which said solar workpiece is constructed comprises an earth's surface, both cultivated and uncultivated, and a building structure and a civil structure,
whereas, said building structure is formed and completed with said base frame to serve the original primary use of the building, and further includes separate facilities therein to serve or improve said primary use (hereinafter referred to as “internal facilities”) or is attached to the exterior of said building (hereinafter referred to as “external installations”),
said building structure includes the construction of dwellings, shops, schools, workshops, factories, warehouses, barns, sheds, growers, breeders, fish farms, fish ponds and (semi-shaded) horticultural facilities,
Said internal facilities include power, communications, lighting, irrigation, pesticide and liquid fertilizer application facilities and harmful tide control nets as separate utilities,
whereas, said exterior facilities are formed by erecting columns on or around the roof of all or a portion of the floor area of said building to form said base frame,
whereas, said base frame is constructed in addition to or as an integral part of said existing or new civil structures,
said civil structures include parking lots, parks, rivers, bridges, railroads, roads, intersections, sidewalks, sewage treatment plants, water treatment plants, marinas, moorings, (train) platforms, and road soundproofing tunnels,
whereas, said base frame is formed in the form of a cloister by erecting columns inside, outside or at the boundaries of said civil structures,
whereas, said surface of the earth on which said base frame is installed includes land, water and swampy ground,
wherein said base frame is installed by erecting poles at the boundary or inside of said object,
wherein said floating body includes a floating mooring of said base frame, said mooring comprising an anchor and a pile mooring,
wherein said anchor is tethered to said base frame and anchored to the bottom of the water in the form of a floating structure,
wherein said pile mooring is fixed to said base frame in the form of a semi-floating structure by inserting a cylinder movable up and down to a certain height with said pile as a fixed axis,
whereas, said base frame further comprises, in addition to said separate utility facilities, a landscaping structure inside which vine plants are attracted to a certain position for landscaping,
a multipurpose solar energy system characterized in that the space between the roof and the floor of said cubic frame forming said base frame includes facilities for the use of a walkway, pathway or camping deck, and if said space is water, includes a swimming pool or fishpond at the bottom thereof.

9. A construction method for a multipurpose solar energy system, said multipurpose solar energy system being constructed as a solar workpiece including a solar energy panel (abbreviated as “solar panel”) according to a process achieved by including the following steps, for the purpose of being constructed on an object on an earth's surface and utilizing a subspace:
(1) a construction planning step, comprising the following steps, in a process for preparing said solar workpiece for construction on a given object:
(a) a design stage comprising the following steps, in a process utilizing a site numerical map and a global positioning system (GPS) so as to satisfy a condition that said solar panel has a suitable orientation and inclination angle:
1) surveying the outer extent of said subspace, and causing said roof beams to be of a certain height so that one or more polygonal horizontal flat roofs (abbreviated “flat roofs”) are formed by fixing said rack beams on top of said roof beams, and causing said rack beam pairs to be fixed in a layered framing manner on top of said roof beams forming said flat roofs,
2) said rack beam pair is oriented in an east-west direction such that the solar panels have an inclination angle of due south in the northern hemisphere or due north in the southern hemisphere,
3) wherein the inclined support member installed above said rack beam pair has an inclination angle within the range of the latitude of the location minus the tilt of the earth's axis of rotation (obliquity≈23.5°), or is predetermined and molded with an inclination angle value that produces maximum energy production during an annual or specific period of time,
4) the spacing between said rack beam pairs in a north-south or north-south direction is such that they are adjacent but sufficiently spaced so that the shading effect of the solar panels in front and behind them is minimized,
5) said elevation frame is arranged so that the flat roof of the solar workpiece formed by said rack beams and roof beams is formed as a lattice structure in the form of #, and
6) If the acute angle of intersection between said rack beam and said roof beam is 30 degrees or less, said bracing beam is added and fixed between said elevation frame in the form of flush framing at the same height as the roof beam so that said rack beam and said bracing beam are formed into a lattice structure in the form of #,
7) consequently, said design step determines the layout of the multi-use solar energy system so that the poles within said elevation frame are properly positioned on said object;
(b) performing a survey of candidate points on said object to anchor the footing part of said pole; and
(c) determining said framing settlement means from said survey; and
(d) if the candidate points for settling said footing part are unsuitable for the application of said framing settlement means, determine the layout of the multipurpose solar energy system by relocating said poles in said design stage; and
(e) in accordance with said layout, to complete the detailed design of said solar workpiece to comply with the seismic design standards and road transportation regulations;
(2) the factory fabrication stage, which is the process of factory fabricating the components of said solar rack and base frame, further comprising the following steps:
(a) the transportation restrictions prescribed by the Road Traffic Act and the transportation conditions from the factory to the site are investigated, and the main members of said solar rack and base frame are cut accordingly, and assembled to an acceptable scale,
(b) fabricate plate brackets which are assembled on site and which are perforated in the main member for fixing the connection means, and which are applied to the connection means of the said elevation frame and the horizontal members and vertical members attached thereto according to the shape of the said base frame; and
(c) said plate bracket is formed by cutting and bending one metal plate sheet according to the shape of the connection means of said main member;
(3) the site transportation stage, wherein said component of the multipurpose solar energy system manufactured in said factory production stage is transported to the site as prescribed by the Road Traffic Act;
(4) an on-site assembly stage in which said components of said multipurpose solar energy system transported in said on-site transportation stage are assembled unit by unit in a process that includes the following steps:
(a) preparing the construction means required for land excavation work, framing assembly work and aerial loading work,
(b) preparing concrete or pile foundations for the settlement of the framing settlement means at the locations determined in the above design stage within the object, with the construction means for said land excavation; and
(c) the size of the components of the solar workpiece to be assembled on the ground by said framing settlement means, considering the ability of the elevating means to,
1) said solar rack is assembled by attaching inclined support members on a rack beam pair basis, with or without solar panels, depending on the permitted scale; and
2) said elevation frames forming said base frame are assembled individually,
(d) said elevation frames are lifted by said elevated support member and settled by said erecting support member on said foundation,
(e) the assembly of said base frame is accomplished by applying the main members, roof beam facia, roof beams and purlins, between said elevation frames, in accordance with the above design steps,
1) secure the ends of adjacent roof beams with said roof beam facia, or
2) flush with said roof beam and secured to said bracing beam in a flush-framed configuration, or
3) located below said roof beams and secured to said purlins in the form of layered framing,
(f) elevating said solar rack above said base frame by means of elevated loaded construction to secure said roof beams and rack beams, and assembling said solar workpiece by adding rack beam facia in accordance with the above design steps,
(g) in the case of said solar rack excluding solar panels, assembling said solar workpiece on-site by raising the solar panels to the roof of said solar workpiece by means of aerial loading and attaching them to said inclined support member to complete the construction;
(5) a step of completing construction of a multipurpose solar energy system, wherein the process of said on-site assembly step further comprises the following steps:
(a) after completion of said solar workpiece, work on the remaining portion of the structure to conform to the original primary use of the structure and the addition of separate facilities therein to conform to or improve said primary use,
(b) remove from the site said means of construction used in the work on the site and clean up the site; and
(c) connect the power lines required by the electricity transaction under the Electricity Business Act and other applicable laws and regulations, and install and commission the necessary electrical facilities; and
(d) to complete the construction of the said multipurpose solar energy system by obtaining the safety and performance certification from the Authority following the said commissioning.
